(19) United States
(12) Patent Application Publication
(10) Pub. No.: US 2024/0326016 A1
(43) Pub. Date: Oct. 3, 2024

(54) IMPRINTED POLYMER SURFACE FUNCTIONALIZATION OF ACTIVATED CARBON FOR SELECTIVE ADSORPTION OF PER- AND POLYFLUOROALKYL SUBSTANCES

(71) Applicant: University of Washington, Seattle, WA (US)

(72) Inventors: Jessica Steigerwald, Seattle, WA (US); Jessica Ray, Seattle, WA (US)

(73) Assignee: University of Washington, Seattle, WA (US)

(21) Appl. No.: 18/611,269

(22) Filed: Mar. 20, 2024

Related U.S. Application Data
(60) Provisional application No. 63/491,102, filed on Mar. 20, 2023.

(51) Int. Cl. B01J 20/26; B01J 20/28; C02F 1/28; C02F 101/36; C08F 292/00

(52) U.S. Cl. CPC B01J 20/268; B01J 20/28064; B01J 20/2808; C02F 1/288; C08F 292/00; C02F 1/283; C02F 1/285; C02F 2101/36

(57) ABSTRACT

Methods of functionalizing activated carbon for selective adsorption of a per- or polyfluoroalkyl substance (PFAS), methods of removing PFAS, and compositions comprising activated carbon; and a molecularly imprinted polymer (MIP) coupled to the activated carbon are described. In the embodiment, the method of functionalizing activated carbon for selective adsorption of a PFAS comprises coordinating a PFAS template with a plurality of functional monomers; polymerizing the plurality of functional monomers coordinated with the PFAS template in the presence of an activated carbon substrate to provide a molecularly imprinted polymer (MIP) coupled to the activated carbon; and extracting the PFAS template from the MIP.

### CROSS-REFERENCE TO RELATED APPLICATION

This application claims the benefit of U.S. Provisional Application No. 63/491,102, filed on Mar. 20, 2023, the entire disclosure of which is enclosed.

### BACKGROUND

Per- and poly-fluoroalkyl substances (PFAS) are a class of chemicals which have drawn increasing attention in recent decades due to their prevalence, persistence, and negative human health impacts. In 2022, the Environmental Protection Agency (EPA) released new drinking water health advisory limits (HAL; a non-enforceable standard indicating the maximum concentration of a contaminant for which negative human health impacts are not expected to occur) for perfluoroalkyl acids (PFAAs), a particularly persistent and toxic subclass of PFAS. This HAL included exceptionally low interim levels for perfluorooctanesulfonate (PFOS, 0.02 ng/L) and perfluorooctanoic acid (PFOA, 0.004 ng/L), and final HALs for hexafluoropropylene oxide-dimer acid (10 ng/L) and perfluorobutanesulfonic acid (PFBS; 2,000 ng/L). A maximum contaminant level (MCL) is currently being developed which is expected to be consistent with the 2022 HAL. Regulation of PFAAs has prompted a shift in manufacturing toward use of shorter-chain and polyfluorinated PFAAs which were initially thought to be less toxic and less persistent in the environment. However, recent research has shown that many polyfluorinated compounds transform in water treatment systems to shorter-chain perfluorocarboxylic acids (PFCAs), and that these short-chain PFCAs share many of the same negative health outcomes with their longer-chain counterparts Thus, there is a demand for identification of efficient strategies for water treatment and control of routes for PFAA contamination of water sources.

One source of PFAAs to environmental waters and drinking water sources is wastewater treatment plant (WWTP) effluent. PFAAs may enter sewage through household sources, industrial discharges, or landfill leachate, and are then removed poorly (if at all) by conventional wastewater treatment processes. Wastewater effluent and biosolids containing PFAAs will be introduced to the environment (e.g., land application of PFAA-contaminated biosolids followed by leaching into stormwater runoff and to surface waters) where they may disperse or become PFAA point sources for downstream drinking water supply. This is a relevant consideration for areas where water reuse is being implemented or considered, such as in water-constrained areas of the American (South)West.

One challenge associated with PFAA removal from WWTP effluent is the lack of targeted separation approaches. The industry standard for PFAA separation in water is adsorption onto activated carbon (AC)—a highly porous, pyrolyzed carbonaceous media with high specific surface area capable of adsorbing a wide variety of organic and inorganic pollutants. In WWTP effluent containing high dissolved organics or salt concentrations, competition for AC active sites arises leading to modest PFAA removal rates—particularly for shorter-chain PFAA compounds. For example, wastewater effluent typically contains around 10 mg/L of total organic carbon (TOC), 200-1000 mg/L of total dissolved solids (TDS; i.e., salts), and much lower concentrations of PFAA (0.01 ng/L-50 μg/L) and other trace organics (0.0-20 μg/L). Effective removal of PFAAs from these more complex wastewater matrices presents a unique challenge for ACs. This challenge was highlighted in PCT Application No. PCT/US2021/056771 that described, inter alia, the development of a sustainably sourced and cost-effective activated biochar which exhibited high PFAA removal comparable to a commercially available AC. In the absence of other organics, this biochar—sourced from spent coffee grounds—achieved 92.4% removal of 340±23 μg/L PFOS but experienced a decrease in PFOS removal (i.e., 33.6% PFOS removed) when synthetic effluent organic matter (sEfOM) was included in the reaction matrix. Pretreatment to remove dissolved organics and salts could increase PFAA separation efficacy by activated carbons and biochar; however, this is an expensive option and likely impractical for the majority of WWTPs. In addition to reduced PFAA adsorption in complex aquatic systems, a safe and reliable disposal method for spent, PFAA-loaded AC has yet to be identified. Typically, spent AC is landfilled or incinerated, both of which present environmental hazards. Thus, there is a demand for more selective, regenerable adsorbent materials capable of achieving targeted removal of PFAAs over multiple adsorption and regeneration cycles.

### SUMMARY

To address these and related challenges, the present disclosure provides methods and compositions capable of selective adsorption for effectively removing a wide range of PFAS from complex matrices. In an embodiment, the present disclosure provides a method for using a target organic molecule (e.g., a PFAS adsorbate) as a template to create an active site with size, shape, and affinity specifically tailored to the target molecule. In an embodiment, the method functionalizes a PFAS-templated molecularly imprinted polymer (MIP) onto activated carbon to obtain a high surface area, selective adsorbent with physical size and properties that make it easily implemented in existing water treatment infrastructure.

In an embodiment, the method produces MIP functionalization which improves PFAS selectivity in the presence of co-occurring organics and ions. In an embodiment, the method includes regeneration of spent media for long material lifetimes, thereby creating an alternative adsorbent media for both commercial and household single-use applications.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIGS. 1A-1E: Nitrogen (N 1s) XPS spectra for (1A) BC, (1B) BC-N, (1C) BC-M, and (1D) BC-A. Structures of each type of nitrogen-containing functional group identified by XPS are shown on the far right. Table (1E) summarizes the composition of unmodified and nitrogen modified biochar materials determined by XPS and elemental analysis;

FIGS. 2A-2D: TEM images with SEM image insets of MIP modified biochar materials: (2A) BC-N@MIP-V, (2B) BC-A@MIP-VF, (2C) BC-M@MIP-VF, and (2D) BC-M@MIP-V;

FIGS. 3A and 3B: Equilibrium adsorption of (3A) 4275±342 μg/L PFOS and (3B) 1476±207 μg/L PFOS, 1166±153 μg/L PFBS, and 1453±582 μg/L PFOA by 100 mg/L MIP modified and unmodified biochar materials in an ultrapure water only matrix following a 4-day equilibration period. Main graphs display the distribution coefficient while insets display the normalized equilibrium adsorption. Error bars represent the standard deviation from triplicate samples;

FIGS. 4A and 4B: Equilibrium adsorption of 1659±99 μg/L PFOS, 1400±11 μg/L PFBS, 2313±71 μg/L PFOA, 1916±76 μg/L caffeine, 1520±63 μg/L fipronil, and 3385±217 μg/L pentachlorophenol by 100 mg/L MIP modified and unmodified biochar materials in synthetic wastewater following a 4-day equilibration period, with FIG. 4A displaying the distribution coefficient and FIG. 4B displaying the normalized equilibrium adsorption. Error bars represent the standard deviation from triplicate samples;

FIG. 5 shows selectivity coefficient from synthetic wastewater test calculated using equations 3-5 with PFOS as the reference adsorbate and unmodified BC as the reference adsorbent;

FIGS. 6A and 6B show percent recovery of adsorbate from spent adsorbent following batch adsorption tests with (6A) 4275±342 μg/L PFOS only in a water matrix, and (6B) 1659±99 μg/L PFOS, 1400±11 μg/L PFBS, 2313±71 μg/L PFOA, 1916±76 μg/L caffeine, 1520±63 μg/L fipronil, and 3385±217 μg/L pentachlorophenol adsorption in the synthetic wastewater matrix. Percent regeneration was calculated as the percent recovery of mass adsorbed during the 4-day equilibrium adsorption test. Error bars represent the standard deviation from triplicate samples;

FIG. 7 illustrates thermogravimetric analysis of nitrogen modified biochar materials, according to embodiments of the present disclosure;

FIG. 8 provides Diffuse Reflectance Fourier Transform Infrared Spectroscopy (DRIFTS) spectra of nitrogen modified and unmodified spent coffee grounds biochar, according to embodiments of the present disclosure;

FIGS. 9A-9D illustrate carbon (C1s) XPS data for SCGKOH (9A), BC-N (9B), BC-M (9C), and BC-A (9D), according to embodiments of the present disclosure;

FIGS. 10A-10D illustrate oxygen (O1s) XPS data for SCGKOH (10A), BC-N (10B), BC-M (10C), and BC-A (10D), according to embodiments of the present disclosure;

FIG. 11 illustrates percent removal of 4490±478 μg/L PFOS by 100 mg/L of nitrogen modified and unmodified SCGKOH biochar in an ultrapure water matrix following a 4-day equilibration period, according to embodiments of the present disclosure, where error bars represent standard deviation from triplicate samples;

FIG. 12 illustrates percent removal of 4174±302 μg/L PFOS by 100 mg/L of MIP coated and unmodified SCGKOH biochar in an ultrapure water matrix following a 4-day equilibration period, according to embodiments of the present disclosure, where error bars represent standard deviation from triplicate samples;

FIG. 13 illustrates percent removal of 1478±185 g/L PFOS, 1152±135 μg/L PFBS, and 1380±515 μg/L PFOA by 100 mg/L of MIP coated and unmodified SCGKOH biochar in an ultrapure water matrix following a 4-day equilibration period, according to embodiments of the present disclosure, where error bars represent standard deviation from triplicate samples;

FIG. 14 illustrates percent removal of 1659±99 μg/L PFOS, 1400±11 μg/L PFBS, 2313±71 μg/L PFOA, 1916±76 μg/L caffeine, 1520±63 μg/L fipronil, and 3385±217 μg/L pentachlorophenol by sEfOM, biochar, and biochar MIP composite materials in a synthetic wastewater matrix with pH controlled to 7.0±0.2 using a 5 mM HEPES buffer following a 4-day equilibration period, according to embodiments of the present disclosure, where error bars represent standard deviation from triplicate samples;

FIG. 15 illustrates equilibrium adsorption of 4275±342 μg/L PFOS by 100 mg/L MIP modified and unmodified biochar materials in an ultrapure water only matrix following a 4-day equilibration period, according to embodiments of the present disclosure, where error bars represent the standard deviation from triplicate samples;

FIG. 16 illustrates equilibrium adsorption of 1476±207 μg/L PFOS, 1166±153 μg/L PFBS, and 1453±582 μg/L PFOA by 100 mg/L MIP modified and unmodified biochar materials in an ultrapure water only matrix following a 4-day equilibration period, according to embodiments of the present disclosure, where error bars represent the standard deviation from triplicate samples;

FIG. 17 illustrates equilibrium adsorption of 1659±99 μg/L PFOS, 1400±11 μg/L PFBS, 2313±71 μg/L PFOA, 1916±76 μg/L caffeine, 1520±63 μg/L fipronil, and 3385±217 μg/L pentachlorophenol by 100 mg/L MIP modified and unmodified biochar materials in synthetic wastewater following a 4-day equilibration period, according to embodiments of the present disclosure, where error bars represent the standard deviation from triplicate samples.

FIGS. 18A-18F provide chemical structures of PFOS (18A), PFBS (18B), PFOA (18C), caffeine (18D), fipronil (18E), and pentachlorophenol (18F);

FIG. 19A graphically illustrates adsorption of PFOS onto functionalized biochar, according to embodiments of the present disclosure;

FIG. 19B illustrates PFAS adsorption using biochar and functionalized biochar according to embodiments of the present disclosure;

FIG. 19C provides structures of functional monomers used to prepare MIP according to embodiments of the present disclosure;

FIG. 20 schematically illustrates processing coffee beans and coffee grounds to provide functionalized biochar with adsorbed PFOS, according to embodiments of the present disclosure;

FIG. 21 schematically illustrates immobilization of a multi-template imprinted polymer on biochar for improved adsorption of short- and long-chain per- and polyfluoroalkyl substances, according to embodiments of the present disclosure;

FIGS. 22A-22D provide (22A) Adsorption of nine PFAS by 100 mg/L of unmodified and polymer modified biochar materials over a 4-day equilibration time. Error bars represent standard deviation from triplicate samples. Initial concentrations were 58±3.7 μg/L PFOS, 50±5.5 μg/L PFHxS, 49±5.1 μg/L PFBS, 48±3.2 μg/L 6:2-FTS, 50±4.9 μg/L PFOA, 58±4.8 μg/L PFHxA, 52±5.4 μg/L PFPeA, 53±5.5 μg/L PFBA, and 41±7.8 μg/L TFA. FIGS. 22B-22D show a comparison of selectivity coefficients for single- and multi-template BC@MIP materials calculated from adsorption of nine PFAS shown in (22A) with 6:2-FTS, PFBS, and PFPeA used as templates in calculations for (22B), (22C), and (22D), respectively. Non-imprinted polymer (BC@NP) was used as a reference material for these calculations;

FIGS. 23A-23D illustrate adsorption of approximately 5-5000 μg/L of individual templates (6:2-FTS (23A), PFBS (23B), PFPeA (23D)) onto BC@mMIP. Error bars represent standard deviation of triplicate samples. Data is modeled with the Langmuir and Freundlich isotherms. Calculated model parameters are shown in FIG. 23C;

FIG. 24 shows adsorption of nine PFAS by 100 mg/L of BC@mMIP over four in ultrapure water with an initial pH of 7.0 are shown as solid bars. Subsequent PFAS recovery over 7 days in a 70% methanol, 1% sodium chloride, and 2.8 mM sodium hydroxide solution at a solids concentration of 1 g/L are shown as hashed bars. Error bars represent standard deviation of triplicate samples. Data labels give equilibrium solution concentration in ng/L following the adsorption phase. Initial PFAS concentrations were: 217±93 ng/L PFOS, 114±28 ng/L PFHxS, 109±29 ng/L PFBS, 112±10 ng/L 6:2-FTS, 93±10 ng/L PFOA, 87±19 ng/L PFHxA, 96±19 ng/L PFPeA, 98±6 ng/L PFBA, and 197±50 ng/L TFA;

FIGS. 25A-25F provide time series normalized column effluent concentrations for representative PFAS and organic compounds with initial concentration of approximately 20 μg/L each in a wastewater effluent matrix delivered at 1 mL/min to columns containing 1 wt % of adsorbent in sand. Error bars represent standard deviation from triplicate columns for each media type;

FIGS. 26A-26F show mass adsorbed and desorbed over from column media over four sequential cycles for representative PFAS and organic compounds. Initial concentrations for each compound during adsorption was approximately 20 μg/L in a wastewater effluent matrix delivered at 1 mL/min to columns containing 1 wt % of adsorbent media in sand. Desorption was achieved by flushing with the column wash solution at 0.5 mL/min. Error bars represent standard deviation from triplicate columns for each media type;

FIG. 27 shows PFAS adsorption 100 mg/L of BC@mMIP synthesized with and without the macromolecular crowding approach. Equilibrium adsorption was evaluated after 4 days. Error bars represent standard deviation from triplicate samples. Initial concentrations were 58±3.7 μg/L PFOS, 50±5.5 μg/L PFHxS, 49±5.1 μg/L PFBS, 48±3.2 μg/L 6:2-FTS, 50±4.9 μg/L PFOA, 58±4.8 μg/L PFHxA, 52±5.4 μg/L PFPeA, 53±5.5 μg/L PFBA, and 41±7.8 μg/L TFA;

FIGS. 28A and 28B show PFAS desorption kinetics from BC@mMIP following a 4-day adsorption of (waste)water relevant concentrations in ultrapure water. PFAS recovery was achieved in a 70% methanol, 1% sodium chloride, 2.8 mM sodium hydroxide solution with a solids concentration of 1 g/L. Graph (28A) displays the full dataset while (22B) displays a closer look at the PFAS with recovered mass from 0-60 ng;

FIG. 29 provides an image of a column test set-up with test columns contain 1 wt. % of adsorbate in sand;

FIG. 30 illustrates column tracer test graphical results;

FIGS. 31A-31G show time series adsorption for PFAS and organic compounds not shown in FIGS. 25A-25F. Initial concentrations for each compound during adsorption was approximately 20 μg/L in a wastewater effluent matrix delivered at 1 mL/min. Error bars represent standard deviation from triplicate columns for each media type;

FIG. 32A-32G show mass adsorbed and desorbed from column media over four sequential cycles for PFAS and organic compounds not shown in FIGS. 26A-26F. Initial concentrations for each compound during adsorption was approximately 20 μg/L in a wastewater effluent matrix delivered at 1 mL/min. Desorption was achieved by flushing with 70% methanol and 1% sodium chloride at 0.5 mL/min. Error bars represent standard deviation from triplicate columns for each media type;

FIGS. 33A-33J provide chemical structures of PFOS (33A), PFHxS (33B), PFBS (33C), 6:2-FTS (33D), PFOA (33E), PFHxA (33F), PFPeA (33G), PFBA (33H), TFA (33I), and Fipronil (33J); and

FIGS. 34A and 34B are scanning electron microscope image of BC substrate (34 A), and transmission electron microscope image of multi-template MIP-BC composite (34B) showing adsorbent morphology.

### DETAILED DESCRIPTION

Methods of functionalizing activated carbon for selective adsorption of a per- or polyfluoroalkyl substance (PFAS), methods of removing PFAS, and compositions comprising activated carbon; and a molecularly imprinted polymer (MIP) coupled to the activated carbon are described.

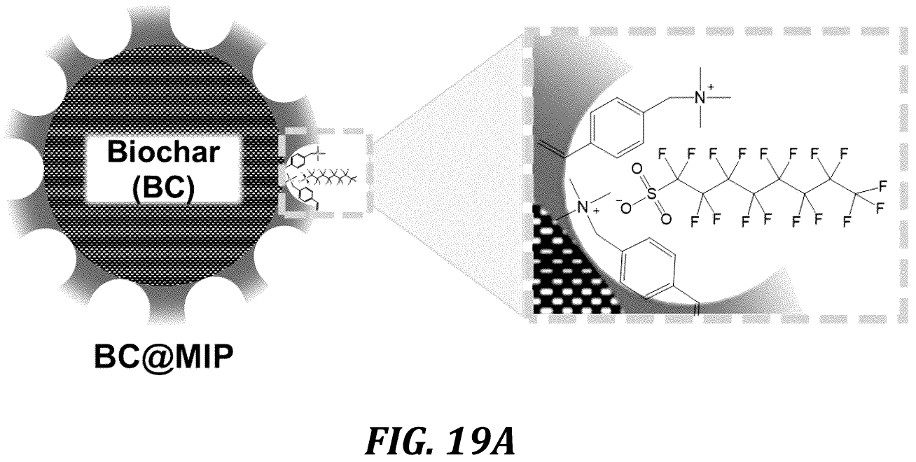

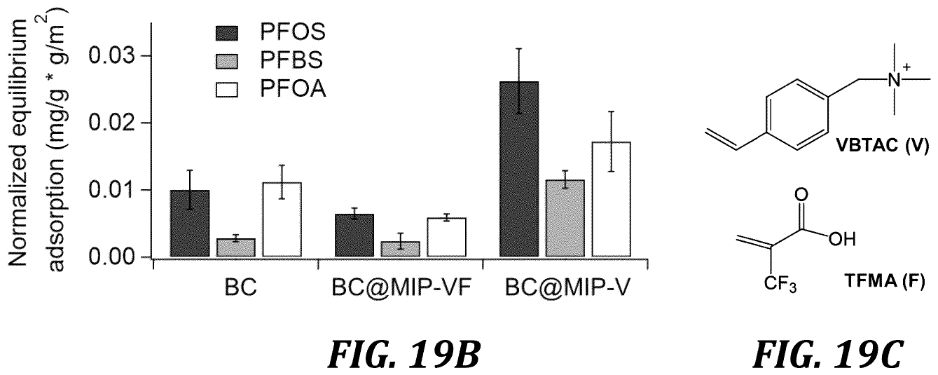

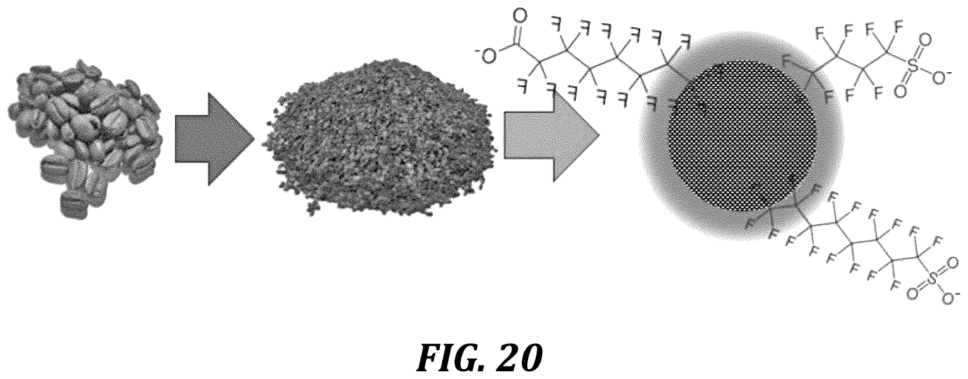

MIPs, a class of polymers traditionally used for sensing compounds, are shown herein to provide selective PFAA adsorption. During synthesis, a target organic molecule (e.g., a PFAA adsorbate) is used as a template to create an active site with size, shape, and affinity specifically tailored to the target molecule. As described herein, a multi-step approach can be employed for synthesis of molecularly imprinted polymer adsorbents. See, for example, FIG. 20. This can include pre-polymerization mixing to form a template-monomer complex followed by polymerization and then washing to remove imprinted template. In an embodiment, a functional monomer is mixed with the template compound for a defined pre-polymerization assembly time. During this step, weak attractive forces (i.e., van der Waals forces) promote binding of the template and monomer to form self-assembled ligands. Functional monomers can be selected with specific moieties (e.g., quaternary nitrogen or fluorocarbon) or properties (e.g., hydrophobicity, hydrophilicity, or charge) that will enhance the affinity for the template and increase imprinting success in this self-assembly step. Examples are shown in FIG. 19C. In an embodiment, next, a crosslinker is introduced which links the functional monomers and provides structural stability for the final polymer product. In an embodiment, a high crosslinker to monomer ratio is used, making crosslinker selection a possible determining factor in the final morphology and physicochemical properties of the MIP. In an embodiment, polymerization is initiated, for example, through chemical, thermal, or physical means and allowed to proceed for a set amount of time or until self-termination. Thermally activated radical initiated polymerization can include addition of an initiator compound (e.g., 2,2′-azobis(2-methylpropionitrile), AIBN) which, when heated, promotes formation of radical groups from —NH moieties and initiates the formation of a vinyl polymer from monomer and crosslinker compounds containing one or more R═R moieties. In an embodiment, the MIP is rinsed with an extraction solution to remove the target molecule. The same template extraction process can be leveraged to regenerate spent MIP media to create a concentrated PFAA solution from which PFAAs could be extracted either for reuse in manufacturing processes or for subsequent disposal.

The MIP synthesis approach of the present disclosure enables high selectivity for the template compound-even in the presence of compounds with similar structure or charge. While these and other MIPs have been demonstrated to possess high selectivity and high affinity for templated PFAAs, polymerization results in a fine powder media, which limits MIP use during traditional water filtration applications.

To overcome this obstacle to deployment, the present disclosure affixes MIP to activated carbon (AC) and/biochar (BC). See, for example FIG. 19A. AC and BC have several advantages that make them advantageous substrates for MIP functionalization. First, the waste feedstock (e.g., spent coffee grounds) from which BC can be produced have the advantage of being relatively low cost and widely available compared to many other substrate options. Second, the high specific surface area and density of micropores characteristic of ACs and BC-which has been shown to be a contributor to the success of these materials as adsorbents—is expected to be retained during the MIP functionalization and aid in their water treatment capabilities. Third, BC and AC materials often contain a high density of surface functional groups and are easily modifiable to add or alter functional groups via well-established processes. In MIP functionalization applications, these functional groups can act as potential receptor sites where crosslinking of the substrate to the MIP may occur. In particular, surface functional groups containing —NH moieties are expected to participate in radical-initiated polymerization since these bonds have been shown to form radicals upon interaction with radical initiator compounds like AIBN. However, there is still a demand for additional research into MIP-substrate composite adsorbents capable of removing both long- and short-chain PFAAs at environmentally relevant pH ranges.

In the present disclosure, an MIP material assembled with PFOS template is functionalized onto a previously developed spent coffee grounds activated BC to produce an adsorbent composite with high PFAA selectivity. While BC is described, it will be understood that AC of any source, not just BC, can be used in the methods and compositions of the present disclosure. It will further be understood that, while certain embodiments may be described with respect to or using BC, that AC of all sources fall within the scope of such description of BC.

PFOS was chosen as an example template compound because: (1) it can participate in relatively strong electrostatic and hydrophobic interactions compared to other PFAAs which will increase the likelihood of successful imprinting; (2) the 8-carbon backbone length should result in MIP binding sites capable of adsorbing a number of equal-length and shorter PFAAs; and, (3) it is one of the most widely detected PFAAs in the environment. The present disclosure illustrates how, inter alia: (1) modify the spent coffee grounds BC with nitrogen containing functional groups via low-impact methods with respect to the AC structure or PFAA removal capability; (2) functionalize the nitrogen-modified AC with a PFAA selective MIP layer; and, (3) evaluate the ability of the MIP-functionalized AC (AC@MIP) to selectively remove and recover PFAAs in ultrapure water and synthetic wastewater matrices. To our knowledge, however, functionalization of a MIP onto an AC substrate and evaluation of PFAS imprinted polymer performance in synthetic wastewater have yet to be explored. Development and characterization of an AC@MIP adsorbent for targeted PFAA adsorption and recovery described herein can provide more environmentally sustainable and advantageous alternatives to activated carbon for PFAA separation during water treatment.

### A Method of Functionalizing Activated Carbon for Selective Adsorption of a Per- or Polyfluoroalkyl Substance (PFAS)

In an aspect, the present disclosure provides a method of functionalizing activated carbon for selective adsorption of a per- or polyfluoroalkyl substance.

In an embodiment, the method comprises coordinating a PFAS template with a plurality of functional monomers; polymerizing the plurality of functional monomers coordinated with the PFAS template in the presence of an activated carbon substrate; and extracting the PFAS template from the MIP activated carbon.

In an embodiment, coordinating the PFAS template with the plurality of functional monomers comprises mixing the plurality of the functional monomers and the PFAS template in a pre-polymerization solution, such as under conditions and for a time sufficient to coordinate functional monomers of the plurality of functional monomers with the PFAS template.

In an embodiment, functional monomers of the plurality of functional monomers comprise a functional group including a quaternary amine. In an embodiment, functional monomers of the plurality of functional monomers comprise a functional group including a fluorocarbon. In an embodiment, functional monomers of the plurality of functional monomers are selected from the group consisting of [(methacryloyloxy)ethyl] trimethylammonium chloride, 2-(trifluoromethyl)acrylic acid, and vinylbenzyl trimethylammonium chloride, and combinations thereof.

In an embodiment, the method includes templating the MIP using multiple PFAS templates. Without wishing to be bound by any particular theory, it is believed that by templating the MIP using multiple PFAS templates that resulting compositions are configured to adsorb broader ranges of types, sizes, compositions of PFAS. In an embodiment, the PFAS template is a first PFAS template, the method further comprising coordinating a second PFAS template with a plurality of functional monomers. In an embodiment, the second PFAS template comprises a length different than a length of the first PFAS template.

Without wishing to be bound by any particular theory, the present disclosure demonstrates that templating an MIP with PFAS templates of different lengths and/or types provides a synergistic effect in PFAS adsorption from solution. In an embodiment, the PFAS template is selected from the group consisting of PFCAs, such as PFOA, PFSAs, such as PFOS, GenX, 6:2 FtTAOS, PFHxSaAmA, ADONA, and combinations thereof.

In an embodiment, polymerizing the functional monomers coordinated with the PFAS template in the presence of an activated carbon substrate comprises introducing a crosslinker configured to crosslink the plurality of functional monomers and an activated carbon substrate to the pre-polymerization solution to provide a reaction solution; and introducing an initiator to the reaction solution thereby polymerizing the plurality of functional monomers to provide molecularly imprinted polymer (MIP) activated carbon.

In an embodiment, polymerizing the functional monomers coordinated with the PFAS template in the presence of an activated carbon substrate comprises polymerizing the functional monomers in the presence of a molecular crowding agent, such as polystyrene sulfonate.

In an embodiment, the crosslinker is N,N′-methylenebisacrylamide. In an embodiment, the initiator is 2,2′-azobis(2-methylpropionitrile).

In an embodiment, in a first step of MIP polymerization, the functional monomer (e.g., vinylbenzyl trimethylammonium chloride) and template (e.g., a PFAS) are mixed in water and stirred slowly for 10 h, allowing coordination between the monomer and template to occur via Van der Waals forces resulting in complexes held together by these weak bonds.

In an embodiment, in a second step of MIP polymerization, the crosslinker (e.g., N,N′-methylenebisacrylamide) and substrate (e.g., activated carbon) are added to the pre-polymerization solution which is stirred for an additional 30 min to achieve a homogenous mixture. Next, the initiator compound (i.e., 2,2′-azobis(2-methylpropionitrile)) is added and the reaction solution is heated to 60° C. to start the polymerization. This reaction is allowed to proceed for 15 h before the reaction solution is removed from heating and allowed to sit briefly to cool. The aqueous solution is then decanted, and the MIP functionalized activated carbon (AC@MIP) is retained for template extraction.

In the subsequent step of an embodiment, a template extraction solution containing 70% methanol and 1% sodium chloride in ultrapure water is added to the AC@MIP either in a batch or column set up to remove the template compound. Washing is considered complete when the concentration of template in the wash solution falls below acceptable levels. The AC@MIP is then washed with ultrapure water to remove excess methanol and salt, dried at 60° C. overnight, and stored in a sealed container for future use.

In an embodiment, the molecularly imprinted polymer (MIP) functionalized on AC via thermally activated radical initiated polymerization described herein is intended for the removal of per- and polyfluoroalkyl substances (PFAS) from aquatic matrices. MIPs are a class of polymers easily tailored to have high affinity and selectivity for a chosen target compound because of their unique production process. The target compounds (e.g., PFAS) which in an embodiment is used as a molecular template during synthesis after which it is extracted to leave behind a binding site with size, shape, and affinity specific to the template. Activated carbon materials (either with or without a nitrogen-addition pre-treatment) are used as a substrate for MIP attachment to obtain a high surface area adsorbent media with a shape and structure conducive to use in existing water treatment infrastructure. This process can be divided into three main steps: pre-polymerization coordination, polymerization, and template extraction.

In an embodiment, the activated carbon substrate is spent coffee grounds activated carbon made from pyrolyzing spent coffee grounds with a caustic. While spent coffee ground activated carbon is discussed, it will be understood that other types of activated carbon can be used and are within the scope of the present disclosure.

In an embodiment, the method includes modifying the activated carbon with a nitrogen moiety. In an embodiment, modifying the activated carbon occurs before coordinating the PFAS template with the plurality of functional monomers. Without wishing to be bound by theory, it is believed that such nitrogen moieties assist with coordinating with PFAS molecules.

In an embodiment, the method comprises, prior to introducing the activated carbon substrate to the pre-polymerization solution, heating the activated carbon substrate with melamine to modify the activated carbon substrate with the melamine. In an embodiment, the method further comprises rinsing the melamine-modified activated carbon substrate to remove unreacted melamine; and drying the rinsed melamine-modified activated carbon substrate.

In an embodiment, the method comprises, prior to introducing the activated carbon substrate to the pre-polymerization solution, contacting the activated carbon substrate with nitric acid and sulfuric acid to provide a nitrate-modified activated carbon substrate. In an embodiment, the method further comprises contacting the nitrate-modified activated carbon substrate with sodium dithionite to provide an amino-functionalized activated carbon substrate. In an embodiment, the method further comprises rinsing the amino-modified activated carbon substrate to remove unreacted nitric acid and sulfuric acid; and drying the rinsed amino-modified activated carbon substrate.

In an embodiment, nitrogen modification is accomplished via melamine addition. First, melamine is measured such that 1 g N is added per 1 g of activated carbon and mixed with ultrapure water (15 mL water per g activated carbon). This mixture is then added with the activated carbon to a ceramic crucible (VWR, Radnor, PA). The crucible lid is set in place and then the vessel is heated in a muffle furnace (Seattle Pottery Supply, Inc., Seattle, WA) at 400° C. for 1 h before the crucible is allowed to cool to room temperature. The final material is rinsed with ultrapure water to remove unreacted melamine and dried at 90° C. for 24 hr.

Method of Removing PFAS from a Solution

In another aspect, the present disclosure provides a method for removing PFAS from a solution. In an embodiment, the method comprises contacting a composition according to any embodiment of the present disclosure with a solution comprising PFAS, thereby coordinating the PFAS with the composition and removing the PFAS from the solution.

In an embodiment, the method further comprises rinsing or otherwise removing the PFAS from the composition, such as when the composition coordinated with the PFAS has been removed from or otherwise separated from the solution. Once the PFAS has been separated from the composition, the PFAS may be appropriately disposed of. Further, once the PFAS has been separated from the composition, the composition may be used to again remove PFAS from a solution.

In an embodiment, the solution is an aqueous solution. In an embodiment, the solution comprises wastewater. In an embodiment, the solution comprises a salt.

### Composition

In another aspect, the present disclosure provides a composition comprising an activated carbon and a MIP coupled to the activated carbon. In an embodiment, the composition is prepared using a method according to any embodiment of the present disclosure. As a result of the templating described further herein, the MIP may be configured to selectively adsorb a PFAS compound, such as to remove the PFAS compound from a solution in contact with the composition.

In an embodiment, the activated carbon comprises an amine functional group. As described further herein, the amine functional group can be suitable to coordinate with PFAS compounds. In an embodiment, the activated carbon can be reacted, such as before polymerization of the MIP, to include the amine functional group. In an embodiment, the amine functional group comprises a moiety selected from the group consisting of a pyrrolic-N, pyridinic-N, amine-N, graphitic-N, and pyridinic-N+ oxides, and combinations thereof.

In an embodiment, the MIP comprises repeating units comprising a quaternary nitrogen moiety. In an embodiment, the MIP comprises repeating units selected from the group consisting of (vinylbenzyl trimethylammonium chloride, [2-(Methacryloyloxy)ethyl] trimethylammonium chloride) and 2-(trifluoromethyl)acrylic acid.

In an embodiment, the composition comprises a specific surface area in a range between about 700 m²/g and about 1100 m²/g. In an embodiment, the composition comprises a specific surface area in a range between about 700 m²/g and about 850 m²/g. In an embodiment, the composition comprises a specific surface area in a range between about 750 m²/g and about 850 m²/g. In an embodiment, the composition comprises a specific surface area in a range between about 1000 m²/g and about 1400 m²/g, such as where the MIP is templated on multiple PFAS templates.

In an embodiment, a thickness of the MIP is in a range between about 10 nm and about 500 nm. In an embodiment, a thickness of the MIP is in a range between about 10 nm and about 250 nm. In an embodiment, a thickness of the MIP is about 200 nm.

### EXAMPLES

### Example 1

Wastewater is an important source of perfluoroalkyl acids (PFAAs) to environmental waters. PFAAs are poorly removed during conventional wastewater treatment and only moderately removed by non-selective adsorbents (e.g., activated carbon). Molecularly imprinted polymers (MIPs) enable selective adsorption of trace organics (e.g., PFAAs) by templating polymerization with a target compound; however, MIP morphology limits use for wastewater treatment. To overcome this obstacle, a perfluorooctanesulfonate (PFOS)-templated MIP was immobilized on a spent coffee grounds biochar—an eco-friendly activated carbon alternative—via radical initiated polymerization. Vinylbenzyl trimethylammonium chloride (VBTAC) and/or 2-(trifluoromethyl)acrylic acid (TFMA) served as functional monomers for MIP synthesis. First, biochar surfaces were functionalized with —NH MIP attachment points via: (i) electrophilic aromatic substitution followed by reduction; or, (ii) heat-catalyzed addition of melamine. Melamine-modified biochar functionalized with VBTAC-MIP (BC-M@MIP-V) demonstrated high PFOS selectivity (K_{selectivity} of 4.52 for perfluorobutanesulfonic acid and 3.76 for perfluorooctanoic acid) and PFAA adsorption comparable to unmodified biochar in ultrapure water (0.043 and 0.039 mg PFAA/g*g/m², respectively). Adsorption by BC-M@MIP-V increased by 0.012 mg PFAA/g*g/m² in synthetic wastewater due to reduced MIP swelling and non-specific binding. Single cycle regeneration of the BC@MIP composites suggest long material lifetimes are possible. These selective adsorbent presents a potential alternative for effective wastewater PFAA treatment.

### Materials and Methods

### Spent Coffee Grounds Biochar Surface Nitrogen Functionalization

The spent coffee grounds biochar, an AC derived from used coffee grounds, was produced from locally sourced waste material via a two-step process: pyrolysis followed by activation. Details on chemical grades and sources are provided further herein.

Two methods were explored for addition of nitrogen-containing surface functional groups to the BC substrate to facilitate subsequent polymer functionalization via radical initiated polymerization. In the first method, nitro (—NO₂) groups were introduced to the BC via electrophilic aromatic substitution by mixing the unmodified biochar with equal volumes of concentrated sulfuric and nitric acid. Nitro groups were then reduced to —NHₓ groups through addition of sodium dithionite, ammonium hydroxide, and acetic acid while heating under reflux. The final product was designated biochar-N (BC-N). In the second amine modification method, a nitrogen source (melamine or ammonium chloride) was added to BC in water and the mixture was heated to catalyze attachment of nitrogen containing functional groups. Modified biochar were designated BC-M (melamine) and BC-A (ammonium chloride). Additional experimental details for these modifications are given further herein.

### Chemicals and Materials

Spent coffee grounds (SCG) for biochar production were donated by Bay Laurel Catering Services at the University of Washington (Seattle, WA) from Starbucks® Pike Place® grounds, medium roast, arabica coffee sourced from Latin America after use in an industrial drip coffee maker.

All chemicals used herein were ACS reagent grade or equivalent unless otherwise noted. Potassium hydroxide pellets and high purity nitrogen gas (99.998%) used for biochar production were purchased from Fisher Scientific (Waltham, MA) and Praxair (Danbury, CT), respectively. Nitrogen modification of the SCG biochar was accomplished with sulfuric acid (H₂SO₄, 95-98%), nitric acid (HNO₃, 69%), glacial acetic acid (EMSURE®, 99.8%), ammonium chloride (99.5%) purchased from VWR Chemical (Radnor, PA); sodium dithionate (technical grade) and ammonium hydroxide solution (28-30%) purchased from Sigma Aldrich (St. Louis, MO); and isopropyl alcohol (IPA) and melamine (99% assay) purchased from Thermo Fisher Scientific (Hampton, NH).

Molecularly imprinted polymers were synthesized using perfluorooctanesulfonate potassium salt (PFOS, 98.0%) purchased from Sigma Aldrich as the template; vinylbenzyl trimethylammonium chloride (VBTAC, 96.0%) purchased from Thermo Fisher Scientific, and 2-(trifluoromethyl)acrylic acid (TFMA, 98%) and [2-(Methacryloyloxy)ethyl] trimethylammonium chloride solution (DMC, 75% in H₂O) purchased from Sigma Aldrich as functional monomers; N,N′-methylenebisacrylamide (MBA, 96.0%) purchased from Thermo Fisher Scientific as the crosslinker; 2,2′-azobis(2-methylpropionitrile) (AIBN, 98%) purchased from Sigma Aldrich as the initiator. Methanol purchased from Fisher Scientific and sodium chloride (NaCl) purchased from VWR Chemical were used for template washing and regeneration of spent adsorbent.

Optima™ LC/MS grade methanol purchased from Thermo Fisher Scientific was used for preparation of stock solutions and LC-MS/MS samples for all batch tests. Perfluorooctanesulfonate potassium salt (PFOS, 98.0%), perfluorooctanoate potassium salt (PFOA, 95%), perfluorobutanesulfonic acid (PFBS, 97%), Reagent Plus® grade caffeine, pentachlorophenol (PCP, 97%), bovine serum albumin lyophilized powder (96%), alginic acid sodium salt from brown algae, technical grade humic acid, octanoic acid (98%), calcium chloride (99%), 4-(2-hydroxyethyl)piperazine-1-ethanesulfonic acid (HEPES, 99.5% purity by titration), and 0.2 micron, 25 mm diameter cellulose acetate (CA) syringe filters for sample filtration were purchased from Sigma Aldrich. HPLC grade fipronil (97%) was purchased from Chem-Impex International (Wood Dale, IL). Magnesium chloride (99%) was purchased from VWR Chemical and sodium hydroxide was purchased from Fisher Scientific. Analytical and mass-labeled PFAS standards were purchased from Wellington Laboratories (Ontario, Canada). Mass labeled diuron-d₆ purchased from Sigma Aldrich was used as the internal standard for caffeine quantification since both compounds elute at similar retention times and are measured via positive electrospray ionization in the mass spectrometer.

### Detailed Methods for Production of Nitrogen Modified Biochar

Two primary methods were employed for nitrogen modification of biochar: (1) electrophilic aromatic substitution followed by reduction, and (2) addition of melamine or ammonium chloride via heating in a muffle furnace. In the first method, nitro (—NO₂) groups were functionalized on the biochar surface by mixing the SCGKOH with equal volumes of concentrated nitric (69%) and sulfuric (98%) acids at a 1:17 mass:volume ratio (i.e., for every 1 g of SCGKOH, 17 mL of each acid was added). This mixture was placed in an ice bath inside a fume hood and stirred for 3 h. At the end of the reaction period, the reaction solution was diluted five times with ultrapure water (Milli-Q; 18.2 MΩ-cm; Millipore Sigma) and filtered using a vacuum pump filter and Whatman GF/A 42.5 mm filter paper (Whatman, United Kingdom) to collect the biochar. The collected biochar was then added to 50 mL of ultrapure water in a polypropylene tube and rotated at 40 rpm for 30 minutes to wash off residual acid. The wash process was repeated with isopropyl alcohol, and the final product was dried at 90° C. overnight and stored in an airtight container prior to further modification or characterization. To reduce nitro groups to amine (—NH₂) groups, 2.2 g of the dried nitro-modified SCGKOH was added to 22 mL of ultrapure and 8.8 mL of ammonium hydroxide and stirred for 15 min. Then, 12.1 g of sodium dithionite was added, and the mixture was stirred for 20 h at 200 rpm. Next, 52.8 mL of acetic acid was added, and the mixture was heated at 98° C. under reflux for 5 h. After the 5-h reaction, the solution was filtered with Whatman GF 100 filter paper and washed to remove residual reaction solution. Washing steps were as follows: ultrapure water for 1 h, isopropyl alcohol for 1 h, ultrapure water for 30 min. All washes were conducted with 50 mL of wash solution in a polypropylene tube and rotated at 40 rpm. The final product was designated biochar-N (BC-N). A BC-N2 material was also prepared via the same general method (with a 6 h mixing time during the first nitration step) and functionalized with the MIP; however, initial evaluation of this substrate material showed poor PFOS removal.

In the second method, either melamine or ammonium chloride was measured such that 1 g N was added per 1 g of SCGKOH. The melamine or ammonium chloride was mixed with ultrapure water (15 mL water per g SCGKOH), and then added with the SCGKOH to a ceramic crucible (VWR, Radnor, PA). The crucible lid was added, then the vessel was heated in a muffle furnace (Seattle Pottery Supply, Inc., Seattle, WA) at 400° C. for 1 h before the crucible was allowed to cool to room temperature. The final material was rinsed with ultrapure water to remove unreacted melamine or ammonium chloride and dried at 90° C. for 24 hr. Modified biochar were designated BC-M (melamine) and BC-A (ammonium chloride).

Two alternative methods for nitrogen modification of biochar were also evaluated but found to perform poorly compared to the BC-N, BC-M, and BC-A materials. The first is described further herein. Briefly, 0.2051 g melamine was mixed with 0.244 g SCGKOH and 2.5 mL water and placed in a quartz boat (rather than a ceramic crucible). The quartz boat was placed in a Hogentogler Protégé Split Tube Furnace (Hogentogler, Colombia, MD) with 500 mL/min nitrogen gas flow for 20 minutes to purge all oxygen from the atmosphere. Next, the furnace was heated to 400° C. at a ramp rate of 10° C./min and held there for 1 hour to catalyze the reaction with melamine. After the process was completed, the final material was rinsed with ultrapure water as described further herein, and the final product was designated BC-M1-2.

The second nitrogen modification method also used melamine as the nitrogen source. First, melamine was mixed with Milli-Q water at a 1 g melamine to 100 mL water ratio and stirred for 20-30 minutes until the melamine was well mixed (the solubility of melamine in water at 20° C. is 3240 mg/L, therefore the melamine did not completely dissolve). The melamine and water mixture was then added to a Teflon lined, stainless steel hydrothermal autoclave along with 1 g of biochar placed in a muffle furnace at 160° C. for 24 hours. At the end of the reaction time, the autoclave was taken out of the muffle furnace and allowed to cool to room temperature before removing the modified biochar. The biochar was placed in a 50 mL polypropylene tube with 50 mL Milli-Q water and rotated at 40 rpm for at least 30 minutes to remove excess melamine. This wash step was repeated until the pH was circumneutral. Washed biochar was placed in and oven and dried overnight at 90° C. The final biochar product was stored in an air-tight container until further use and was designated BC-M2.

### Physicochemical Characterization of Nitrogen Functionalized Biochar

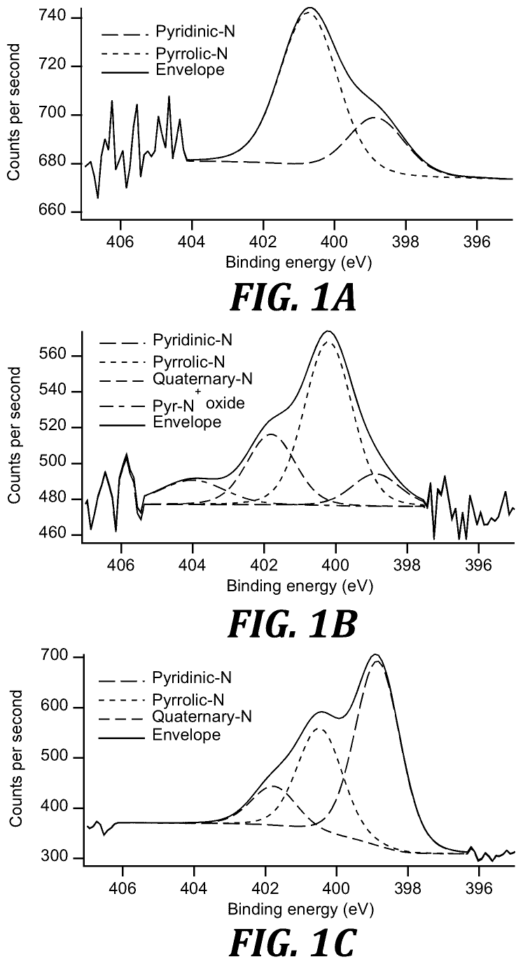

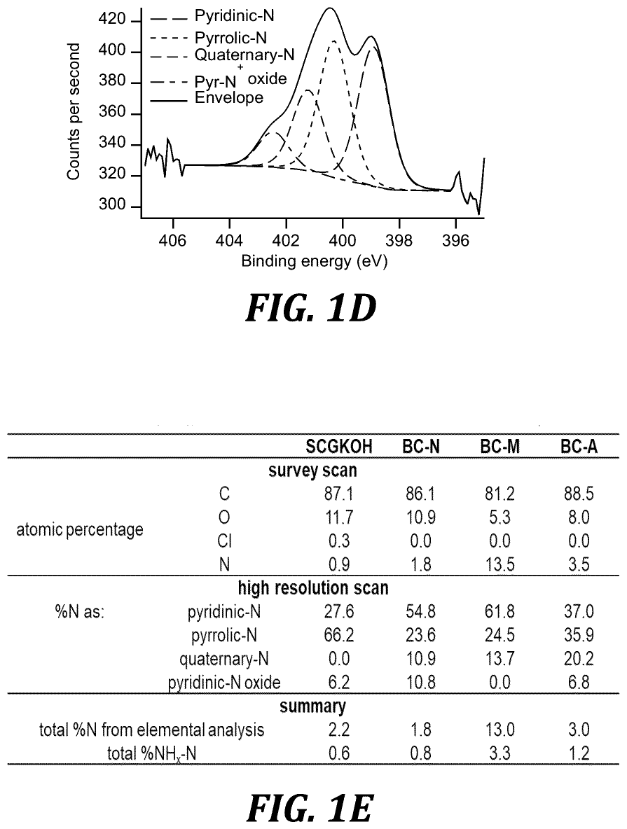

Several types of nitrogen-containing functional groups are commonly found in highly aromatic carbon materials (like biochar) and were expected here, including: pyrrolic-N, pyridinic-N, amine-N, graphitic-N, and pyridinic-N⁺ oxides (FIGS. 1A-1E). Pyrrolic, amine, and some quaternary nitrogen groups all contain an —NHₓ moiety that can participate in radical initiated polymerization, and were thus the desired types of nitrogen groups described herein. Nitrogen modification was performed to increase the naturally occurring percentage of —NHₓ groups on the biochar substrate. The BC-N, BC-M, and BC-A were characterized using several techniques described below to confirm modification success, characterize the types of nitrogen-containing functional groups, and quantify the coverage and extent of each type.

Thermogravimetric analysis (TGA) was performed to quantify the mass of nitrogen-containing functional groups added to the modified BC. The mass added was calculated as the absolute value of the difference between the mass lost from the modified and unmodified BC. TGA was performed from room temperature to 800° C. at a ramp rate of 10° C./min on a TA Instruments (New Castle, DE) TGA Q50 with a nitrogen purge throughout.

Proximate carbon analysis paired with elemental analysis was performed to quantify the mass percentages of nitrogen and oxygen added to the biochar materials during nitrogen modification. Proximate carbon analysis was completed using the ASTM D1762-84 method (reapproved 2007). Carbon, hydrogen, nitrogen (CHN) elemental analysis was completed on a Perkin Elmer (Waltham, MA) 2400 Series elemental analyzer. The oxygen content was calculated as the remainder out of 100% after carbon, hydrogen, nitrogen, and ash.

Two spectroscopic analyses were performed to identify and quantify the nitrogen surface functional groups. X-ray photoelectron spectroscopy (XPS) was conducted on a Kratos (Manchester, UK) Axis Ultra DLD X-ray Photoelectron Spectrometer. XPS data was referenced to an adventitious carbon peak with binding energy of 285.0 eV. Additional peak fitting details are included further herein. Diffuse Reflectance Fourier Transform Infrared Spectroscopy (DRIFTS) measurements were collected on a Thermo Scientific™ (Waltham, MA) Nicolet™ iSTM10 FT-IR Spectrometer using a KBr to biochar mass ratio of 10:1. Collected spectra were corrected with the atmospheric suppression and auto background corrections available in the OMNIC processing software from Thermo Fisher.

### Additional Physicochemical Characterization of Nitrogen Modified Biochar

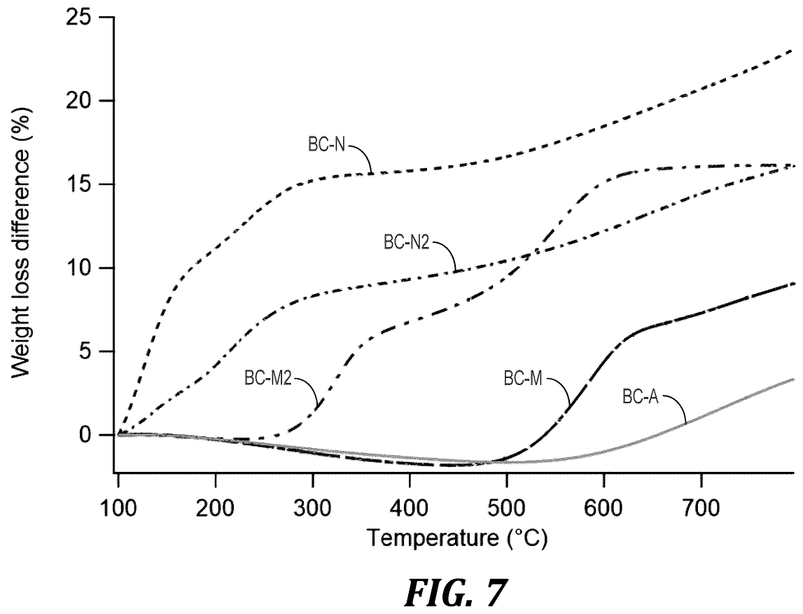

Characterization of nitrogen-modified biochar composition via thermogravimetric analysis (TGA, FIG. 7) and elemental analysis (TABLE 2) were conducted as a first pass evaluation of the success of nitrogen modification for all modification methods employed and to rule out modification methods with poor attachment of nitrogen functional groups. In particular, biochars modified with the same nitrogen source (e.g., nitration or melamine addition) were compared against each other to select the optimal method for each nitrogen source. Comparison of TGA spectra from the BC-N and BC-N2 materials revealed the BC-N nitrogen modification resulted in a much greater mass of added nitrogen-containing surface functional groups on the BC-N. These results indicated the BC-N2 was unlikely to perform well for molecularly imprinted polymer (MIP) functionalization, and excluded from future analyses. PFAA adsorption on the BC-N2 and BC-N2@MIP were performed to validate the exclusion of more comprehensive BC-N2 evaluation. The BC-M1-2 material was also excluded from future evaluation because the percent nitrogen from elemental analysis was low compared to the BC-M substrate. Similarly, the BC-M2 method was excluded for two reasons. First, although the percent nitrogen from elemental analysis was comparable to that of BC-M, TGA results indicated the melamine was poorly attached to biochar matrix compared the BC-M attachment as evidenced by the much larger weight loss difference. Secondly, the production process for the BC-M2 was more energy and time intensive than for BC-M, making this a less desirable modification method.

TABLE 2
Elemental composition of nitrogen modified biochar materials
from elemental analysis and proximate carbon analysis.

| | Elemental Analysis | | | | | % N |
|---|---|---|---|---|---|---|
| Sample ID | C % | H % | N % | O %* | Ash % | increase |
| SCGKOH | 81.4 ± 2.3 | 0.76 ± 0.0 | 2.17 ± 0.1 | 12.2 | 3.85 ± 0.2 | — |
| BC-N | 69.4 ± 0.2 | 2.19 ± 0.0 | 1.8 ± 0.1 | 23.7 | 2.9 ± 0.5 | −0.3 |
| BC-M | 64.6 ± 3.5 | 1.1 ± 0.0 | 13.0 ± 0.6 | 19.5 | 1.8 ± 0.2 | 10.8 |
| BC-M1-2 | 73.7 ± 1.6 | 1.3 ± 0.0 | 5.8 ± 0.2 | ND | ND | 3.6 |
| BC-M2 | 68.5 ± 3.3 | 1.6 ± 0.1 | 14.4 ± 0.6 | 13.9 | 1.5 ± 0.1 | 12.3 |
| BC-A | 65.0 ± 1.5 | 1.0 ± 0.1 | 3.0 ± 0.1 | 29.4 | 1.6 ± 0.1 | 0.9 |

ND: not detected

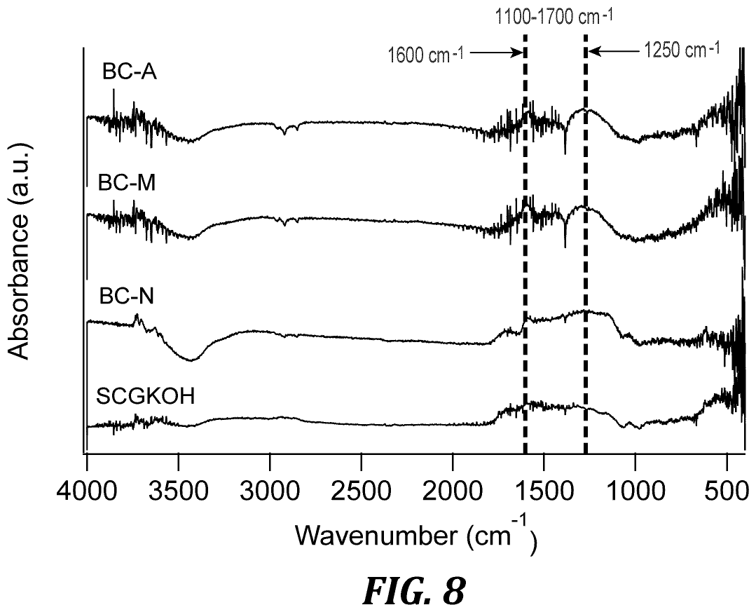

DRIFTS spectra were collected for the remaining nitrogen modified biochar materials to provide additional information about the surface functional groups (FIG. 8). The BC-M and BC-A DRIFTS spectra show clear peaks at 1600 cm⁻¹ and 1250 cm⁻¹ that correspond to N—H bending and C—N stretching from aromatic amines. These peaks are notably absent in the SCGKOH base material spectra. The BC-N also displayed the 1600 cm⁻¹ and 1250 cm⁻¹ peaks, although they are harder to distinguish due to their smaller size and the masking effect of the broad band (from around 1100-1700 cm⁻¹) seen on all four spectra which corresponds to aromatic and aliphatic hydrocarbon peaks typical of activated carbons and biochar. The smaller 1600 cm⁻¹ nitrogen peak size in the BC-N spectra also indicates a lower nitrogen density for this material.

### XPS Peak Fitting Details

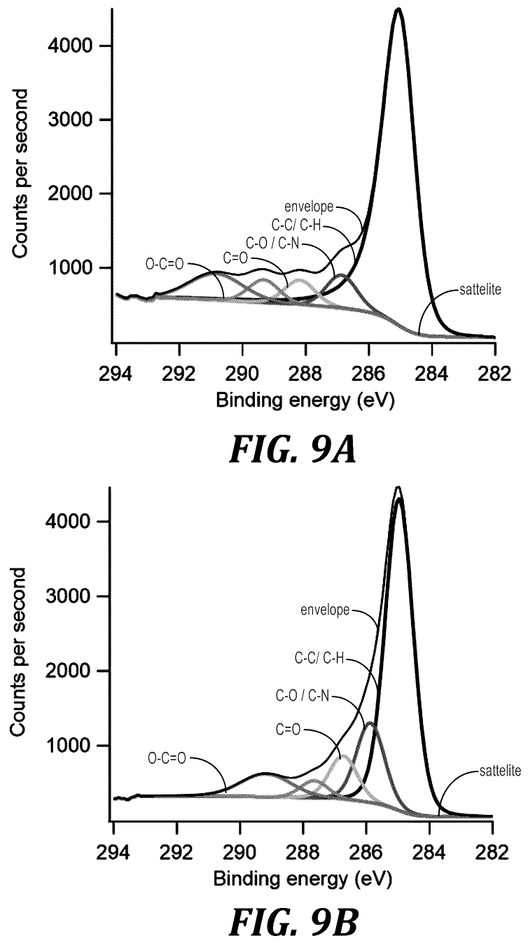

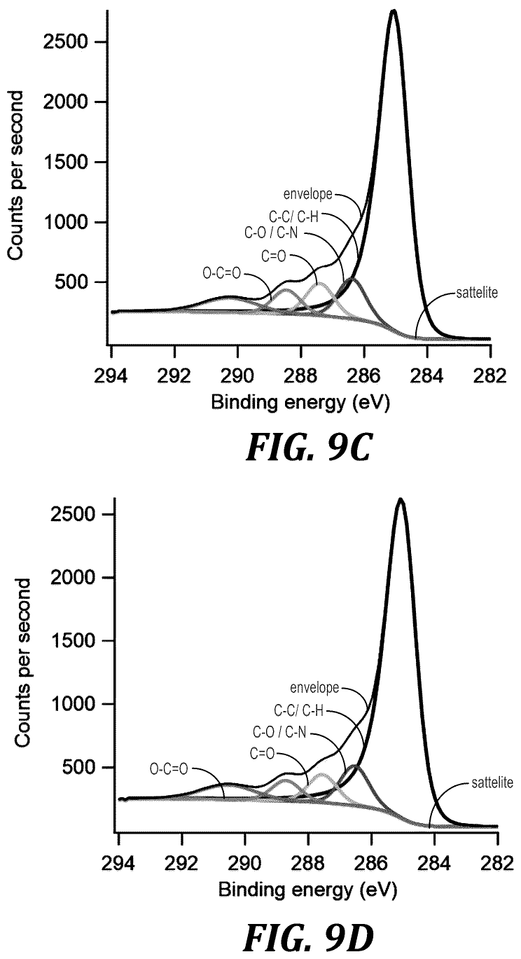

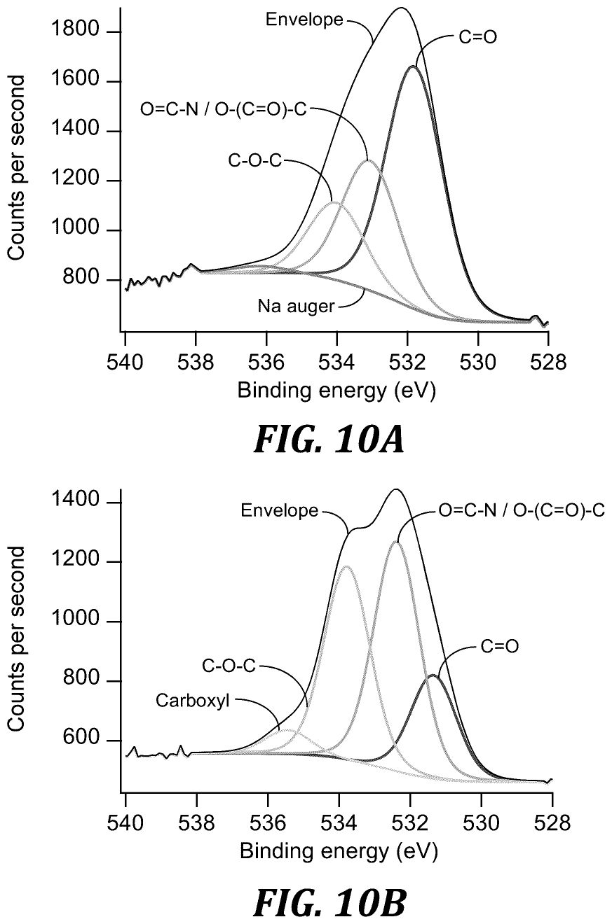

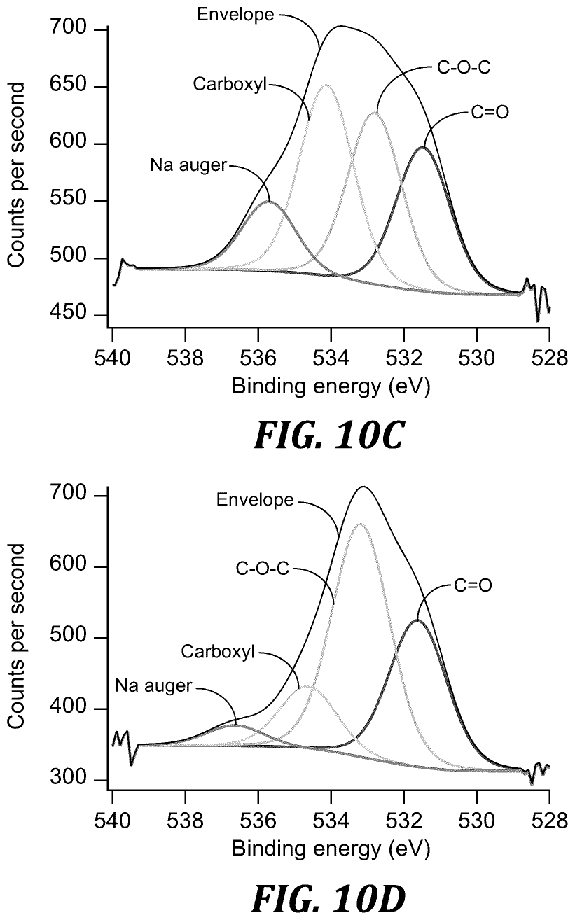

XPS data were collected from biochar samples using the #30-50 mesh size fraction via three scan types. A survey scan combined with a detailed nitrogen scan were used to determine the atomic percentages of each element on the material surface. A high-resolution scan for nitrogen (N1s), carbon (C1s), and oxygen (O1s) were used to obtain more detailed information about the binding energy and types of functional groups present. XPS data was fitted with the Casa XPS software, version 2.3.25 using a Shirley background and a Gaussian-Lorentzian peak shape (70% Gaussian, 30% Lorentzian). Peak shape was further constrained such that the full width at half max (FWHM) was approximately 0.7-1.9 eV and was consistent between peaks from a single scan. Peak separation was limited to no less than 0.5 eV, and all peaks were referenced to an adventitious carbon peak at 285.0 eV. The high-resolution carbon and oxygen spectra are shown in FIGS. 9A-9D and FIGS. 10A-10D.

### Effect of Nitrogen Modification on PFAA Adsorption Capabilities

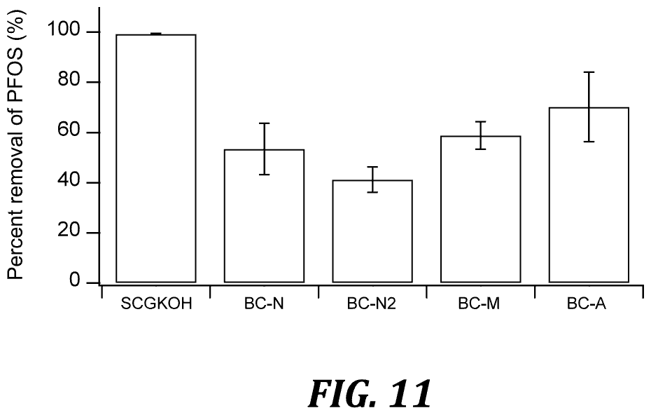

PFOS adsorption by nitrogen modified biochar materials was compared to that on the base material (SCGKOH) to evaluate any change in adsorption capabilities from the modification process. Briefly, 5 mg biochar and 50 mL ultrapure water were placed in a 50 mL polypropylene centrifuge tube and PFOS was added from concentrated methanol stock to achieve an initial concentration of 4490±478 μg/L PFOS with a methanol concentration of not more than 0.2%. Samples were prepared in triplicate and allowed to rotate at 40 rpm on a Fisherbrand™ Multi-Purpose Tube Rotator (Fisher Scientific, Waltham, MA) for 4 days to achieve equilibrium. At the end of the equilibration time, samples were filtered with a 0.2 micron cellulose acetate (CA) syringe filter (VWR, Radnor, PA) and prepared for analysis as described further herein. Results from this test are shown in FIG. 11 and indicate decreased adsorption capability after nitrogen modification with only slight variation observed between the different modification methods.

### Molecularly Imprinted Polymer Functionalization of Biochar

As described herein, a MIP material assembled with perfluorooctanesulfonate (PFOS) template was functionalized onto a spent coffee grounds activated biochar to produce an adsorbent composite with high PFAA selectivity. PFOS was chosen as a template compound because: (1) it can participate in relatively strong electrostatic and hydrophobic interactions compared to other PFAAs which will increase the likelihood of successful imprinting; (2) the 8-carbon backbone length should result in MIP binding sites capable of adsorbing a number of equal-length and shorter PFAAs; and, (3) it is one of the most widely detected PFAAs in the environment. The objectives of the present disclosure include (1) modifying the spent coffee grounds biochar with nitrogen containing functional groups via low-impact methods that do not significantly alter the biochar structure or PFAA removal capability; (2) functionalizing the nitrogen-modified biochar with a PFAA selective MIP layer; and, (3) evaluating the ability of the MIP-functionalized biochar (BC@MIP) to selectively remove and recover PFAAs in ultrapure water and synthetic wastewater matrices. To our knowledge, however, functionalization of a MIP onto a biochar substrate and evaluation of PFAS imprinted polymer performance in synthetic wastewater have yet to be explored. Development and characterization of a BC@MIP adsorbent for targeted PFAA adsorption and recovery described herein can provide more environmentally sustainable and advantageous alternatives to activated carbon for PFAA separation during water treatment.

A layer of MIP was functionalized on the surface of the nitrogen-modified biochar via thermally activated radical initiated polymerization to increase selectivity of the adsorbent for PFAAs. Three functional monomers were chosen for polymerization: two containing a quaternary nitrogen moiety (vinylbenzyl trimethylammonium chloride, VBTAC and [2-(Methacryloyloxy)ethyl] trimethylammonium chloride, DMC) and one containing a fluorocarbon moiety (TFMA). The monomers were used individually or in combination as described in TABLE 1. Quaternary nitrogen moieties have been shown to retain a positive charge over a wide pH range and have been hypothesized to electrostatically attract the negatively charged headgroups of most.

TABLE 1
MIP composite composition, BET specific surface area and pore size.

| | | | | functional monomers | |
|---|---|---|---|---|---|
| adsorbent name¹ | biochar substrate | BET surface area (m²/g) | pore size² (nm) | 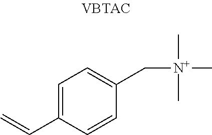 | 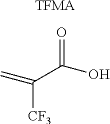 |
| spent coffee | BC | 858 | 1.42 | — | — |
| grounds biochar | | | | | |
| BC-N@MIP-V | BC-N | 741 | 1.53 | Y | — |
| BC-A@MIP-VF | BC-A | 1054 | 1.47 | Y | Y |
| BC-M@MIP-VF | BC-M | 806 | 1.56 | Y | Y |
| BC-M@MIP-V | BC-M | 155 | 8.88 | Y | — |

¹All samples analyzed were #30-#50 mesh particle size
²BJH average pore radius (2V/A)
VBTAC: (vinylbenzyl)trimethylammonium chloride; TFMA: (2-(trifluoromethyl)acrylic acid

PFAA compounds across environmentally-relevant pH ranges—a feature for selective PFAA adsorption. Therefore, VBTAC and DMC were chosen for their similar molecular length to PFOS, a property which has been shown to increase interactions in aqueous systems. In an embodiment, fluorocarbon-containing functional monomers were demonstrated to improve adsorption of long-chain PFAAs during MIP synthesis. N,N′-methylenebisacrylamide (MBA) was used as a crosslinker because it is highly water soluble and thus a common option for synthesis of hydrophilic MIP materials intended for use in aqueous systems; and 2,2′-azobis(2-methylpropionitrile) (AIBN) was used as the radical initiator commonly used for MIP synthesis.

In an embodiment, MIP production was accomplished in three steps: pre-polymerization mixing, thermally activated radical initiated polymerization, and template washing. Briefly, approximately 0.43 mmol of PFOS and 0.86 mmol of each functional monomer were added to 170 mL of ultrapure water and stirred at 150 rpm at room temperature for 10 h to allow the template and functional monomers to align. At the same time, 0.5 g of N-modified biochar was added to approximately 40 mL of ultrapure water in a separate container and allowed to sit for 10 h to pre-wet the biochar. At the end of the pre-polymerization time, 8.59 mmol MBA and the wetted biochar were added to the polymerization mixture and mixed for 30 min. Next, 1.00 mmol AIBN was added to the reaction vessel to initiate polymerization and the reaction solution was mixed at 150 rpm and 60° C. in a water bath for 15 hr. Following polymerization, the functionalized biochar was separated from solution and rinsed with methanol to remove unattached polymer. Finally, the functionalized biochar was placed in 100 mL of a 70% methanol/1% NaCl solution and shaken at 200 rpm and 33° C. for 24 h to extract the template. This process was repeated until the PFOS concentration in the wash solution dropped below 2000 μg/L (a decrease from PFOS concentrations in the first wash which are typically around 100-200 mg/L), at which point the biochar was washed for 24 h in ultrapure water and then dried at 60° C. overnight. The final product was then stored in a sealed container for further use.

### Characterization of Molecularly Imprinted Polymer Layer

In an embodiment, several characterization methods were undertaken to evaluate the extent and thickness of the polymer layer. A JOEL JSM-6010PLUS/LA Analytical Scanning Electron Microscope (SEM; JOEL, Peabody, MA) was used to image the samples and measure coating thickness. Transmission Electron Microscopy (TEM) samples were embedded in a Mollenhauer epoxy resin which was polymerized at 60° C. overnight, then microtomed to 80 nm using a Leica EM UC6 and a hard diamond knife, dried on a carbon mesh, and stored in a desiccator until imaging. An FEI Tecnai G2 F20 Twin or Tecnai G2 F20 SuperTwin Transmission Electron Microscope (FEI, Hillsboro, OR) was used to visualize the thickness of the polymer layer and provide insight into the extent of the MIP functionalization. Specific surface area was measured with nitrogen adsorption at 77K and Brunner-Emmet-Teller (BET) fitting on a Micromeritics 3Flex Analyzer (Micromeritics, Norcross, GA) to quantify changes in the specific surface area (SSA) resulting from the nitrogen modification and polymer functionalization processes.

### Batch Adsorption Tests for PFOS Selectivity

Three batch adsorption tests were performed to evaluate PFAA removal capabilities and selectivity of the MIP-biochar materials. For all batch tests, 50 mL of the reaction matrix and 5 mg of MIP-functionalized biochar were first added to a 50 mL polypropylene tube followed by sufficient volume of methanol-based PFAA (or organic contaminant) stock solution to achieve the desired initial concentration while maintaining a methanol concentration of not more than 1% v/v. Samples were prepared in triplicate, rotated for 4 days to achieve equilibrium adsorption, then filtered and prepared for analysis. First, adsorption of 4275±342 μg/L PFOS was evaluated for all MIP materials in ultrapure water to provide information on the relative adsorption capacity for the template compound. The importance of functional monomer selection was particularly evident for this test because no competing contaminants were evaluated. Second, adsorption of 1476±207 μg/L PFOS, 1166±153 μg/L PFBS, and 1453±582 μg/L PFOA in ultrapure water was performed to evaluate adsorption capabilities for PFAAs of different chain length (PFBS, 4-chain) and head group (PFOA, carboxylic acid) from the template (8-chain, sulfonic acid). A PFAA shorter than PFOA and PFOS (i.e., PFBS) was included due to the greater production and environmental detection of short-chain PFAAs compared to longer PFAAs. Sample pH was not adjusted or controlled during these two screening batch tests; however, final pH was measured and found to be 6.5±0.5. Results from these tests were used to screen the MIP-functionalized biochar composites, and the BC-N@MIP-V, BC-M@MIP-VF, and BC-M@MIP-V composites were chosen for further evaluation (TABLE 1). Finally, PFAA adsorption was evaluated in a synthetic wastewater matrix containing compounds representative of possible components found in WWTP effluent: divalent cations and synthetic effluent organic matter (sEfOM; details provided further herein), PFAAs (i.e., 1659±99 μg/L PFOS, 1400±11 μg/L PFBS and 2313±71 μg/L PFOA), and co-occurring organic contaminants (i.e., 1916±76 μg/L caffeine, 1520±63 μg/L fipronil, and 3385±217 μg/L pentachlorophenol (PCP)). Concentrations of PFAAs and co-occurring organics were set to be approximately equal to each other to assess the ability of the MIP-biochar composites to selectively adsorb PFAAs in a more complex matrix representative of secondary wastewater effluent conditions. Concentrations were much higher than would typically be found in wastewater effluent to better differentiate the adsorption capabilities of each adsorbent material. The pH was adjusted at the start of the test to 7.0±0.1 with sodium hydroxide (NaOH) and buffered with 5 mM HEPES to maintain a constant pH throughout the test. Final concentrations of PFAAs and organic contaminants were analyzed via tandem liquid chromatography-mass spectrometry (LC-MS/MS).

Normalized equilibrium adsorption (q_{e,SSA}) and the liquid-solid distribution coefficient (K_{d}) were calculated from the results of each batch test using the following equations:

$$\begin{matrix}{q}_{e , SSA} = ( {C}_{0} - {C}_{e} ) * \frac{V}{{m}_{ads}} * \frac{1}{BET SA} & Eqn . 1 \\ {K}_{d} = \frac{{C}_{0} - {C}_{e}}{{C}_{e}} * \frac{V}{{m}_{ads}} & Eqn . 2\end{matrix}$$

Where C₀ and Cₑ were the initial and equilibrium adsorbent concentrations (mg/L), V was the sample volume (L), m_{ads} was the adsorbate mass (g), and the BET surface area (BET SA) was taken from TABLE 1 (g/m²). The selectivity coefficient (K_{selectivity}) was calculated from the results of the PFAS competition test in ultrapure water and the synthetic wastewater batch tests using equations 3-5. The PFOS template was used as the reference adsorbate and the unmodified BC was used as the reference adsorbent.

$$\begin{matrix}{K}_{imprinted} = \frac{{q}_{e , BC @ MIP , PFOS}}{{q}_{e , BC @ MIP , PFOA / PFBS / organics}} & Eqn . 3 \\ {K}_{comparison} = \frac{{q}_{e , SCGKOH , PFOS}}{{q}_{e , BC @ MIP , PFOA / PFBS / organics}} & Eqn . 4 \\ {K}_{selectivity} = \frac{{K}_{imprinted}}{{K}_{comparison}} & Eqn . 5\end{matrix}$$

### Regeneration of Spent Adsorbent

Single cycle regeneration of spent adsorbent was performed following adsorption of PFOS in ultrapure water and following adsorption of PFAAs and co-occurring organics in the synthetic wastewater matrix to assess opportunities for reuse. The template extraction wash solution was used for composite imprinting site regeneration. Briefly, after collection of LC-MS/MS samples for each adsorption test, the remainder of the adsorption solution was decanted and 50 mL of 70% MeOH/1% NaCl was added to each test tube of spent adsorbent. Samples were capped, wrapped in parafilm to minimize evaporation of MeOH, and rotated at 40 rpm for 24 h to facilitated desorption prior to analyte concentration quantification.

### Effects of Alternative Nitrogen Modification Methods and Functional Monomer Selection on PFAA Removal by Molecularly Imprinted Polymer (MIP) Functionalized Biochar

Several biochar MIP composite adsorbents were synthesized in addition to those discussed further herein to evaluate the effect of nitrogen modification method and functional monomer selection on the final BC@MIP composite performance. The composition of these adsorbents is given in TABLE 3. Preliminary screening of MIP performance was conducted via two batch adsorption tests, both performed in ultrapure water using the methods and parameters (i.e., solution volume, adsorbent concentration, test time, and sample preparation methods). The first batch test evaluated adsorption of 4174±302 μg/L of the PFOS template. The second batch test evaluated competitive adsorption of three PFAAs: 1478±185 μg/L PFOS, 1152±135 g/L PFBS, and 1380±515 μg/L PFOA. Regeneration of spent adsorbent was not evaluated since the purpose of these preliminary tests was merely to screen adsorbent performance in order to inform further testing.

TABLE 3
Molecularly imprinted polymer (MIP) naming convention by nitrogen
modification method and functional monomer selection.

| | | functional monomers | | |
|---|---|---|---|---|
| adsorbent name | biochar substrate | 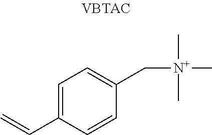 | 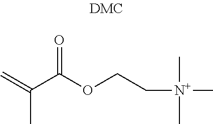 | 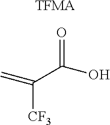 |
| BC-N@MIP-V | BC-N | Y | — | — |
| BC-N@MIP-VF | BC-N | Y | — | Y |
| BC-N@MIP-DF | BC-N | — | Y | Y |
| BC-N2@MIP-VF | BC-N2 | Y | — | Y |
| BC-N2@MIP-DF | BC-N2 | — | Y | Y |
| BC-A@MIP-VF | BC-A | Y | — | Y |
| BC-M@MIP-VF | BC-M | Y | — | Y |
| BC-M@MIP-V | BC-M | Y | — | — |

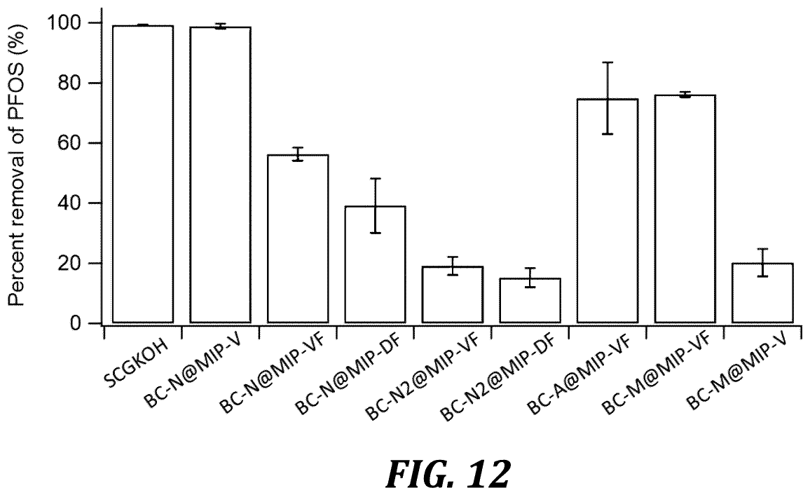

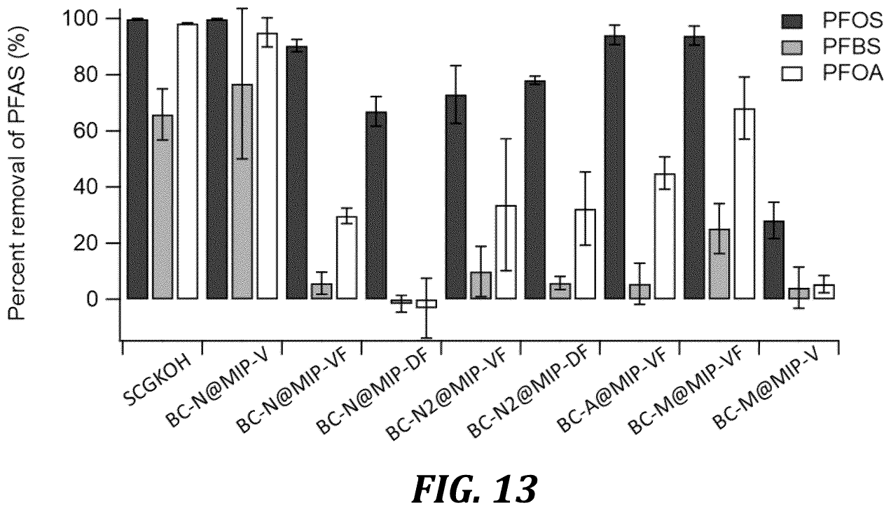

Adsorption test results (FIG. 12 and FIG. 13) revealed poor performance of biochar MIP composite materials synthesized with the DMC functional monomer and with the BC-N2 substrate. It is hypothesized that the oxygen containing moieties on the DMC may have repelled the anionic PFAAs, decreasing overall adsorption efficiency. The poor performance of adsorbents produced with the BC-N2 substrate agrees with the discussion further herein. Thus, both the DMC and BC-N2 were excluded from future use and no additional testing was performed with the adsorbent materials made using these components. The BC-M@MIP-V material also experienced low percent removal of PFAAs in both tests; however, this was attributed to the low specific surface area (SSA) of the material rather than the functional monomer selection or nitrogen modification method. Low SSA was not expected to be a factor in the low percent removal by the BC-N@MIP-DF, BC-N2@MIP-VF, or BC-N2@MIP-DF for two reasons. First, the biochar substrates had relatively low-NH moiety density compared to the BC-M. Second, all three materials contained the TFMA monomer. Both of these factors appear to preclude the possibility of low SSA as demonstrated further herein.

Synthetic Wastewater Composition and Adsorption of PFAAS and Co-Occurring Organics onto Synthetic Effluent Organic Matter

A synthetic wastewater matrix was produced to evaluate the performance of selected biochar MIP composite adsorbents under conditions more representative of those expected for real treatment applications. The composition of this synthetic wastewater is detailed in TABLE 4. Synthetic effluent organic matter (sEfOM) stock solutions were prepared at 1000 mg/L and stirred at 150 rpm overnight. Total organic carbon (TOC) content was then evaluated using a Sievers 900 Portable TOC analyzer (GE Instruments, Boulder, CO). Stock solution volumes to achieve the final sample concentration listed in TABLE 4 were calculated using the results of this TOC analysis.

TABLE 4
Composition of synthetic wastewater matrix.

| compound | concentration | |
|---|---|---|
| Bovine serum albumin (protein) | 2.5 | mg C/L |
| Sodium alginate (carbohydrate) | 2.0 | mg C/L |
| Humic acid | 5.0 | mg C/L |
| Octanoic acid (fat) | 0.5 | mg C/L |
| Calcium (Ca²⁺) | 26.0 | mg/L |
| Magnesium (Mg²⁺) | 12.6 | mg/L |
| Chloride (Cl⁻) | 40 | mg/L |

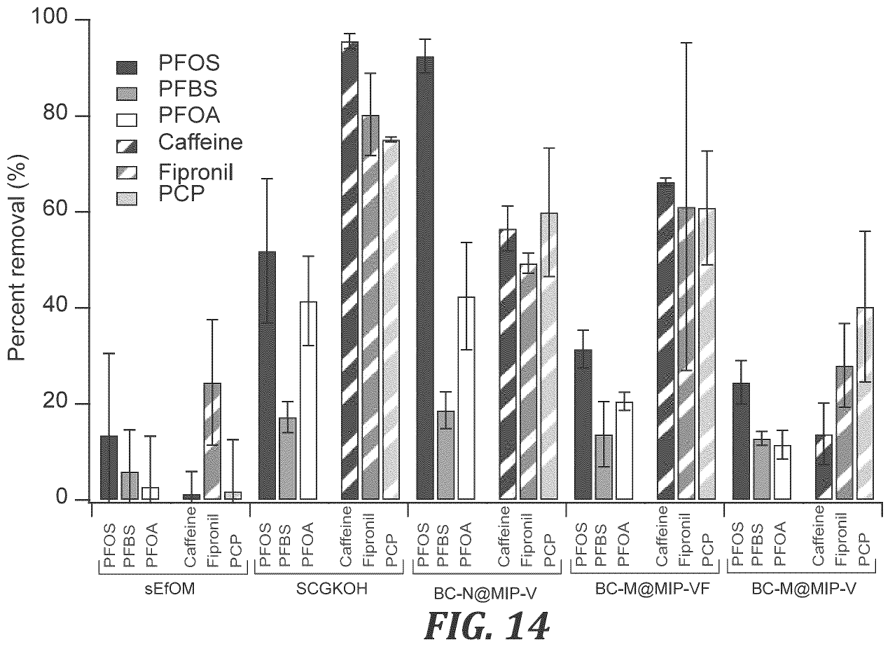

Adsorption of PFAAs and co-occurring organic compounds onto the sEfOM in particular was evaluated during the synthetic wastewater batch test described further herein with the addition of a control sample containing all components of the synthetic wastewater listed in TABLE 4 but no adsorbent. Percent removal of each adsorbate of interest onto the sEfOM as well as the four biochar and biochar MIP composite adsorbents is shown in FIG. 14. Results indicate low removal of PFAAs, caffeine, and PCP with slightly higher removal of fipronil. Percent removal of PFOS is notably higher than other PFAAs, however the high standard deviation of this data point indicates low precision of this result. Thus, adsorption to sEfOM was not expected to be a contributor to PFAA removal.

### Normalized Equilibrium Adsorption Figures and Selectivity Coefficient Calculations

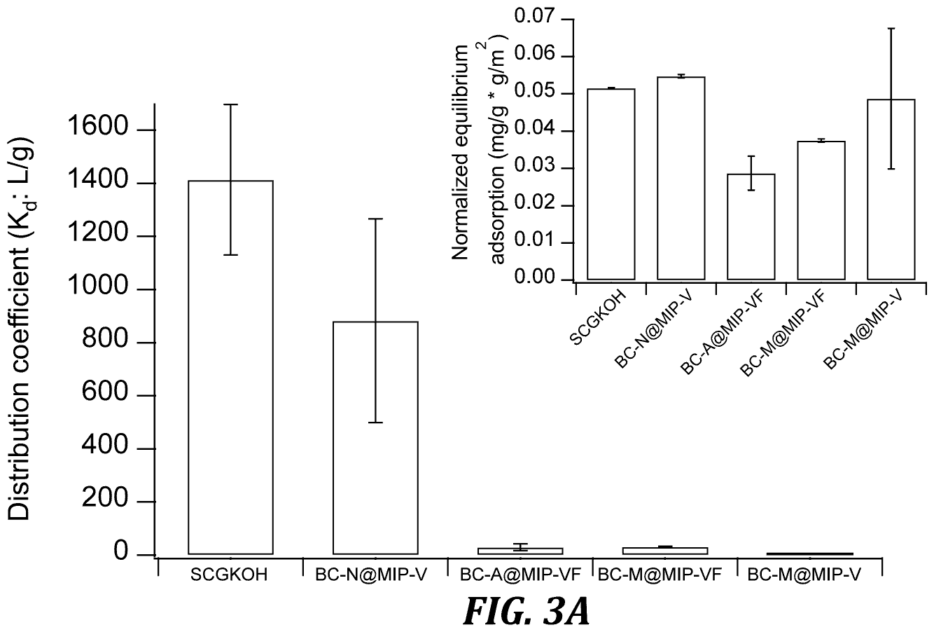

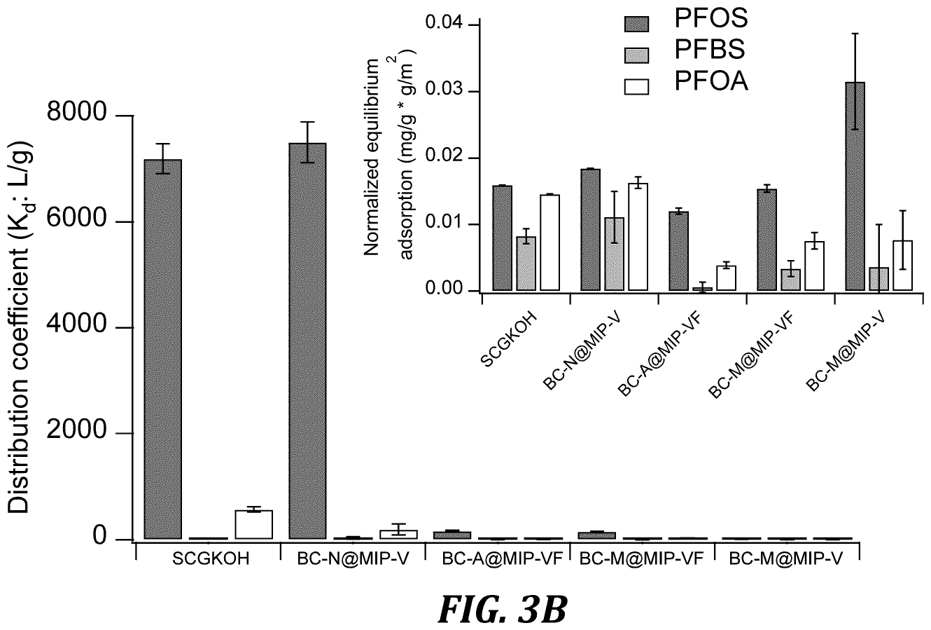

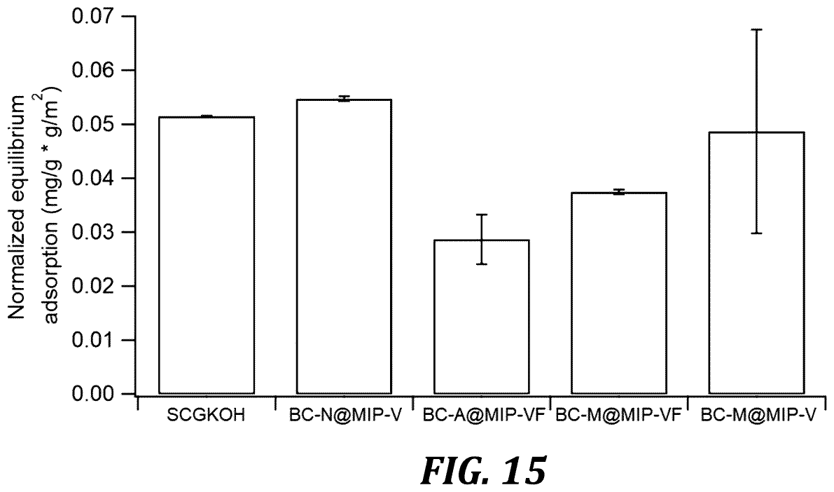

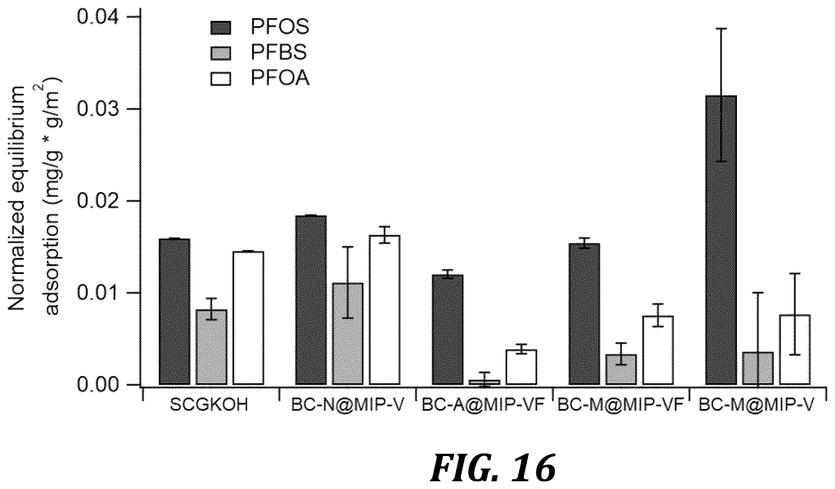

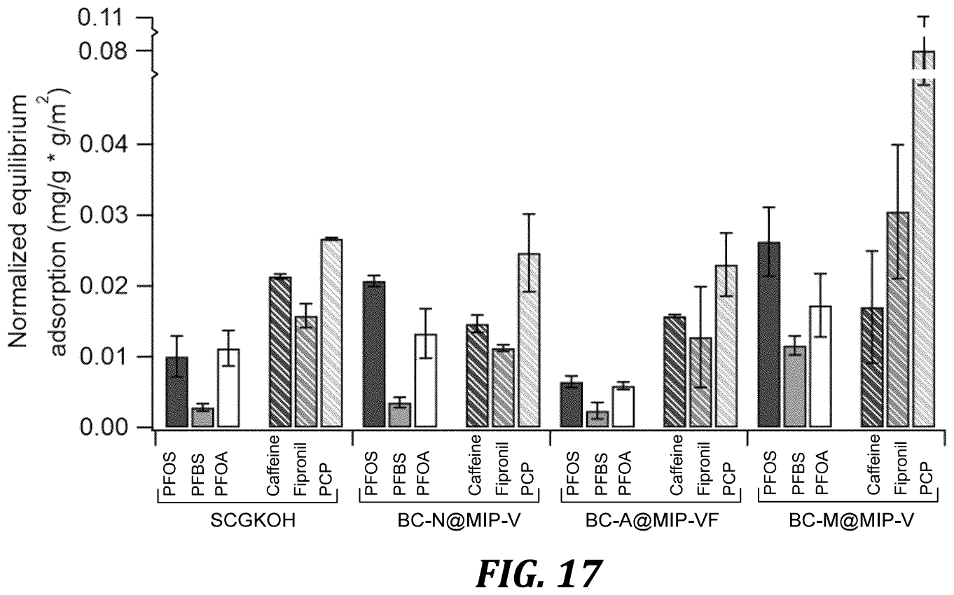

Normalized equilibrium adsorption (q_{e,SSA}) results are presented in FIGS. 15, 16, and 17, the full size counter parts to FIGS. 3A and 3B (insets) and 4B in the main text. See also FIG. 19B. Results from the selectivity coefficient (K_{selectivity}) calculations for the synthetic wastewater batch test and PFAS competition test in ultrapure water are given in TABLE 5.

TABLE 5
Selectivity coefficients comparing adsorption of PFOS template to other contaminants of interest
(COI; i.e., PFBS, PFOA, and co-occurring organics) on MIP-modified and unmodified biochar.

| | | Ultrapure water matrix | | | Synthetic wastewater matrix | | |
|---|---|---|---|---|---|---|---|
| Adsorbent | COI | K_{imprinted} | K_{comparison} | K_{selectivity} | K_{imprinted} | K_{comparison} | K_{selectivity} |
| SCGKOH | PFBS | | 1.93 | | | 3.56 | |
| BC-N@MIP-V | PFBS | 1.66 | | 0.86 | 5.86 | | 1.65 |
| BC-A@MIP-VF | PFBS | 20.90 | | 10.82 | ND | | |
| BC-M@MIP-VF | PFBS | 4.59 | | 2.37 | 2.72 | | 0.76 |
| BC-M@MIP-V | PFBS | 8.73 | | 4.52 | 2.27 | | 0.64 |
| SCGKOH | PFOA | | 1.09 | | | 0.90 | |
| BC-N@MIP-V | PFOA | 1.13 | | 1.03 | 1.56 | | 1.74 |
| BC-A@MIP-VF | PFOA | 3.10 | | 2.83 | ND | | |
| BC-M@MIP-VF | PFOA | 2.04 | | 1.87 | 1.10 | | 1.22 |
| BC-M@MIP-V | PFOA | 4.11 | | 3.76 | 1.52 | | 1.69 |
| SCGKOH | Caffeine | | | | | 0.47 | |
| BC-N@MIP-V | Caffeine | | | | 1.42 | | 3.01 |
| BC-A@MIP-VF | Caffeine | | | | ND | | |
| BC-M@MIP-VF | Caffeine | | | | 0.41 | | 0.87 |
| BC-M@MIP-V | Caffeine | | | | 1.54 | | 3.28 |
| SCGKOH | Fipronil | | | | | 0.64 | |
| BC-N@MIP-V | Fipronil | | | | 1.85 | | 2.90 |
| BC-A@MIP-VF | Fipronil | | | | ND | | |
| BC-M@MIP-VF | Fipronil | | | | 0.51 | | 0.80 |
| BC-M@MIP-V | Fipronil | | | | 0.86 | | 1.35 |
| SCGKOH | PCP | | | | | 0.38 | |
| BC-N@MIP-V | PCP | | | | 0.84 | | 2.23 |
| BC-A@MIP-VF | PCP | | | | ND | | |
| BC-M@MIP-VF | PCP | | | | 0.28 | | 0.75 |
| BC-M@MIP-V | PCP | | | | 0.33 | | 0.88 |

### LC-MS/MS Analysis of PFAAS and Co-Occurring Organic Compounds

Concentrations of all PFAAs and co-occurring organic contaminants (i.e., caffeine, fipronil, PCP) were quantified by mass spectroscopy using a Waters Corporation (Milford, MA) triple quadrupole mass spectrometer (MS/MS) preceded by liquid chromatography (LC). Prior to analysis, samples were filtered to remove biochar fines and (where applicable) organic compounds that would negatively impact instrument performance. Briefly, samples were filtered with a cellulose acetate (CA) syringe filter by first filtering 5 mL of Milli-Q water followed by filtering 20 mL of sample into waste and then collecting 1 mL of filtered sample. Cellulose acetate was chosen as a filter media for its low PFAA loss. All liquid chemicals used in LC-MS/MS analysis of PFAAs and caffeine were Optima® LCMS Grade and the Ammonium Acetate was certified ACS Grade (98.1% purity), all purchased from Fisher Chemical (Hampton, NH).

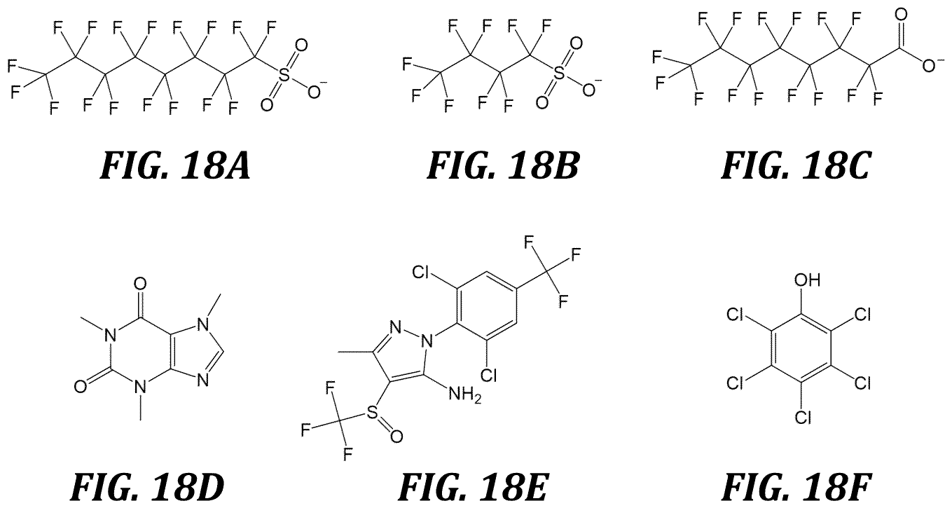

PFOS (C₈F₁₇SO₃; FIG. 18A), PFBS (C₄F₉SO₃; FIG. 18B), and PFOA (C₈HF₁₅O₂; FIG. 18C) were analyzed via LC-MS/MS using an Agilent (Santa Clara, CA) Zorbax Rapid Resolution Eclipse XBD-18C column (2.1×50 mm, 1.8 μm). An Agilent, XDB-C18 guard cartridge (80 Å, 4.6×12.5 mm, 5 μm) was placed before the LC column to pre-filter the sample. The MS/MS operation mode was set to negative electrospray ionization with multiple reaction monitoring (MRM) transitions (TABLE 6). The LC was operated with a stationary phase of HPLC grade water with 10 mM ammonium acetate (A) and a mobile phase of HPLC grade methanol with 10 mM ammonium acetate (B). Details of the gradient program are given in TABLE 7. Mass labeled PFOS (mPFOS), PFBA (mPFBA), and PFOA (mPFOA) were used as internal standards for PFOS, PFBS, and PFOA, respectively. Calibration standards were prepared with 60:40 volumetric ratio of methanol and water while samples were prepared with a 50:50 volumetric ratio of methanol and water to minimize PFOS losses to the walls of the borosilicate glass LCMS vials.

Caffeine (C₈H₁₀N₄O₂; FIG. 18D), fipronil (C₁₂H₄Cl₂F₆N₄OS; FIG. 18E), and PCP (C₆HCl₅O; FIG. 18F) were analyzed via LC-MS/MS using a Phenomenex (Torrence, CA) Gemini 3 μm NX-C18 110 A (3×50 mm) liquid chromatography column. Mass labeled diuron (diuron-d₆) and PCP (PCP-¹³C) were used as internal standards. For caffeine and diuron-d₆ quantification, the MS operation mode was set to positive electrospray ionization with MRM transitions (TABLE 6). For fipronil, PCP, and PCP-¹³C quantification, the MS operation mode was set to negative electrospray ionization with MRM transitions (TABLE 6). The LC was operated with acetonitrile and acetic acid (5% each) in water as the stationary phase (A) acetonitrile and methanol (50:50 v/v ratio) as the mobile phase (B). Details of the gradient program are given in TABLE 8. Diuron-d6 was used an internal standard.

TABLE 6
LC-MS/MS parameters used for quantification
of PFAAs and organic co-contaminants.

| | | | | | colli- | |
|---|---|---|---|---|---|---|
| | ioniza- | | produc- | cone | sion | |
| | tion | parent | tion | energy | energy | RT |
| | mode | (m/z) | (m/z) | (V) | (V) | (min) |
| PFBS | − | 299.00 | 79.40 | 14 | 35 | 7.46 |
| PFBS | − | 299.00 | 98.50 | 52 | 35 | 5.88 |
| mPFBA | − | 217.00 | 172.00 | 11 | 13 | 5.88 |
| PFOS | − | 498.95 | 79.40 | 53 | 40 | 9.81 |
| PFOS | − | 498.95 | 98.50 | 53 | 35 | 9.84 |
| mPFOS | − | 503.10 | 79.40 | 53 | 40 | 9.80 |
| PFOA | − | 413.10 | 169.00 | 18 | 19 | 9.32 |
| PFOA | − | 413.10 | 369.00 | 18 | 10 | 9.32 |
| mPFOA | − | 417.10 | 372.00 | 18 | 10 | 9.32 |
| Caffeine | + | 195.15 | 138.15 | 32 | 23 | 3.06 |
| Caffeine | + | 195.15 | 110.15 | 32 | 20 | 3.06 |
| Diuron-d6 | + | 239.15 | 52.05 | 27 | 15 | 5.06 |
| Diuron-d6 | + | 239.15 | 78.05 | 27 | 18 | 5.06 |
| Fipronil | − | 434.90 | 330.2 | 32 | 16 | 5.65 |
| Fipronil | − | 436.90 | 330.2 | 32 | 16 | 5.65 |
| Pentachloro- | − | 262.85 | 263.10 | 38 | 7 | 4.70 |
| phenol | | | | | | |
| Pentachloro- | − | 264.85 | 265.10 | 38 | 7 | 4.70 |
| phenol | | | | | | |
| Pentachloro- | − | 270.95 | 271.15 | 38 | 7 | 4.70 |
| phenol-¹³C | | | | | | |
| Pentachloro- | − | 272.95 | 273.15 | 38 | 7 | 4.70 |
| phenol-¹³C | | | | | | |

TABLE 7
LC gradient program for elution of PFAA compounds
using 10 mM ammonium acetate in water and methanol
as the stationary and mobile phases.

| time | % A (10 mM ammonium | % B (10 mM ammonium | flow rate |
|---|---|---|---|
| (min) | acetate) | acetate in methanol) | (mL/min) |
| 0.0 | 80 | 20 | 0.4 |
| 8.0 | 5 | 95 | 0.4 |
| 10.0 | 5 | 95 | 0.4 |
| 10.5 | 80 | 20 | 0.4 |
| 16.0 | 80 | 20 | 0.4 |

TABLE 8
LC gradient program for elution of organic co-contaminants
using acetonitrile and acetic acid (5% each) in
water as the stationary phase acetonitrile and methanol
(50:50 v/v ratio) as the mobile phase.

| time | % A (5% acetonitrile and 5% | % B (acetonitrile and | flow rate |
|---|---|---|---|
| (min) | acetic acid in water) | methanol 50:50 v/v) | (mL/min) |
| 0.0 | 90 | 10 | 0.2 |
| 1.5 | 45 | 55 | 0.2 |
| 3.5 | 40 | 60 | 0.2 |
| 4.0 | 1 | 99 | 0.2 |
| 6.0 | 1 | 99 | 0.2 |
| 6.5 | 90 | 90 | 0.3 |
| 9.0 | 90 | 90 | 0.2 |

### Results and Discussion

Comparable Total Nitrogen Addition Obtained from Biochar Modification

Elemental and proximate carbon analyses reveal an increase in both nitrogen and oxygen composition for the BC-N, BC-M, and BC-A that was corroborated by an increase in total surface functional group mass identified with TGA. Elemental analysis revealed a wide range of nitrogen compositions: 13.0% for BC-M, 3.0% for BC-A, and 1.8% for BC-N (TABLE 2). Some portion of the nitrogen from the melamine modified materials is expected to be unavailable for MIP polymer attachment because it is not bonded to one or more hydrogen atoms (i.e., pyrrolic-N, amine-N, or quaternary-N). Percent mass change in oxygen composition, obtained through elemental and proximate carbon analysis, was not directly correlated with percent change in nitrogen composition. BC-A had the highest oxygen content (29.4%) followed by BC-N (23.7%) while BC-M had the lowest oxygen (19.5%). Increased oxygen content is often correlated with a greater negative surface charge since many of the common oxygen-containing surface functional groups are deprotonated at environmental pH ranges. Thus, high oxygen content may be an indicator of poor PFAA removal if the negative surface charge is of sufficient magnitude to repel the negatively charged PFAAs (particularly PFBS) and interfere with other adsorption processes.

TGA, in contrast, provided information on the total mass of nitrogen- and oxygen-containing surface functional groups and the strength of their attachment (FIG. 7). TGA results revealed that the BC-N material experienced a larger increase in mass lost (23.1%) than either the BC-M (9.1%) or BC-A (3.4%) materials when compared to the unmodified BC. The mass loss during TGA can represent the mass of surface functional groups present on a substrate surface. The larger mass loss from the BC-N compared to BC-M is somewhat contradictory since the melamine modified biochar exhibited the greatest increase in nitrogen composition and indicate a higher temperature is beneficial for complete volatilization of functional groups required for effective analysis of these materials using the TGA method. Even so, both elemental analysis and TGA results suggest the BC-M material will have the greatest success for MIP attachment. Melamine addition appeared to present the most stable reaction of a nitrogen source with the bulk biochar substrate, which likely accounts for the high nitrogen yield from this method. Nitrogen addition with ammonium chloride (i.e., BC-A) instead of melamine as the nitrogen source was likely less successful because a large percentage of the ammonium chloride volatilized before reacting with the biochar (as evidenced by the formation of ammonium chloride crystals in the interior of the muffle furnace following production). Similarly, nitrogen addition via nitration with concentrated acids (i.e., BC-N approach) may have been ineffective because exposure to the acids may have eroded aromatic moieties from the biochar surface to form nitroaromatic compounds (observed as a yellow color in the diluted final reaction solution).

XPS results confirmed the BC-M material was likely to undergo the most successful MIP functionalization owing to the high density of —NH moieties on the surface. Interestingly, the number of —NH moieties were noticeably higher for the BC-M substrate than for either the BC-A or BC-N substrates despite the large percentage of nitrogen on the BC-M only bonded to carbon or oxygen. Four main types of nitrogen containing surface functional groups were identified via XPS (FIGS. 1A-1D): pyridinic-N (398.9±0.1 eV), pyrrolic-N (400.4±0.2 eV), quaternary-N (401.5±0.3 eV), and pyridinic-N⁺ oxides (403.4±0.8 eV). Interestingly, amine-N (near 399.5 eV) was not identified on any of the materials. Both the total nitrogen and density of —NHₓ groups hypothesized to be available for MIP attachment followed the trend BC-M>BC-A>BC-N>unmodified BC, as detailed in the FIG. 1E. DRIFTS spectra (FIG. 8) of the BC-N, BC-M, and BC-A substrates agreed with results from XPS analysis, demonstrating a lower nitrogen density on the BC-N in particular. Therefore, the complementary surface characterization results for the BC-M indicate this substrate may exhibit a faster and more uniform MIP attachment, while the BC-N and BC-A are expected to experience similar and poorer MIP attachment.

### Thicker MIP Layer Decreases Composite Specific Surface Area

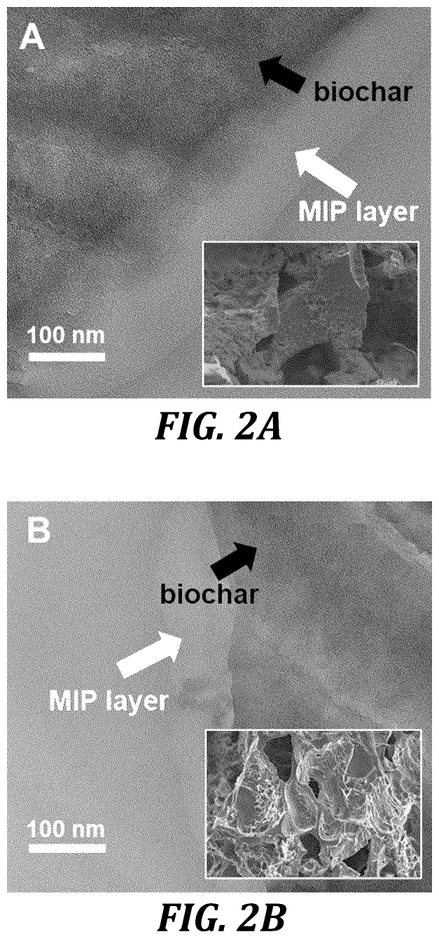

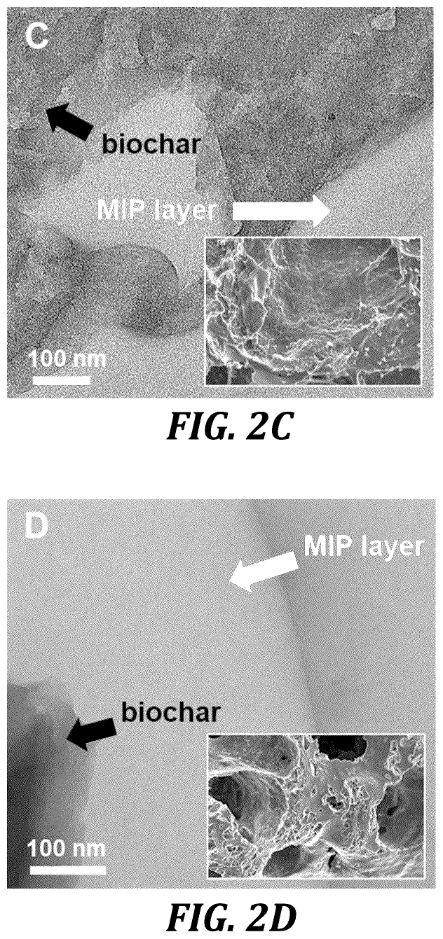

Successful and relatively uniform MIP functionalization on the biochar substrates was verified with TEM (FIGS. 2A-2D). Imaging revealed MIP layer thickness ranging from 10s to 100s of nm across much of the surface for all four materials of interest. Notably, the MIP layer on the BC-M@MIP-V material was thicker, with a thickness of approximately 200 nm observed across much of the material surface. MIP modified and unmodified biochar were also imaged via SEM to further characterize the MIP layer (FIGS. 2A-2D insets); however, the MIP was indistinguishable from the biochar surface, which is likely a result of the thin MIP layer, highly irregular biochar surface, and SEM contrasting.

The MIP functionalization generally reduced the SSA of the biochar composites, with variability in the final SSA observed based on the nitrogen modification method and functional monomer selection. The SSA of BC-N@MIP-V and BC-M@MIP-VF decreased only slightly from the unmodified BC (858 m²/g) to 741 m²/g and 806 m²/g (TABLE 1). By contrast, the BC-M@MIP-V material synthesis resulted in a decrease in the inherent SSA to 155 m²/g, which was accompanied by a corresponding increase in average pore size from 1.42 nm for BC to 8.88 nm, indicating the MIP layer has covered some or all of the smallest micropores in the biochar substrate. Interestingly, the BC-A@MIP-VF SSA increased to 1035 m²/g, which is possibly due to an increase in ammonium chloride modified biochar SSA. BET analysis of the BC-A was not performed to confirm this finding due to the relatively lower PFAA removal observed for BC-A@MIP-VF (discussed in the following). The SSA data also suggests that more attachment points (i.e., greater percentage of —NH moieties) for MIP functionalization may not be beneficial unless other factors like polymerization time or monomer concentration are adjusted. Interestingly, the thicker polymer layer and corresponding reduction in composite BET SSA was not observed when the TFMA monomer was included during MIP synthesis. Further work could help better understand this relationship.

### PFAA Batch Adsorption Tests

### Functional Monomer Choice Directs PFOS Adsorption

BET SSA had an impact on the PFOS adsorption capabilities of each material as evidenced by a comparison of their distribution coefficients (K_{d}, FIG. 3A). The BC and BC-N@MIP-V exhibited high K_{d} values (1410 and 882 L/g), corresponding to their high BET SSA (858 and 741 m²/g). BC and BC-N@MIP-V also had low equilibrium PFOS concentrations, which suggests that PFOS adsorption was the highest compared to the other adsorbents. Similarly, the BC-M@MIP-V possessed the lowest SSA at 155 m²/g and a low K_{d} (1.89 L/g) and a large equilibrium aqueous PFOS concentration. The poor PFOS removal by the BC-M@MIP-V adsorbent was expected. Interestingly, the BC-A@MIP-VF and BC-M@MIP-VF materials also exhibited low K_{d} values despite their high SSA. The presence of the TFMA monomer in these materials is hypothesized to be responsible for the decreased adsorption, as discussed in further detail below. In order to better evaluate the effects of functional monomer selection and nitrogen modification method on BC@MIP capabilities, further comparison of adsorbent performance was evaluated using normalized equilibrium adsorption (q_{e,SSA}; FIG. 3A inset).

Normalized equilibrium adsorption results indicate the VBTAC monomer alone produced a BC@MIP material with high PFOS adsorption capabilities regardless of nitrogen modification approach while inclusion of the TFMA monomer reduced PFOS adsorption capabilities. The BC-M@MIP-V and BC-N@MIP-V demonstrated PFOS removal capabilities comparable or greater than the unmodified BC, with normalized equilibrium PFOS adsorption of 0.055, 0.049, and 0.052 mg/g*g/m², respectively. The addition of the fluorinated TFMA functional monomer in the BC-M@MIP-VF reduced PFOS equilibrium adsorption to 0.037 mg/g*g/m². Similarly, the BC-A@MIP-VF material exhibited PFOS equilibrium adsorption of only 0.029 mg/g*g/m². The low PFOS adsorption by BC-A@MIP-VF is particularly interesting given the high SSA of the material (1035 m²/g). This may be due in part to the density and speciation of oxygen and nitrogen containing surface functional groups (see FIG. 1D and FIG. 9D) resulting from the ammonium chloride modification method used for the BC-A substrate. Specifically: (1) if portions of the biochar surface do not have MIP attached, the high oxygen content of the exposed BC-A (28.9% oxygen) will be negatively charged at the solution pH and repel negatively charged PFAAs like PFOS; and (2) the nitrogen functional group speciation (i.e., high pyridinic-N and low pyrrolic-N and quaternary-N) may have affected the morphology and function of the MIP layer. Thus, it appears functional monomer selection had an impact on PFOS adsorption while the nitrogen modification method had a lower impact.

### Preferential Adsorption of Longer-Chain PFAAS Over Short-Chain PFAAS

Competition studies revealed high selectivity for the template by the PFOS-imprinted MIP composites and preferential adsorption of long-chain PFAAs. The preferential adsorption of PFOS is not surprising as high selectivity for the template compound is characteristic for MIP materials; however, the adsorption of PFOA and PFBS was also observed. The normalized equilibrium adsorption of PFOS was only slightly greater than PFOA for the BC and BC-N@MIP-V materials with equilibrium adsorption of 0.016 mg PFOS/m² and 0.015 mg PFOA/m², and 0.018 mg PFOS/m² and 0.016 mg PFOA/m², respectively (FIG. 3B inset). Selectivity coefficient (K_{selectivity}) calculations (TABLE 5) similarly indicated only a minor improvement in PFOS selectivity for the BC-N@MIP-V compared to the unmodified BC while the other three adsorbents showed much greater increases in PFOS selectivity. For the other three BC@MIPs, however, higher PFOS selectivity was observed. For example, the PFOA adsorption was approximately half that for PFOS for the BC-M@MIP-VF, and even lower for the BC-A@MIP-VF and BC-M@MIP-V. The BC-M@MIP-V in particular exhibited much higher PFOS selectivity, which is possibly due to the thick MIP layer and the corresponding decrease in non-specific adsorption from exposed biochar surfaces. By contrast, PFBS adsorption was lower than that of PFOS and PFOA for all three BC@MIP composites. The lower PFBS affinity may indicate greater template imprinting success on the BC-A@MIP-VF, BC-M@MIP-VF, and BC-M@MIP-V materials and higher rates of non-specific binding on the BC-N@MIP-V. We hypothesize that orientation of the functional monomer with the quaternary nitrogen located farther into the binding site may also be negatively impacting adsorption of short-chain PFAAs (i.e., PFBS) that rely more strongly on electrostatic attraction rather than hydrophobic interactions. Thus, the shorter-chain PFBS that primarily rely on electrostatic attraction for adsorption are poorly removed while the longer-chain PFOS and PFOA that rely primarily on hydrophobic attraction are removed well. Our observations from the PFAA competition studies confirm the hypothesis that the PFOS template would create a binding site capable of removing other perfluoroalkyl sulfonic acids (PFSAs) and perfluoroalkyl carboxylic acids (PFCAs) in addition to the PFOS template.

Generally, the total mass of PFAAs adsorbed decreased for all MIP composite materials in the presence of competing PFAAs. For example, the BC-N@MIP-V composite had a normalized PFAA equilibrium adsorption of 0.055 mg PFOS/m² that decreased to 0.046 mg PFAA/m² for the PFAA competition test. The BC-A@MIP-VF composite in particular experienced a decrease in normalized equilibrium adsorption (from 0.029 mg PFOS/m² to 0.016 mg PFAA/m²). Therefore, no additional tests were performed using this particular MIP composite material. The diminished PFAA adsorption performance by all composites compared to PFOS-only reaction systems is likely due to adsorption competition, and the lower initial concentration of each individual PFAA (1476±207 μg/L PFOS, 1166±153 μg/L PFBS, and 1453±582 μg/L PFOA) compared to the PFOS only test (4275±342 μg/L PFOS). It should be noted, however, that total PFAA load was similar between tests (4637 μg/L PFOS compared to 4314 μg/L PFAAs). The exception to this general observation was the BC-M@MIP-V composite which demonstrated comparable PFAA adsorption between the single and multi-PFAA tests (0.049 mg PFOS/m² and 0.043 mg PFAA/m²). The contrasting results of reduced PFAA adsorption by BC-N@MIP-V and sustained PFAA adsorption by BC-M@MIP-V composites prepared using the VBTAC functional monomer imply that the biochar substrate can impact PFAA selectivity directly via non-specific binding to exposed biochar or indirectly via the corresponding MIP layer morphology. For example, low imprinting success on the BC-N@MIP-V may have led to lower adsorption in the presence of competing PFAAs. This conclusion is supported by the high K_{selectivity} values calculated for the BC-M@MIP-V (4.52 and 3.76 for PFBS and PFOA; TABLE 5) compared to BC-N@MIP-V (0.86 and 1.03 for PFBS and PFOA) revealing a higher selectivity for the template compound by the BC-M@MIP-V.

Interestingly, the fluorinated TFMA monomer did not appear to improve PFAA adsorption in the present disclosure, which is contrary to findings from other PFAA-MIP studies. For example, the BC-M@MIP-VF material exhibited significantly lower total PFAA adsorption (0.026 mg/g*g/m²) compared to the BC-M@MIP-V material (0.043 mg/g*g/m²) despite having a SSA nearly five times greater (806 m²/g compared to 155 m²/g). This observation was particularly surprising for the more hydrophobic PFAAs (i.e., PFOA and PFOS) which possess a strong affinity for fluorocarbon-containing structures. The observed reduced PFAA adsorption may be a result of the highly acidic, anionic nature of the TFMA monomer at near-neutral pH ranges that would repel the negatively charged PFAAs.

### Increased Complexity in Reaction Matrix Increased PFAA Adsorption by BC-M@MIP-V

Interestingly, the BC-M@MIP-V material displayed an increase in total PFAA adsorbed in the synthetic wastewater (0.055 mg PFAAs/m²) compared to the ultrapure water matrix (0.043 mg PFAAs/m² or 0.049 mg PFOS/m²). We hypothesize that the elevated ionic strength from the synthetic wastewater decreased swelling of the MIP layer and exposed more of the binding sites within the inner pores. The effect was likely expressed to a greater extent in the BC-M@MIP-V material compared to the other adsorbents because of the greater thickness of the MIP layer.

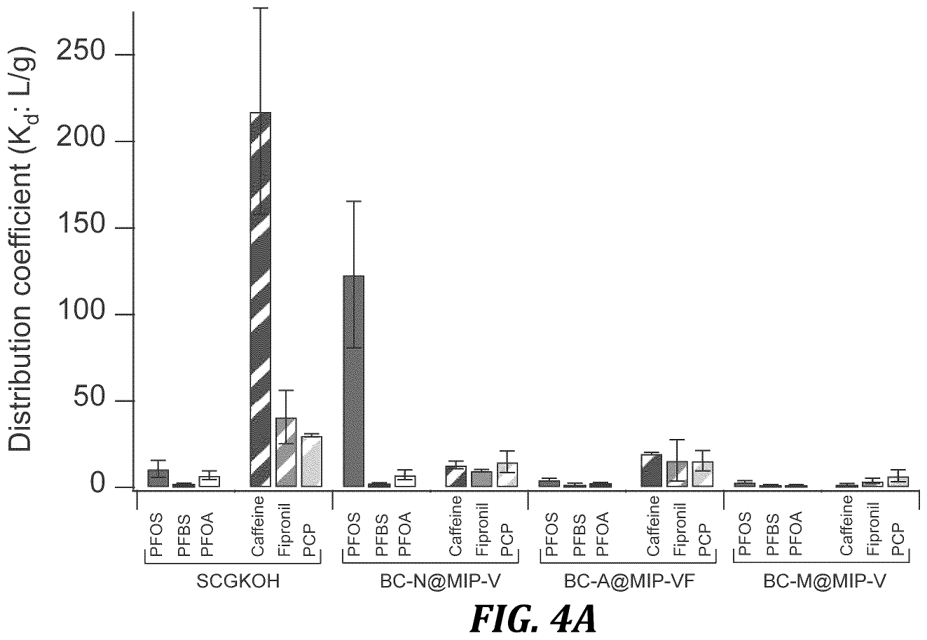

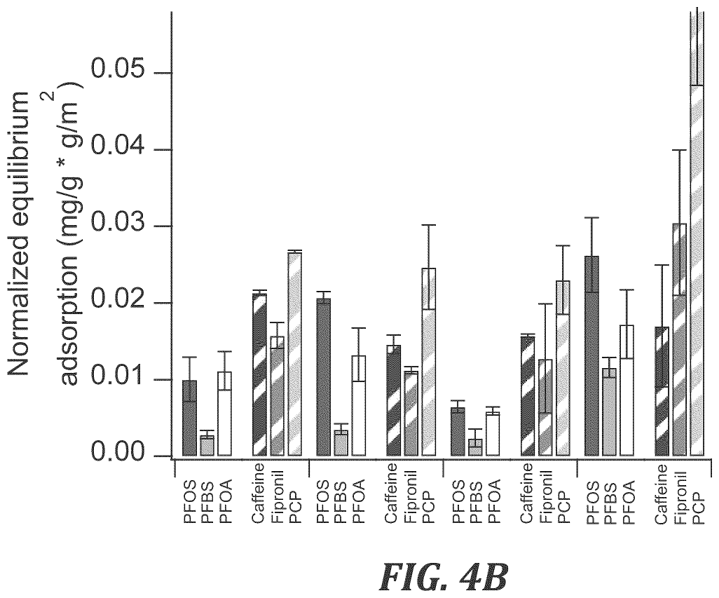

PFOS selectivity in the synthetic wastewater remained high for all of the BC@MIP composites, particularly when compared with adsorption of other PFAAs, caffeine, and fipronil. The BC-N@MIP-V and BC-M@MIP-V composites demonstrated much higher affinity for all PFAAs than the unmodified BC substrate, while the BC-M@MIP-VF composite demonstrated lower adsorption of all three PFAAs. However, the hierarchy of PFAA adsorption remained the same (FIGS. 4A and 4B). The lower PFAA adsorption by the BC-M@MIP-VF material compared to the other composites follows the trend observed further herein. PFOS removal remained higher than that of other PFAAs with equilibrium adsorption of 0.010 mg/g*g/m², 0.021 mg/g*g/m², 0.006 mg/g*g/m², and 0.026 mg/g*g/m² for the BC, BC-N@MIP-V, BC-M@MIP-VF, and BC-M@MIP-V, respectively. PFOA adsorption was generally more comparable to PFOS adsorption in the synthetic wastewater matrix test (equilibrium PFOA adsorption of 0.013 mg/g*g/m², 0.006 mg/g*g/m², 0.017 mg/g*g/m² for the BC-N@MIP-V, BC-M@MIP-VF, and BC-M@MIP-V, respectively) than it was in the PFAA competition test in the ultrapure water matrix. Therefore, the presence of salts and sEfOM reduced selectivity for the template compound due to competition at binding sites and potential fouling of the composite surface. PFBS removal was lower than the other PFAAs with adsorbed quantities of 0.003 mg/g*g/m², 0.004 mg/g*g/m², 0.002 mg/g*g/m², and 0.012 mg/g*g/m² for the BC, BC-N@MIP-V, BC-M@MIP-VF, and BC-M@MIP-V materials, respectively. Notably, the mass of PFBS adsorbed on the BC-M@MIP-V material is more than three times the PFBS mass adsorbed on any other composite, which is potentially a result of the reduced MIP swelling and greater availability of binding sites on the thick MIP layer. Poor PFBS removal compared to other PFAAs may be partially due to interference of Cl⁻ 40 mg/L) at the quaternary nitrogen binding site which may interrupt electrostatic attraction and adsorption of short-chain PFAAs. Additionally, complexation of PFAAs with divalent Ca²⁺ and Mg²⁺ may be hindering electrostatic attraction to the BC@MIP composite surface, a phenomenon which likely impacts PFBS adsorption to a greater degree due to its reliance on electrostatic attraction.

The BC adsorbed the lowest amount of PFAAs in the synthetic wastewater mixture compared to the more selective BC-N@MIP-V and BC-M@MIP-V composites. The BC and BC-M@MIP-V demonstrated higher K_{d} values and higher normalized equilibrium adsorption for all three competing organics than for any of the PFAAs. For example, K_{d} values for caffeine ranged from 217 L/g for BC to 1.59 L/g for BC-M@MIP-V. Normalized equilibrium adsorption of competing organics ranged from 0.016 to 0.027 mg/g*g/m² for BC and 0.008 to 0.022 mg/g*g/m² for BC-M@MIP-VF. For the BC-N@MIP-V and BC-M@MIP-V composites, normalized equilibrium adsorption of co-occurring organics (i.e., caffeine, fipronil, and pentachlorophenol) was generally comparable to that of PFAAs. The normalized equilibrium adsorption of PFAAs ranged from 0.003 to 0.011 mg/g*g/m² for BC and from 0.003 to 0.007 mg/g*g/m² for BC-M@MIP-VF. For the BC-N@MIP-V and BC-M@MIP-V composites, the caffeine and fipronil removal were lower than or comparable to removal of PFOS and PFOA, but higher than the PFBS removal. Normalized equilibrium adsorption for caffeine and fipronil were 0.015 and 0.011 mg/g*g/m² for BC-N@MIP-V and 0.016 and 0.025 mg/g*g/m² for BC-M@MIP-V. Equilibrium adsorption results appear to indicate removal of PCP was greater than for any other contaminant for all adsorbents; however, PCP quantification via LC-MS/MS was compromised due to issues with carry-over of PCP during analysis, potentially resulting in higher calculated equilibrium adsorption values than are representative of what occurred. Comparison of the distribution coefficients (K_{d}) reveals PCP removal on the same order of magnitude as the other co-occurring contaminants, which is assumed to be a more accurate interpretation of what occurred in this system. Very little adsorption of PFAAs onto sEfOM was observed in control samples (FIG. 13), confirming removal of PFAAs was primarily facilitated by the adsorbents. Therefore, the data suggest that while selective removal of PFAAs on the composites was high, some non-selective adsorption of competing organic compounds still occurred, likely due to binding to non-imprinted VBTAC and TFMA or adsorption onto exposed biochar substrate. The BC-M@MIP-V material in particular showed high removal of all PFAAs in the synthetic wastewater matrix, making this material a promising option for use in water treatment systems and may improve PFAS adsorption capabilities-especially where salts and co-contaminants are likely to be present.

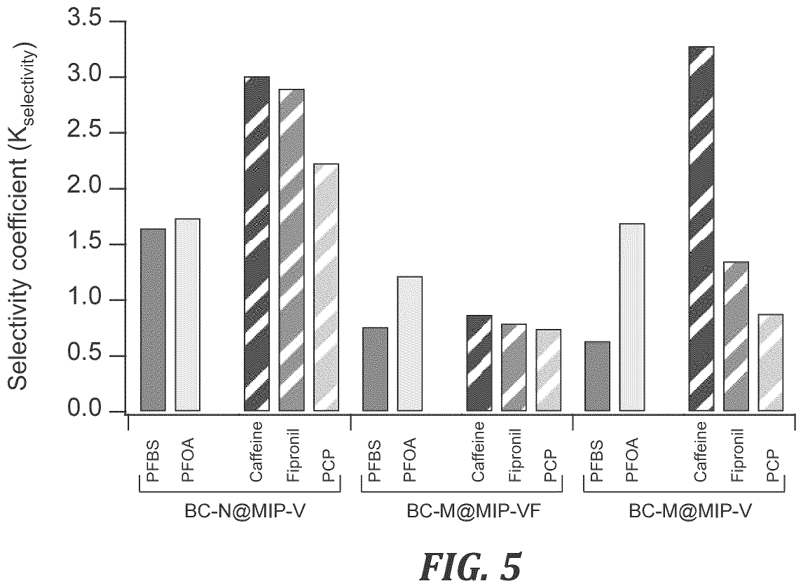

Overall, imprinting success and selectivity for the PFOS template appears higher for the BC@MIP materials containing only the VBTAC functional monomer as evidenced by comparison of the calculated selectivity coefficient (K_{selectivity}) values (FIG. 5 and TABLE 5). A K_{selectivity} of greater than one indicates the BC@MIP material has a greater selectivity for the PFOS template over another adsorbate compared to the unmodified BC. The BC-N@MIP-V and BC-M@MIP-V materials had particularly high K_{selectivity} values for the co-occurring organics reflecting a decrease in adsorption of these compounds where only the VBTAC functional monomer was used. By contrast, K_{selectivity} values for the BC-M@MIP-VF were less than one for all adsorbates except PFOA (for which K_{selectivity} was 1.22), indicating poor imprinting success and low selectivity for the template. These results corroborate observations (FIGS. 3A, 3B, 4A, and 4B) indicating the VBTAC monomer alone produces a more selective BC@MIP adsorbent material capable of effective PFAA removal in a complex synthetic wastewater matrix.

### Regeneration of Spent Composites Indicates High Potential for Material Reuse

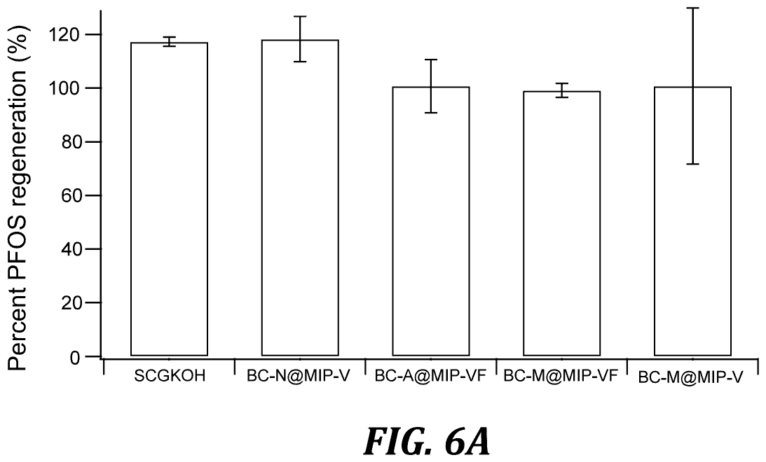

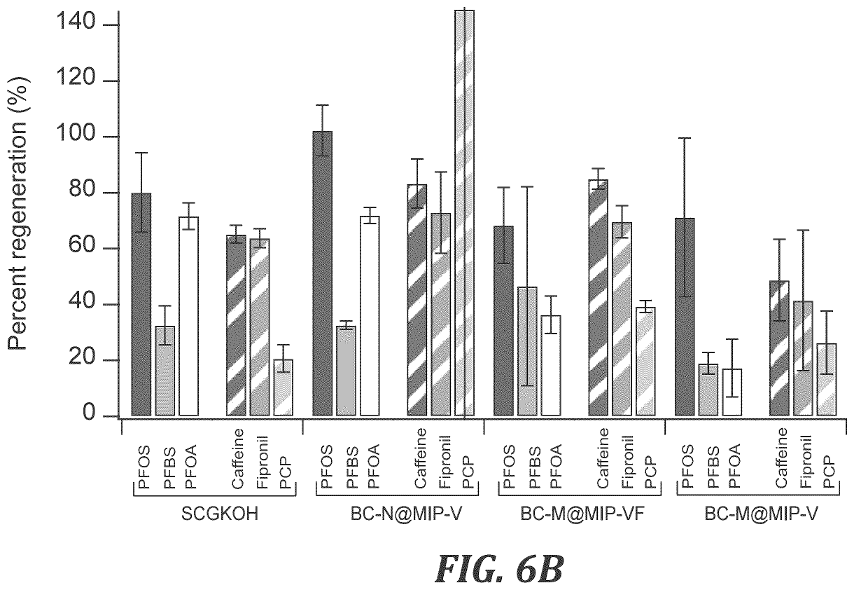

Results from a single use regeneration of spent adsorbents signify high potential for successful material reuse which would increase the functional lifetime of the adsorbent and reduce capital costs for water treatment. Following PFOS adsorption in the ultrapure water system, nearly complete regeneration of spent adsorbent was observed for both MIP functionalized and unmodified BC materials with percent regeneration ranging from 99% for BC-M@MIP-V to 118% for BC-N@MIP-V (FIG. 6A). Adsorbent regeneration following PFAA adsorption in the synthetic wastewater was more varied with recovery of PFOS >PFOA ≥PFBS (FIG. 6B). PFOS recovery generally decreased compared to that observed in the ultrapure water matrix. The exception to this observation was the BC-N@MIP-V material for which PFOS recovery remained high at 102%. PFOA recovery ranged between 72% from BC-N@MIP-V to 31% from BC-M@MIP-V, and PFBS recovery ranged between 31% from BC-M@MIP-VF to 10% from BC-M@MIP-V. The low recovery of PFOA and PFBS from BC-M@MIP-V composites is likely a result of the thicker MIP layer (˜200 nm) and additional time required to desorb PFAAs from interior portions of that MIP layer when compared to the thinner MIP layers (˜100 nm) on the other composite materials. A comparable material with a thinner MIP layer (e.g., produced using a shorter polymerization time) is expected to experience improved regeneration capabilities more similar to that seen for the BC-N@MIP-V. Recovery of caffeine and fipronil was comparable to that of PFOS and PFOA on both the modified and unmodified biochar materials. Percent recovery of caffeine ranged between 46% from BC-M@MIP-V to 85% from BC-M@MIP-VF while percent recovery of fipronil ranged between 29% from BC-M@MIP-V to 66% from BC-M@MIP-VF (FIG. 6B). Adsorption and regeneration over multiple cycles is beneficial to obtain a better understanding of the full material lifetime capabilities; however, these preliminary results indicate promising reuse potential in water treatment applications.

### CONCLUSIONS

Nitrogen modification and MIP functionalization of a spent coffee grounds biochar was successfully performed resulting in an adsorbent material with high potential for selective PFAA removal from water. Of three biochar nitrogen modification methods explored, the melamine modification resulted in the highest fixation of nitrogen containing surface functional groups. The higher density of nitrogen containing surface functional groups (i.e., on the BC-M substrate) resulted in a thicker MIP layer but decreased the composite specific surface area and increased average pore size. Functional monomer selection had a large impact on the BC@MIP composite performance. In particular, the fluorocarbon containing TFMA monomer appeared to decrease PFAA adsorption capabilities, potentially due to electrostatic repulsion. This finding is contrary to findings from previous studies reporting enhanced affinity for PFAAs using a fluorinated functional monomer. A hierarchy of PFAA removal capabilities was observed for all modified and unmodified biochar materials with mass adsorbed of PFOS >PFOA >PFBS. A similar trend was observed during regeneration with mass desorbed of PFOS >PFOA >PFBS. Although total PFAA adsorption capability had little increase as a result of the MIP modification, the modified material exhibited an increase in selectivity for PFAAs when compared to the unmodified spent coffee grounds biochar in a synthetic wastewater matrix. In fact, total mass of PFAAs adsorbed increased for the BC-M@MIP-V material in the synthetic wastewater compared to the ultrapure water matrix. The higher salt concentration in the synthetic wastewater test is expected to reduce swelling of the thicker MIP layer for the BC-M@MIP-V composite, thereby increasing the specific surface area and subsequently the PFAA removal capabilities. Selective PFAA adsorbent materials are beneficial to fill a technology gap for treatment of PFAAs in more complex waters containing a range of PFAAs, co-occurring organic contaminants, and dissolved organic matter for which more traditional adsorbents like activated carbon and ion exchange resins. The data presented herein indicates these biochar-MIP adsorbents are capable of selective PFAA adsorption the presence of competing organics, although additional work is required to refine the synthesis process and fully evaluate the removal capabilities of these materials. The nitrogen modification and MIP functionalization method detailed here is expected to be easily adaptable for any amorphous carbon substrate (e.g., carbon nanotubes, other activated carbons, or carbon membranes) to produce a highly selective PFAA adsorbates with a range of functionalities depending on the physical characteristics of the substrate.

Further embodiments of the present disclosure can include a shorter polymerization time and use of the unmodified biochar as a substrate for immobilization of the VBTAC MIP will be explored in an effort to consistently obtain a composite adsorbent with a thin MIP layer, and to reduce time and cost associated with the synthesis process. This modified synthesis process increases the specific surface area without sacrificing the superior PFAA adsorption performance of the VBTAC MIP coating. Further investigation of the impacts of the TFMA monomer on MIP structure and performance elucidates the impacts of the fluorocarbon moiety on PFAA adsorption. Additionally, a multi-template MIP using short- and long-chain PFAAs during polymerization improves adsorption of shorter-chain PFAAs by reducing competition between short- and long-chain PFAAs. Finally, evaluation of adsorption performance over multiple adsorption and regeneration cycles with PFAA concentrations more representative of those commonly found in WWTP effluent and environmental systems provides a better understanding of the effectiveness of these adsorbents for water treatment applications.

### Example 2: Immobilization of a Multi-Template Imprinted Polymer on Biochar for Improved Adsorption of Short- and Long-Chain Per- and Polyfluoroalkyl Substances

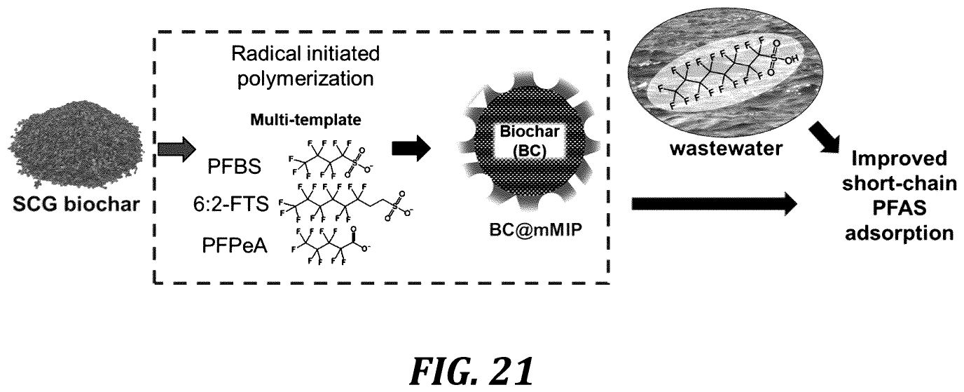

The present Example describes immobilization of a multi-template imprinted polymer on biochar for improved adsorption of short- and long-chain per- and polyfluoroalkyl substances, as schematically illustrated in FIG. 21.

Increased detection frequency of short-chain PFAAs in wastewater and environmental samples has revealed a need for adsorbents capable of selective removal of short- and long-chain PFAAs simultaneously from complex matrices. Example 1 suggests that imprinted polymers prepared using a single PFOS template can result in preferential adsorption of PFOS over short-chain PFAS. To address this need, a multi-PFAS imprinted polymer composite (mMIP) was synthesized. A synergistic effect was observed when using multiple PFAS templates that resulted in an increased imprinting factor compared to the single-template MIPs. The BC@mMIP composite was capable of treating approximately 100 ng/L each of PFOA, PFBS, and PFHxS to below their proposed US EPA MCL in ultrapure water containing a mix of nine PFAS at (waste)water-relevant concentrations. Column testing in real wastewater effluent revealed competition between TDS species and PFAS for adsorption sites on BC@mMIP, non-imprinted BC@NP, and a commercial activated carbon (F400). This mMIP composite material is recommended for use in water treatment with low TDS or used in series with a pre-treatment like ion exchange for optimal performance.

PFAS are a widespread contaminant of concern which have been identified globally in both human, animal, and environmental reservoirs including drinking and wastewater, rain, human and animal blood serum, and freshwater fish. Recent regulatory action limiting the use of such long-chain PFAS as perfluorooctanesulfonate (PFOS) and perfluorooctanoate (PFOA) and their presence in drinking water and environmental waters has caused them to be phased out of production in the US and European Union. With this shift, researchers have noted a corresponding increase in the prevalence and concentrations of short-chain PFAS in the environment and (waste)water treatment. Adsorption with activated carbon (AC) or ion exchange resins has long been the standard for PFAS separation in water; however, removal efficiency by these materials has been shown to be poor for short-chain and perfluorocarboxylic acids. The presence of organics and counterions in some matrices (e.g., wastewater) have also been demonstrated to reduce the efficacy of these adsorbents for PFAS removal. These limitations are of particular concern when considering technology needs to meet the recently proposed US Environmental Protection Agency (EPA) maximum contaminant level (MCL) for PFAS in drinking water. This rule proposes limits of 4 ng/L for PFOS and PFOA separately, and a combined hazard index for perfluorononanoate (PFNA), perfluorohexanesulfonate (PFHxS), perfluorobutanesulfonate (PFBS), and hexafluoropropylene dimer acid (HFPO-DA) which references their respective health based reference concentrations of 10 ng/L PFNA, 9 ng/L PFHxS, 2000 ng/L PFBS, and 10 ng/L HFPO-DA. Thus, there is a need for a more selective PFAS treatment method with greater affinity for short-chain PFAS to overcome existing limitations with conventional PFAS separation media.

Molecularly imprinted polymers (MIPs) are a class of customizable adsorbents with high specificity for one or more target compounds which are used in synthesis as a template. Functional monomer(s) (the building blocks of the MIP) are chosen to have specific affinity for the template (e.g., charged moieties that electrostatically attract or aromatic groups that hydrophobically attract). The functional monomer and template are mixed prior to synthesis to allow time for self-assembly in solution. This step promotes the formation of binding sites on the MIP product with size, shape, and affinity specifically tailored to the template. Another important component of the MIP is the crosslinker which connects functional monomers and holds the MIP together. The crosslinker typically comprises a large fraction of the MIP mass, making crosslinker selection an important aspect of final MIP morphology and physicochemical characteristics. Crosslinkers are often chosen to interact favorably with the synthesis solvent (e.g., N,N′-methylene bisacrylamide is often chosen for synthesis in water).

MIPs have been investigated as PFAS adsorbents because of their high selectivity. These studies have often immobilized the MIP onto a substrate such as biochar, carbon microspheres, or titanium dioxide nanotubes to overcome challenges associated with MIP morphology and size which make them difficult to implement in water treatment without additional modification. Biochar in particular is an advantageous substrate for MIP functionalization due to its high surface area and the abundance of easily modifiable surface functional groups present on most biochar. Example 1 showed single template imprinting with longer chain, anionic PFAS compounds. The MIP products have high imprinting factors (a measure of templating success) due to the high affinity of long chain PFAS for a variety of hydrophobic and cationic functional monomers; however, adsorption of short-chain PFAS remains lower. For example, competitive sorption of three PFAS was evaluated with our previously synthesized PFOS-imprinted polymer-biochar (BC@MIP) in ultrapure water with initial concentrations of 1476±207 μg/L PFOS, 1166±153 μg/L PFBS, and 1453±582 μg/L PFOA and an adsorbent dose of 100 mg/L. Preferential PFOS adsorption was observed with 10 times higher loading of PFOS than the short-chain analogue (PFBS). Thus, additional strategies are needed to improve short chain PFAS removal by MIP adsorbents.

Multi-template MIP is described further herein in which a number of compounds in the same class or otherwise having similar structure are shown effective at removing a broad scope of PFAS compounds. This approach is advantageous because compounds within a class often co-occur and have similar toxicological endpoints. For example, over 240 individual PFAS analytes comprising 57 sub-classes have been identified in aqueous film forming foam (AFFF) or in groundwater from impacted sites, including precursors and polyfluorinated compounds which will transform in the environment. When choosing templates for a multi-template MIP synthesis, it is important to select templates with similar affinity for the functional monomer to achieve similar imprinting factors [equation (4.7)] in the final material. The present Example also explores the use of a molecular crowding agent to improve the imprinting factor. In this approach, large, inert macromolecules (e.g., polystyrene) are included in the pre-polymerization mixing step to increase interactions between the functional monomer and template; however, this technique is more common in syntheses that utilize organic solvents since most of the viable macromolecules are hydrophobic and have little to no solubility in water. This multi-template MIP approach has not, to our knowledge, been previously explored for PFAS removal in water treatment. Therefore, the objectives of the present Example include: First, to synthesize a multi-template MIP-biochar composite using three PFAS templates of varying head group [PFBS, perfluoropentanoate (PFPeA)], and extent of fluorination [6:2-fluorotelomer sulfonate (6:2-FTS)]. The 6:2-FTS template was chosen both because of its similarity to the previously used PFOS template and because it is one of the more common aerobic biotransformation products from fluorotelomer thioether amido sulfonate, one of the key components of AFFF. Second, this Example compares the physicochemical properties and PFAS removal capabilities of this multi-template MIP to analogous single-template and non-imprinted MIPs and the unmodified biochar. Third, the present Example evaluates adsorption and regeneration capabilities of the multi-template MIP through batch tests at PFAS concentrations relevant to (waste)water treatment and a column filtration study using spiked, real wastewater effluent. The viability of the macromolecular crowding approach in aqueous MIP synthesis was also explored and is detailed further.

### Materials and Methods

### Adsorbent Materials and Chemicals

Spent coffee grounds for biochar production were donated by Bay Laurel Catering Services at the University of Washington (Seattle, WA) from Starbucks® Pike Place® grounds, medium roast, arabica coffee sourced from Latin America after use in an industrial drip coffee maker. For column testing, the commercially available activated carbon Filtrasorb® 400 (F400) was obtained from Calgon Carbon (Pittsburgh, PA). F400 was chosen because it is a commonly used adsorbent for PFAS treatment owing to its high point of zero charge (pzc) which allows it to have a slightly positive surface charge at neutral pH, increasing PFAS adsorption through electrostatic attraction with negatively charged PFAS. Prior to use, it was ground, sieved to obtain the #30-50 mesh fraction (595-297 μm), and washed with deionized water to remove fine particulates. Sand was obtained from The Home Depot (Atlanta, GA) to be used as an inert column packing. Coarse gravel was obtained from The Home Depot and was used to pack the ends of the columns to distribute flow and prevent washout of column packing. Prior to use, sand and gravel were washed with 1 M and 0.5 mM nitric acid, respectively (ACS grade nitric acid obtained from Macron Fine Chemicals™ was diluted with ultrapure water), and then washed with deionized water until the rinse reached a pH of approximately 7.0.

All chemicals used for this Example were ACS reagent grade or equivalent unless otherwise noted. Potassium hydroxide pellets and high purity nitrogen gas (99.998%) for biochar production were purchased from Thermo Fisher Scientific (Waltham, MA) and Praxair (Danbury, CT), respectively. Molecularly imprinted polymers were synthesized using PFBS and PFPeA purchased from Sigma Aldrich (St Louis, MO), and 6:2-FTS from AA Blocks (San Diego, CA) as templates; vinylbenzyl trimethylammonium chloride (VBTAC, 96.0%) purchased from Acros Organics as the functional monomer; N,N′-methylenebisacrylamide (MBA, 96.0%) purchased from Thermo Fisher Scientific as the crosslinker; and 2,2′-azobis(2-methylpropionitrile) (AIBN, 98%) purchased from Sigma Aldrich as the initiator. Methanol and potassium hydroxide purchased from Thermo Fisher Scientific and sodium chloride (NaCl) purchased from VWR Chemical were used for template washing and regeneration of spent adsorbent.

Optima™ LC/MS grade methanol purchased from Thermo Fisher Scientific was used for preparation of stock solutions and LC-MS/MS samples for all batch tests. Perfluorooctanesulfonate potassium salt (PFOS) from Matrix Scientific; perfluorohexanesulfonate potassium salt (PFHxS), perfluorobutanesulfonic acid (PFBS), perfluorooctanoic acid (PFOA), perfluoropentanoic acid (PFPeA), perfluorohexanoic acid (PFHxA), perfluorobutanoic acid (PFBA), trifluoroacetic acid (TFA) from Sigma Aldrich (St Louis, MO); and 6:2-fluorotelemere sulfonate (6:2-FTS) from AA Blocks (San Diego, CA) were used as adsorbates. Batch test and wastewater samples were processed using 0.22 μm cellulose acetate (CA) syringe filters from Sigma Aldrich.

Puriss p.a. grade potassium hydrogen phthalate monobasic for preparation of DOC calibration standards from Sigma Aldrich, 1.6 micron glass fiber (GF/A) 42.5 mm filter paper from Whatman (United Kingdom), sodium chloride from VWR, sodium nitrate from VWR, sodium sulfite from Fisher Chemical, sodium sulfate from VWR, trace metals grade nitric acid from Thermo Fisher Scientific, and ICP standards from Inorganic Ventures (Christiansburg, PA) were used for initial characterization of wastewater treatment plant effluent samples. Fipronil from Chem Impex International (Wood Dale, IL), ultrapure acetaminophen (99.0%) from Spectrum Chemical Manufacturing Corporation (New Brunswick, NJ), and HPLC grade benzotriazole and HPLC grade sulfamethoxazole from TCI Chemicals (Tokyo, Japan) were used for spiking co-occurring organics into the column test influent solution along with the nine PFAS used in batch testing.

### Synthesis of Multi-Template MIP Immobilized on Spent Coffee Grounds Biochar

Several types of single- and multi-template molecularly imprinted polymer (MIP)-biochar composites were synthesized via thermally activated radical initiated polymerization as described in Example 1. The names, surface area, and templates of these materials are outlined in TABLE 9. Briefly, spent coffee grounds biochar (BC) was produced via a two-step process of pyrolysis at 400° C. followed by activation with a 1:1 weight ratio of potassium hydroxide at 800° C., as described previously, and then sieved to obtain the #30-50 mesh fraction (595-297 μm). MIP was immobilized directly on the surface of the BC via a three-step process. First 0.1820 g functional monomer (VBTAC) and PFAS template(s) were pre-mixed at a by stirring for 10 h at 150 rpm in 170 mL of deaerated ultrapure water to allow time for alignment in solution. For all MIP composites, a 4:1 molar ratio of total template to functional monomer was maintained. In situations where more than one template was used, equimolar quantities of each template were added to achieve this ratio. Second, 1.3240 g crosslinker (MBA) and 0.5 g pre-wetted BC were added and allowed to mix for 30 min before adding 0.1642 g of initiator (AIBN) and starting the polymerization reaction by heating the solution to 60° C. in an oil bath while maintaining stirring at 150 rpm. Polymerization was allowed to proceed for 15 h (which was assumed to be sufficient time to allow natural termination of the polymerization) before removing the solution from the oil bath and separating the BC@MIP composite material via vacuum filtration. Finally, the PFAS template was removed from the BC@MIP by adding 100 mL of a template wash solution (70% methanol, 1% sodium chloride, and 2.8 mM sodium hydroxide in water) and placing it on a shaker at 200 rpm and 33° C. for a minimum of 24 h before decanting to separate. This wash was repeated for a total of five times with template wash solution followed by one ultrapure water wash. Template extraction was considered successful if PFAS concentrations in the fifth wash solution were at or below 200 μg/L (around three orders of magnitude lower than the concentration in the polymerization solution). Following washing, BC@MIP materials were dried at 60° C. for 24 h, sieved to obtain the #50-30 mesh (297-595 micron) fraction, and then stored in glass vials in a desiccator for further analysis. A non-imprinted polymer composite (BC@NP) was synthesized via the same process without the use of a template PFAS analyte, and the final washing was limited to a 24 h ultrapure water wash to remove excess monomers and polymer.

TABLE 9
MIP composite composition, BET specific surface area, pore size, and cumulative pore surface area.

| | templates | | | BET analysis | | |
|---|---|---|---|---|---|---|
| adsorbent name | 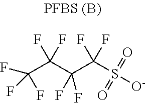 [SMILES: O=S(=O)([O-])C(F)(F)C(F)(F)C(F)(F)C(F)(F)F] | 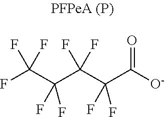 [SMILES: O=C([O-])C(F)(F)C(F)(F)C(F)(F)C(F)(F)F] | 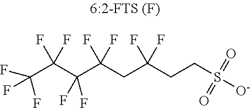 [SMILES: O=S(=O)([O-])CCC(F)(F)CC(F)(F)C(F)(F)C(F)(F)C(F)(F)F] | BET surface area (m²/g) | pore size (nm) | Pore surface area (m²/g) |
| BC | — | — | — | 1319 | 3.3 | 60 |
| BC@NP | — | — | — | 580 | 3.0 | 39 |
| BC@MIP (F) | — | — | Y | 904 | 7.4 | 50 |
| BC@MIP (B) | Y | — | — | 1056 | 6.5 | 63 |
| BC@MIP (P) | — | Y | — | 881 | 9.8 | 52 |
| BC@mMIP | Y | Y | Y | 995 | 4.7 | 54 |
| F400 | — | — | — | 917 | 5.6 | 123 |

### Characterization of Biochar-Molecularly Imprinted Polymer Composite

Specific surface area (SSA) was measured for the unmodified and polymer-modified BC adsorbents via nitrogen adsorption at 77K with a Micromeritics 3Flex Version 5.00 (Norcross, GA). Degassing was conducted in situ at 300° C. for 12 h prior to analysis followed by a two min leak test with a pressure fluctuation limit of 0.0025 mmHg/min to confirm successful degassing. Free space analysis was conducted with helium gas after adsorption to eliminate the effects of trapped helium gas in the micropores on nitrogen adsorption. Adsorption data was evaluated using the Brunauer-Emmett-Teller (BET) model to obtain the SSA, and the Barrett-Joyner-Halenda (BJH) model to obtain average pore diameter and cumulative pore surface area.

The multi-template BC@mMIP material was imaged using transmission electron microscopy (TEM) to better visualize the thickness and uniformity of the MIP layer. First, a small amount of sample was embedded into resin, dried at 60° C. for 24 h, and sliced into 80 nm sections using a Leica Ultracut 6 microtome and hard diamond knife. Finally, the sample was imaged using a Tecnai G2 F20 SuperTwin TEM (FEI, Hillsboro, OR).

### Batch Adsorption Testing

### PFAS Selectivity in Ultrapure Water

An adsorption competition test was conducted in ultrapure water to evaluate the impact of the multi-template approach on adsorption capabilities for a range of PFAS. All six adsorbent materials listed in TABLE 9 were included in this test. Adsorbates included short- and long-chain sulfonic and carboxylic PFAA and one polyfluoroalkyl acid (i.e., PFOS, PFHxS, PFBS, PFOA, PFHxA, PFPeA, PFBA, TFA, and 6:2-FTS). Briefly, 5.0 mg of adsorbent was added to a 50 mL polypropylene tube, with triplicate samples of each adsorbent prepared. At the same time, the PFAS solution was prepared in ultrapure water in a 1 L Erlenmeyer flask with concentrated methanolic stocks to achieve an initial concentration of 50 μg/L of each PFAS while maintaining a methanol concentration of no more than 0.02% v/v. This solution was allowed to mix for 10 min and then the pH was measured and adjusted if needed with dilute sodium hydroxide or hydrochloric acid solutions to achieve a pH of 7.00. This method of pH control was chosen over buffering to eliminate potential effects of the buffer compound on PFAS adsorption. A 50 mL aliquot of the initial PFAS solution was added to each sample, and tubes were placed on a Fisherbrand™ Multi-Purpose Tube Rotator (Fisher Scientific, Waltham, MA) and rotated at 40 rpm for 4 days.

Following the 4-day equilibration period, tubes were removed from the rotator and filtered through 0.22 μm cellulose acetate syringe filters. To minimize PFAS losses on the filter, approximately 25 mL of sample was collected for filtration and the first 20 mL were wasted before collecting around 1.5 mL for subsequent analysis. Samples were prepared and analyzed via liquid chromatography tandem mass spectrometry (LC-MS/MS) as detailed in the supplemental information. Final sample pH was measured following removal of the LC-MS/MS sample and ranged from 6.21-7.33.

Percent removal, normalized equilibrium adsorption capacity (q_{e,SSA}), solid-liquid distribution coefficient (K_{d}), and selectivity coefficients were calculated from adsorption data using equations (4.1)-(4.6) below. Selectivity calculations were performed using template compound(s) as the reference adsorbate and the unmodified BC as the reference adsorbent.

$$\begin{matrix}Percent removal = \frac{( {C}_{0} - {C}_{e} )}{{C}_{0}} * 100 \% & Eqn . 6 \\ {q}_{e} = ( {C}_{0} - {C}_{e} ) * \frac{V}{{m}_{ads}} & Eqn . 7 \\ {K}_{d} = \frac{{C}_{0} - {C}_{e}}{{C}_{e}} * \frac{V}{{m}_{ads}} & Eqn . 8 \\ {K}_{imprinted} = \frac{{q}_{e , BC @ MIP , template}}{{q}_{e , BC @ MIP , adsorbate}} & Eqn . 9 \\ {K}_{comparison} = \frac{{q}_{e , BC @ NP , template}}{{q}_{e , BC @ NP , adsorbate}} & Eqn . 10 \\ {K}_{selectivity} = \frac{{K}_{impmrinted}}{{K}_{comparison}} & Eqn . 11 \\ IF = \frac{{q}_{e , BC @ MIP , template}}{{q}_{e , BC @ NP , template}} & Eqn . 12\end{matrix}$$

Where C₀ and Cₑ are the initial and equilibrium adsorbent concentrations (mg/L), Vis the sample volume (L), and m_{ads} is the mass of adsorbate on the adsorbent (g).

Adsorption Isotherms with Molecular Imprinting Template PFAS

Adsorption isotherms were conducted with each template PFAS individually using the BC@mMIP to gain a more complete understanding of the adsorption mechanisms and capabilities of the material for removal of different types of PFAS. All samples were run in triplicate in a 50 mL polypropylene tube containing 50 mL of PFAS solution in ultrapure water and 100 mg/L adsorbent. Initial concentrations ranged from 5-5000 μg/L of PFBS, PFPeA, and 6:2-FTS for each single adsorbate sample. Multiple methanolic stock solutions were used to prepare these samples such that the methanol concentration remained below 0.2% v/v and pipetted volumes of methanol were no smaller than 10 μL. The initial pH of the two highest concentration PFPeA replicate sets was adjusted with dilute hydrochloric acid to 6.7±0.7 to match the pH of the rest of the isotherm samples. This step was necessary for these samples only because the methanolic stock solutions for the perfluorocarboxylic acids (PFCAs) contain four mole equivalents of sodium hydroxide to prevent methylation of PFCAs during long term storage. Once prepared, sample tubes were placed on a tube rotator at 40 rpm and allowed to equilibrate for 4 d before filtering as described further herein regarding preparing LC-MS/MS samples for PFAS quantification as described. Adsorption results were fit to the Langmuir and Freundlich isotherm models described in equations (4.8) and (4.9) to gain a better understanding of adsorption behavior:

$$\begin{matrix}{q}_{e} = \frac{{q}_{max} {K}_{L} {C}_{e}}{1 + {K}_{L} {C}_{e}} & Eqn . 13 \\ {q}_{e} = {K}_{F} {C}_{e}^{1 / n} & Eqn . 14\end{matrix}$$

Where qₑ and qₘₐₓ are the equilibrium and maximum adsorption densities, Cₑ is the equilibrium adsorbate concentration, K_{L} and K_{F} are the Langmuir and Freundlich adsorption rate constants, respectively, and 1/n is the Freundlich coefficient of non-linearity.

### Adsorption and Regeneration at Environmentally Relevant Concentrations

Simultaneous adsorption of approximately 100 ng/L each of nine PFAS (i.e., PFOS, PFHxS, PFBS, 6:2-FTS, PFOA, PFHxA, PFPeA, PFBA, and TFA) onto BC@mMIP in ultrapure water was observed to better understand the capabilities of this materials for PFAS removal at concentrations relevant to (waste)water treatment. Prior to the start of the experiment, all glassware was washed three times with methanol and once with ultrapure water. First, 3.3 L of ultrapure water were added to a 4 L Erlenmeyer flask and spiked with methanolic stocks of each PFAS to achieve the desired starting concentration of 100 ng/L. The solution was stirred for 10 min to fully mix the reagents, and then the initial pH was adjusted to 7.0 with dilute sodium hydroxide. The PFAS solution was then measured into six 500 mL high density polyethylene (HDPE) bottles (i.e., three BC@mMIP replicates and three PFAS control replicates) and three 50 mL polypropylene tubes (i.e., PFAS initial concentration replicates). Three additional 500 mL HDPE bottles were filled with ultrapure water for blank control replicates. BC@mMIP was added to the samples where relevant to achieve an adsorbent concentration of 100 mg/L and then all HDPE sample bottles were placed on a shaker table at 180 rpm and allowed to equilibrate for 4 d. The initial concentration controls were concentrated via solid phase extraction (SPE) and stored in the refrigerator for no more than two weeks prior to analysis via LC-MS/MS. After 4 d, the solid and liquid phases of the BC@mMIP samples were separated, and all nine liquid samples were concentrated via SPE and PFAS concentrations were quantified via LC-MS/MS.

PFAS loaded on spent BC@mMIP adsorbents were recovered using the template wash solution described further herein for 7 d to better understand PFAS recovery and material lifetimes. Briefly, spent adsorbent from each BC@mMIP sample bottle was placed in individual 50 mL tubes and suspended in 50 mL of template wash solution. Tubes were wrapped in parafilm and placed on a tube rotator at 40 rpm. A 0.05 mL sample aliquot was collected at 1 d and 3 d timepoints to evaluate regeneration kinetics, and an equal volume of fresh template wash solution was added to maintain a total volume of 50 mL throughout the regeneration test. After 7 d, the regeneration samples were removed from the rotator and a sample was collected from each. PFAS concentrations in all samples were quantified via LC-MS/MS.

### Column Testing

Column tests were performed using wastewater treatment plant effluent spiked with nine PFAS and four organics to better evaluate adsorption capabilities under wastewater treatment-relevant conditions and to evaluate material lifetimes. In this test, the BC@mMIP material was compared to the BC@NP, commercial activated carbon (F400) and sand control columns.

### Column Set Up

### Column Assembly and Packing

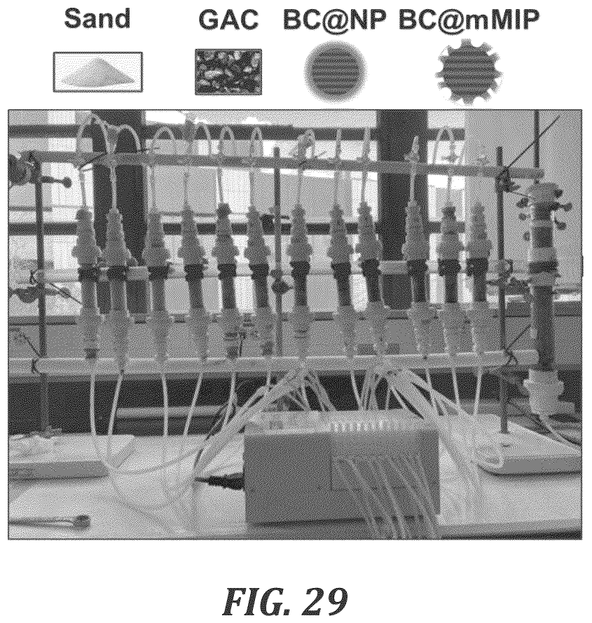

Triplicate columns were run for each of four packing types [sand (control), F400 (commercial AC), BC@NP, and BC@mMIP] for twelve columns in total. Columns were constructed from PVC pipes and fittings with HDPE tubing and tubing fittings. Columns were run in an up-flow configuration. Influent solution was stored in a covered 55 L linear low-density polyethylene (LLDPE) tank at room temperature with constant stirring. An Ismatec IP High Precision Multichannel peristaltic pump was used to convey water to the columns, and PharMed® BPT tubing was used within the pump housing. Sample ports were located at the top of the columns and effluent was subsequently collected in a PVC pipe and collected for disposal. A photo of the assembled columns is provided in FIG. 29. Adsorbents (BC@mMIP, BC@NP and F400) were packed at 1 weight percent (wt. %) with pre-washed sand (approximately 56 g sand and 0.56 g adsorbent media per column). Columns were weighed pre- and post-packing, and both wet and dry to quantify the pore volume in each column (TABLE 16).

### Tracer Testing

Following column assembly, a tracer test was performed using sodium borate to confirm the column pore volumes calculated herein above. Tracer stock solutions of 2.5 mM and 50 mM Br as NaBr were prepared in ultrapure water. The lower concentration stock was used for the sand, BC@NP, and BC@mMIP columns while the high concentration stock was used for the F400 columns to account for the moderate levels of bromide adsorption by that material. A flow of 1 mL/min of deionized (DI) water was started through the first column replicate of each adsorbent type (for a total of four columns). The columns were allowed to equilibrate for 60 min, and then a 1 minute duration sample was collected from each column and weighed to confirm the flow rate.

Once the columns were equilibrated at the correct flow rate, influent lines were removed from the DI water, placed in the appropriate NaBr stock for 8 seconds, and then placed back in the DI water. Small air bubbles were allowed to form in the tubing lines on either side of the NaBr stock to track the location of the tracer. The movement of the tracer aliquot through the influent lines to the start of the column was timed and recorded for future reference. Tracer test sampling was started once the tracer stock reached the column with 1 minute (1 mL) samples collected every two minutes from each column.

### Wastewater Effluent Characterization and Preparation for Column Influent

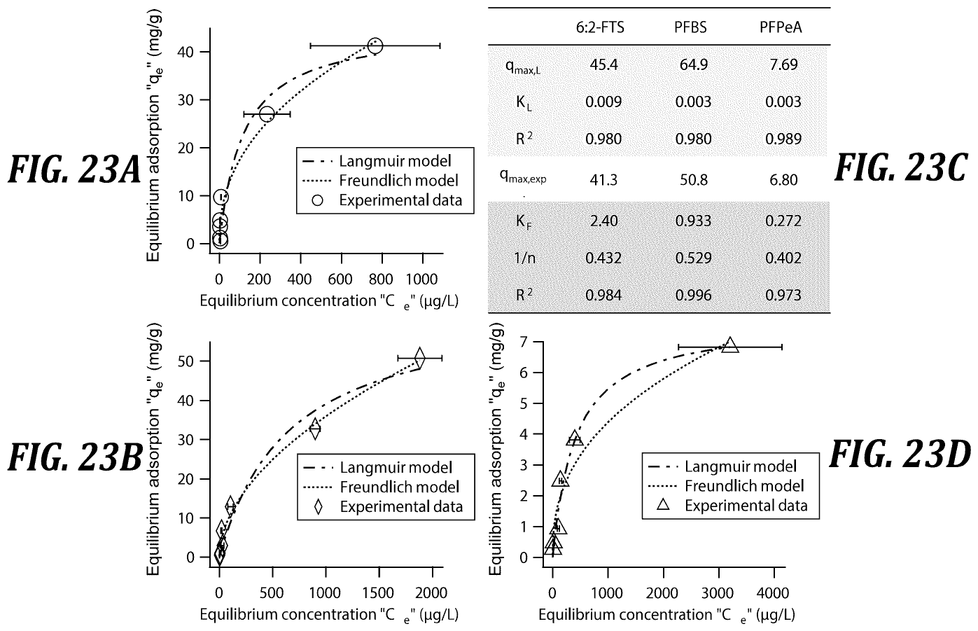

Wastewater treatment plant (WWTP) effluent was obtained from the West Point Treatment Plant located in Seattle, WA and operated by the King County Wastewater Treatment Division. Samples were collected weekly in 5-gal buckets and stored at room temperature until use. Aliquots of each weekly sample were characterized as follows to gain a better understanding of the chemical composition of the WWTP effluent and results from all analyses are tabulated in FIG. 23C.

### Quantification of Organic Matter and pH

Dissolved organic carbon (DOC) was quantified as described by Standard Method 5310 using a Shimadzu TOC-L analyzer (Kyoto, Japan) using the non-purgeable organic carbon analysis mode. A 20 mL sample of wastewater effluent was filtered with a 0.22 μm cellulose acetate syringe filter by first wasting approximately 10 mL of sample through the filter prior to collecting a 9 mL aliquot for DOC analysis.

Total dissolved solids (TDS) and total suspended solids (TSS) were quantified as described by Standard Methods 5240C and 2540D, respectively. Briefly, a Whatman glass fiber filter was pre-washed with 60 mL of ultrapure water, dried at 100° C. overnight, weighed, and washed with an additional 30 mL of ultrapure water. A 250 mL glass beaker was also washed with ultrapure water, dried at 180° C. overnight and weighed. A 250 mL aliquot of WWTP effluent sample was passed through this filter using high vacuum, and the filtrate was collected in the 250 ml beaker. Filtrate was evaporated to dryness at 100° C., then heated at 180° C. for 1 h and weighed once cool. The difference in mass compared to the washed beaker was attributed to TDS. Organics retained on the filter were dried at 100° C. overnight and weighed, and the change in mass compared to the washed filter was attributed to TSS.

Sample pH was measured with an Orion Star A111 PH meter equipped with an Orion Ross Ultrap pH/ATC Triode probe.

### Quantification of Ions and Trace Organic Contaminants

Ions from common salts were measured via ion chromatography (for anions: chloride, nitrate, and sulfate) and inductively coupled plasma optical emission spectroscopy [ICP-OES; for cations: sodium, calcium (II), magnesium (II), lead (II), aluminum (III), and total iron]. Instrument and methodology details for both analyses are given in the supplemental information. For both analyses, samples were filtered with a 0.22 μm syringe filter by first wasting approximately 10 mL of sample through the filter prior to collecting the aliquot for analysis. ICP-OES samples were also acidified with nitric acid to obtain a final acid concentration of 1% v/v.

Initial concentrations of adsorbates of interest (i.e., PFOS, PFHxS, PFBS, 6:2-FTS, PFOA, PFHxA, PFPeA, PFBA, TFA, acetaminophen, fipronil, sulfamethoxazole, and benzotriazole) were quantified via liquid chromatography tandem mass spectrometry (LC-MS/MS) and high performance liquid chromatography followed by ultra-violet spectroscopy (HPLC-UV) as described further herein. No quantifiable amounts of PFAS, fipronil, or sulfamethoxazole were found in the wastewater effluent samples; benzotriazole was quantified in the wastewater effluent at 7.7±1.9 μg/L and was factored into the initial concentration of the column test influent accordingly.

### Preparation of Column Influent Stock Solution

Column influent stock comprised of WWTP effluent spiked with approximately 20 μg/L each of PFOS, PFHxS, PFBS, 6:2-FTS, PFOA, PFHxA, PFPeA, PFBA, TFA, acetaminophen, fipronil, sulfamethoxazole, and benzotriazole was prepared in batches of no more than 55 L. Briefly, a concentrated adsorbate stock was prepared in ultrapure water from individual methanolic stocks. The ultrapure water stock was stirred for 10 minutes to completely mix, and then a 1 mL aliquot was collected for adsorbate quantification. This stock was then added to the appropriate volume of WWTP effluent to obtain the desired goal concentration and stirred overnight to obtain a homogeneous mixture. Slow stirring was maintained for the duration of the column test and influent stock was refreshed every 3-4 days as needed. WWTP effluent samples were collected weekly.

### Column Adsorption and Regeneration

PFAS adsorption and recovery capabilities in the columns were evaluated over four sequential cycles of adsorption and regeneration with each cycle consisting of a six-day adsorption period followed by six hours of regeneration and then an 18 hour low flow DI wash. During the adsorption phase, a constant flow of 1 mL/min of the column influent stock was delivered to each column. Samples were collected as one-minute composites (1 mL sample volume) and stored at −20° C. prior to analyte quantification. After six days, flow to the columns was briefly stopped, and influent lines were washed with ultrapure water and placed in the regeneration solution (column wash). The column wash was 70% methanol, 1% sodium chloride and 2.8 mM sodium hydroxide in ultrapure water. During the regeneration phase, column wash was delivered at 0.5 mL/min for six hours. Samples were collected as two-minute composites (1 mL sample volume) and stored at −20° C. prior to analyte quantification. Following regeneration, DI water was passed through the columns at 0.5 mL/min for 18 hours to wash out any residual methanol or sodium chloride in preparation for the next adsorption phase.

### Viability of the Macromolecular Crowding Approach to BC@MMIP Synthesis

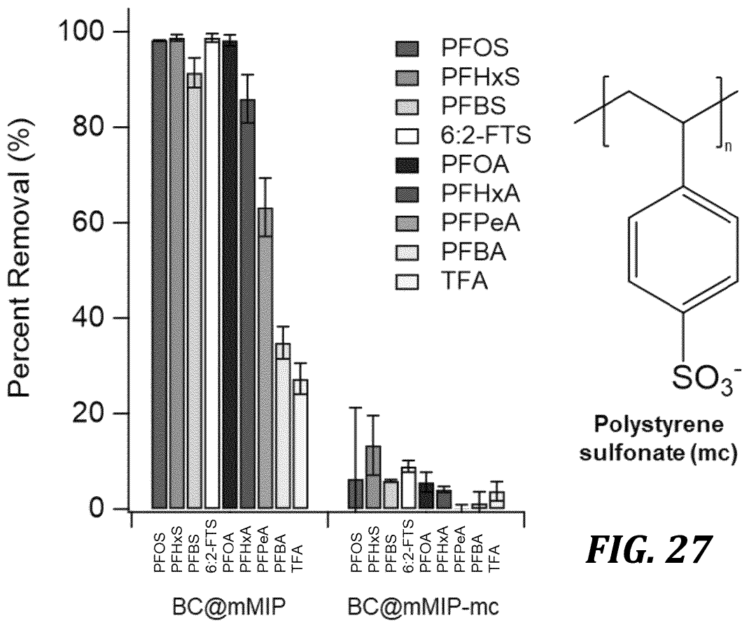

A modified synthesis approach for the multi-template BC@mMIP was attempted using polystyrene sulfonate as macromolecular crowding agent to increase interactions between the template and functional monomer and thus improve the imprinting factor of the MIP product. Polystyrene sulfonate was chosen for its high water solubility and similarity in structure to the commonly used macromolecular crowding agent polystyrene. Results shown in FIG. 27 showed poor PFAS removal by the resulting adsorbent (BC@mMIP-mc), thus this approach was not employed for further adsorbent synthesis.

### TEM Embedding Resin Recipe

Transmission electron microscopy (TEM) samples were embedded in a resin prepared as shown in TABLE 11. Approximately 5 mg of sample was placed in a plastic conical tube mold approximately 1×2 cm and allowed to harden overnight at 60° C.

TABLE 11
TEM Embedding Resin Recipe.

| component | quantity |
|---|---|
| epoxy resin (Poly/Bed 812) | 24 g |
| dodecenyl succinic anhydride (DDSA) | 16 g |
| nadic methyl anhydride (NMA) | 10 g |
| 2,4,6-tris(dimethylaminomethyl)phenol | 1.5%-2% |
| (DMP-30) Or | |
| benzyldimethylamine (BDMA) | |

### Effect of Swelling on Bet Surface Area of Multi-Template and Non-Imprinted Polymers

The effect of polymer swelling on BC@MIP/NP morphology was evaluated via a 4-day equilibration in ultrapure water followed by drying at 60° C. Subsequently, the surface area, pore size, and pore surface area were evaluated via nitrogen adsorption as described further herein. Swelling appeared to have minimal impact on surface area, but significantly increased the pore size and surface area (TABLE 12). These changes could impact adsorption kinetics over multiple cycles of adsorption and regeneration with these materials, particularly if the adsorbent is allowed to dry out during this process.

TABLE 12
Changes in BET surface area (SA), pore size, and pore
SA following polymer layer swelling and redrying.

| | BET SA | pore size | pore SA |
|---|---|---|---|
| adsorbent name | (m²/g) | (nm) | (m²/g) |
| BC@NP | 580 | 3.0 | 39 |
| BC@NP post- | 562 | 66.9 | 230 |
| swelling | | | |
| BC@mMIP | 625 | 9.0 | 54 |
| BC@mMIP post- | 653 | 20.3 | 36 |
| swelling | | | |

### Chemical Properties of PFAS and Organics

TABLE 13
Chemical properties of nine PFAS adsorbates and four co−occurring organics.

| name | structure | pKa^{a} | solubility^{b} | logK_{oc}^{b} | [symbol] |
|---|---|---|---|---|---|
| PFOS | 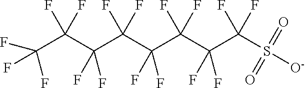 [SMILES: O=S(=O)([O-])C(F)(F)C(F)(F)C(F)(F)C(F)(F)C(F)(F)C(F)(F)C(F)(F)C(F)(F)F] | −6 to −2.6 | 0.104 | 4.86 | [symbol] |
| PFHxS | 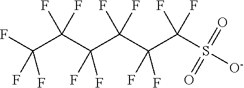 [SMILES: O=S(=O)([O-])C(F)(F)C(F)(F)C(F)(F)C(F)(F)C(F)(F)C(F)(F)F] | −6 to −5.0 | 6.17 | 3.55 | [symbol] |
| PFBS | 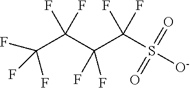 [SMILES: O=S(=O)([O-])C(F)(F)C(F)(F)C(F)(F)C(F)(F)F] | −6 to −5.0 | 344 | 2.25 | [symbol] |
| 6:2-FTS | 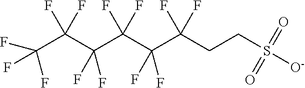 [SMILES: O=S(=O)([O-])CCC(F)(F)C(F)(F)C(F)(F)C(F)(F)C(F)(F)C(F)(F)F] | 1.31 | 11.0 | 4.05 | [symbol] |
| PFOA | 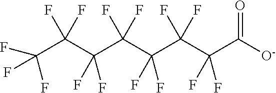 [SMILES: O=C([O-])C(F)(F)C(F)(F)C(F)(F)C(F)(F)C(F)(F)C(F)(F)C(F)(F)F] | −0.16 to 3.8 | 0.481 | 4.42 | [symbol] |
| PFHxA | 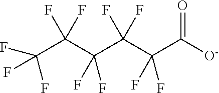 [SMILES: O=C([O-])C(F)(F)C(F)(F)C(F)(F)C(F)(F)C(F)(F)F] | −0.13 | 27.1 | 3.12 | [symbol] |
| PFPeA | 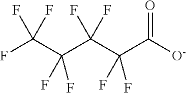 [SMILES: O=C([O-])C(F)(F)C(F)(F)C(F)(F)C(F)(F)F] | −0.06 | 197 | 2.46 | [symbol] |
| PFBA | 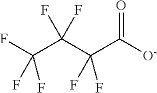 [SMILES: O=C([O-])C(F)(F)C(F)(F)C(F)(F)F] | −0.2 to 0.7 | 1370 | 1.81 | [symbol] |
| TFA | 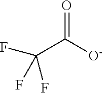 | 0.23 | 97,500 | 0.51 | [symbol] |
| fipronil | 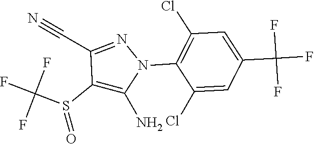 [SMILES: N#Cc1nn(-c2c(Cl)cc(C(F)(F)F)cc2Cl)c(N)c1S(=O)C(F)(F)F] | no dissociation | 1.90 | 3.77 | [symbol] |
| acetaminophen | 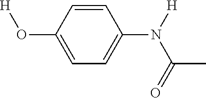 | 9.38 | 30,400 | 1.65 | [symbol] |
| benzotriazole | 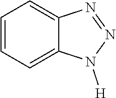 | 8.37 | 19,800 | 1.72 | [symbol] |
| sulfamethoxazole | 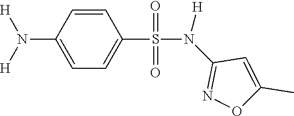 [SMILES: Cc1cc(NS(=O)(=O)c2ccc(N)cc2)no1] | pKₐ₁ [symbol] 1.6 pKₐ₂ [symbol] 5.7 | 3,940 | 2.41 | [symbol] |

[symbol]

indicates data missing or illegible when filed

a. PFAS source: SGS. “Physical and Chemical Properties of PFAS Compounds.” Fipronil source: Bo [symbol] 2015. Other compounds source: PubChem.
b. US EPA. 2020. Estimation Programs Interface Suite™ for Microsoft® Windows, v 4.1. U [symbol] Environmental Protection Agency, Washington, DC, USA.
c. Calculated from pKa and log K_{oc}

### Limits of Detection and Quantification

Method limits of detection (LoD) and quantification (LoQ) were calculated for LC-MS/MS and HPLC-UV samples run in either (A) 50% v/v ultrapure water and Optima Grade methanol, and (B) 50% v/v Optima Grade methanol and 25% v/v each of ultrapure water and wastewater final effluent (TABLE 14) using equations (C.1) through (C.4) below. LoD and LoQ represent analytical method limits only and do not account for concentration factors resulting from solid phase extraction. Values presented are the average of LoD and LoQ values calculated for each analysis run (+/−) the standard deviation.

$$\begin{matrix}{s}^{2} = \frac{{\sum }_{i = 1}^{n} {( {y}_{i} - {f}_{i} )}^{2}}{n - 2} & Eqn . 15 \\ {s}_{intercept} = \sqrt{\frac{{s}^{2} \times {\sum }_{i = 1}^{n} {x}_{i}^{2}}{n \times {\sum }_{i = 1}^{n} {x}_{i}^{2} - {( {\sum }_{i = 1}^{n} {x}_{i} )}^{2}}} & Eqn . 16 \\ LoD = 3.3 \times {s}_{intercept} / slope & Eqn . 17 \\ LoQ = 10 \times {s}_{intercept} / slope & Eqn . 18\end{matrix}$$

Where s² is the sum of the squared differences between the calibration curve data and a linear regression fit, yᵢ is the measured dependent variable from the calibration curve (i.e., the signal), fᵢ is the predicted dependent variable (i.e., the signal calculated using the slope and intercept from a linear regression of the calibration curve data), n is the number of data points in the calibration curve, s_{intercept} is the standard deviation of the intercept, xᵢ is the known dependent variable from the calibration curve (i.e., the concentration), LoD is the limit of detection, slope is the slope value of a linear regression of the calibration curve, and LoQ is the limit of quantification. A similar calculation was performed to determine the LoD and LoQ from the standard deviation of the slope; however, these values were consistently lower than the LoD and LoQ presented here and thus have been excluded from this discussion.

TABLE 14
Limit of detection and limit of quantification for nine PFAS and
four organic contaminants in (A) 50% v/v ultrapure water and
Optima Grade methanol, and (B) 50% v/v Optima Grade methanol
and 25% v/v each of ultrapure water and wastewater final effluent.

| Analyte | LoD | LoQ | LoD | LoQ |
|---|---|---|---|---|
| PFOS | 0.15 ± | 0.47 ± | 0.43 ± | 1.29 ± |
| | 0.09 | 0.26 | 0.31 | 0.93 |
| PFHxS | 0.33 ± | 1.00 ± | 0.52 ± | 1.57 ± |
| | 0.15 | 0.46 | 0.23 | 0.70 |
| PFBS | 0.23 ± | 0.71 ± | 0.38 ± | 1.15 ± |
| | 0.11 | 0.34 | 0.21 | 0.64 |
| 6:2-FTS | 0.32 ± | 0.97 ± | 0.77 ± | 2.34 ± |
| | 0.21 | 0.64 | 0.39 | 1.18 |
| PFOA | 0.15 ± | 0.44 ± | 0.22 ± | 0.66 ± |
| | 0.09 | 0.26 | 0.11 | 0.32 |
| PFHxA | 0.28 ± | 0.84 ± | 0.38 ± | 1.17 ± |
| | 0.09 | 0.26 | 0.15 | 0.45 |
| PFPeA | 0.27 ± | 0.82 ± | 0.35 ± | 1.05 ± |
| | 0.08 | 0.24 | 0.19 | 0.59 |
| PFBA | 0.19 ± | 0.59 ± | 0.40 ± | 1.21 ± |
| | 0.11 | 0.34 | 0.16 | 0.48 |
| TFA | 0.32 ± | 0.98 ± | 0.73 ± | 2.21 ± |
| | 0.19 | 0.59 | 0.36 | 1.08 |
| Fipronil | | | 0.68 ± | 1.51 ± |
| | | | 0.52 | 0.69 |
| Acetaminophen | | | 0.74 ± | 2.26 ± |
| | | | 0.29 | 0.88 |
| Benzotriazole | | | 1.00 ± | 3.04 ± |
| | | | 0.28 | 0.86 |
| Sulfamethoxazole | | | 0.94 ± | 2.86 ± |
| | | | 0.34 | 1.02 |

### Selectivity Coefficient Calculations

Selectivity coefficients were calculated from the results of the PFAS competition test as discussed further herein.

TABLE 15
Selectivity coefficients comparing adsorption of 6:2-FTS,
PFBS, and PFPeA templates to other contaminants of interest
(COI; e.g., PFOS) on single and multi-template BC@MIP
adsorbents to adsorption on the non-imprinted BC@NP.

| adsorbent | COI | K_{imprinted} | K_{comparison} | K_{selectivity} | Kᵢₘ [symbol] |
|---|---|---|---|---|---|
| BC@NP | PFOS | | 0.74 | | |
| BC@MIP | | 0.82 | | 1.11 | 0. [symbol] |
| BC@mMIP | | 0.86 | | 1.16 | 0. [symbol] |
| BC@NP | PFHxS | | 0.97 | | |
| BC@MIP | | 0.87 | | 0.90 | 0. [symbol] |
| BC@mMIP | | 0.97 | | 1.00 | 0. [symbol] |
| BC@NP | PFBS | | 1.60 | | |
| BC@MIP | | 1.92 | | 1.20 | |
| BC@mMIP | | 0.99 | | 0.61 | |
| BC@NP | 6:2-FTS | | | | |
| BC@MIP | | | | | 0. [symbol] |
| BC@mMIP | | | | | 1. [symbol] |
| BC@NP | PFOA | | 1.00 | | |
| BC@MIP | | 1.11 | | 1.11 | 0. [symbol] |
| BC@mMIP | | 0.90 | | 0.90 | 0. [symbol] |
| BC@NP | PFHxA | | 1.45 | | |
| BC@MIP | | 1.63 | | 1.12 | 1. [symbol] |
| BC@mMIP | | 0.91 | | 0.62 | 0. [symbol] |
| BC@NP | PFPeA | | 4.71 | | |
| BC@MIP | | 4.98 | | 1.06 | 1. [symbol] |
| BC@mMIP | | 1.32 | | 0.28 | 1. [symbol] |
| BC@NP | PFBA | | 28.75 | | |
| BC@MIP | | 40.70 | | 1.42 | 3. [symbol] |
| BC@mMIP | | 2.33 | | 0.08 | 2. [symbol] |

[symbol]

indicates data missing or illegible when filed

### Desorption Kinetics Following Adsorption of (Waste)Water Relevant Concentrations of Nine PFAS on BC@MMIP

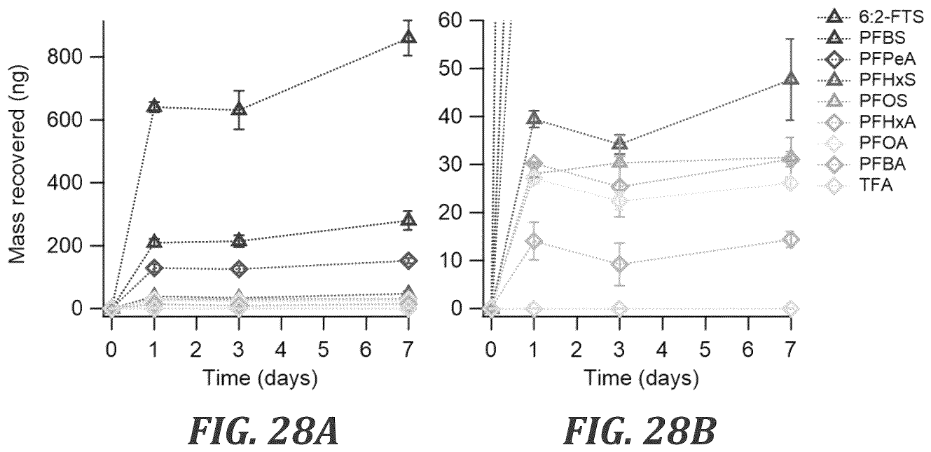

Desorption kinetics from the batch sorption and desorption test are presented in FIGS. 28A and 28B below and indicate fast desorption of all nine PFAS from the BC@mMIP adsorbent material.

### Column Set-Up

Triplicate columns were run for each of four packing types [sand (control), F400 (commercial AC), BC@NP, and BC@mMIP] for twelve columns in total, as shown in FIG. 29.

### Column Pore Volumes

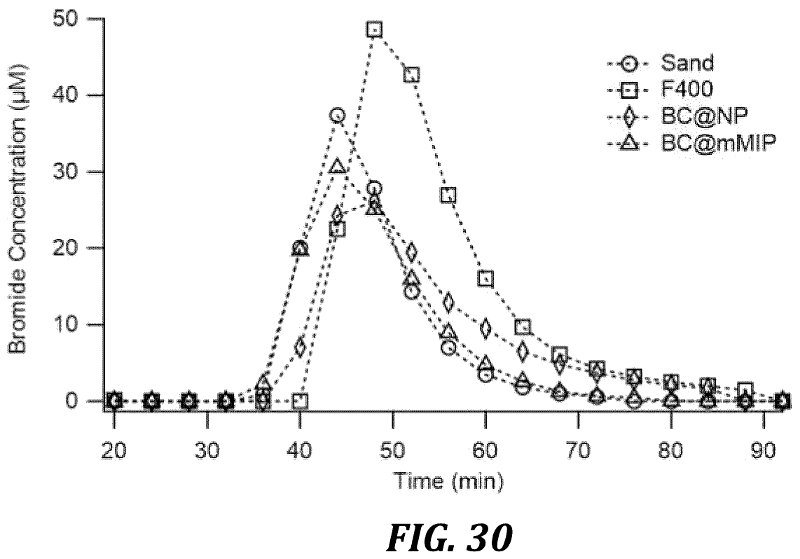

TABLE 16 presents average adsorbent media masses for triplicate columns assembled, and column pore volumes calculated from both the mass change in wet versus dry column weights and from tracer test results and FIG. 30 (graphical tracer test results).

TABLE 16
Column packing characteristics and calculated pore volumes.

| | | F400 | BC@NP | BC@mMIP |
|---|---|---|---|---|
| Media type | Sand | (1 wt %) | (1 wt %) | (1 wt %) |
| mass active | — | 0.52 | 0.54 | 0.54 |
| media (g) | | | | |
| PV_{mass calculation} (mL) | 11.1 | 12.5 | 9.7 | 11.0 |
| PV_{tracer test} (mL) | 27.1 | 27.4 | 37.2 | 27.9 |

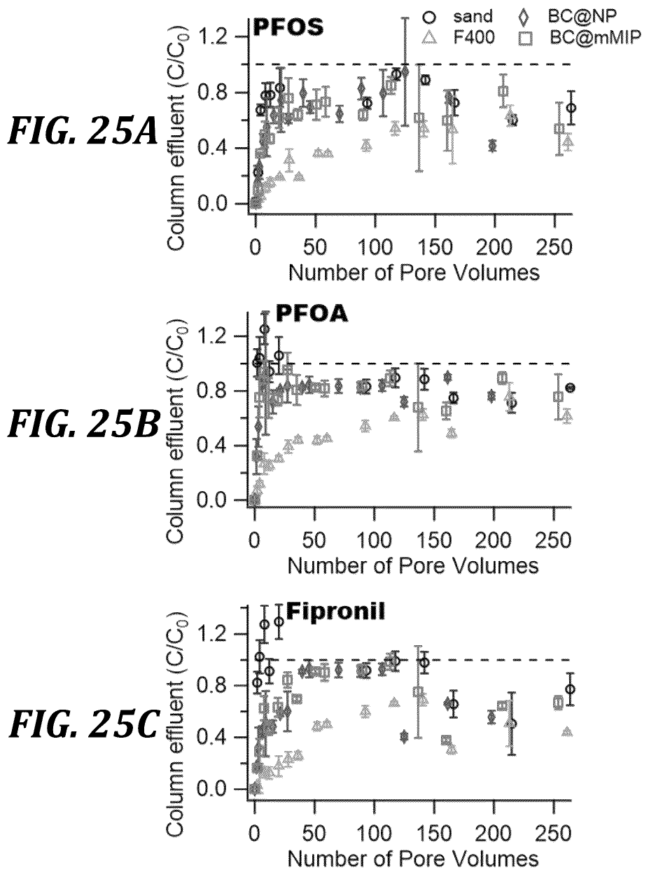

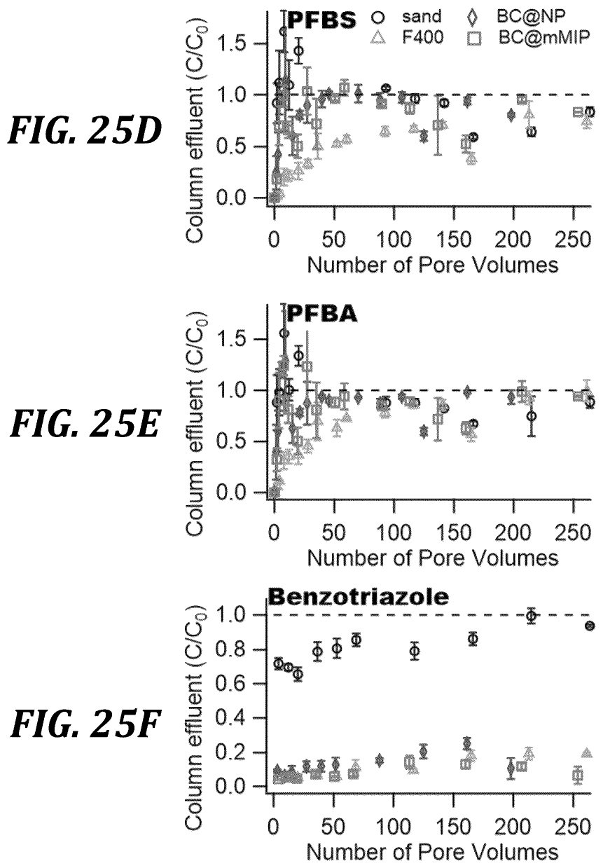

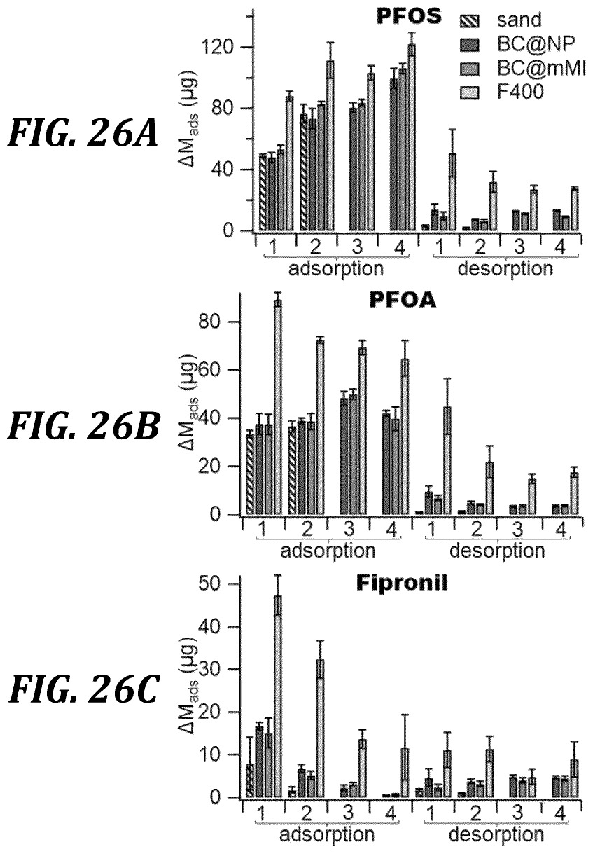

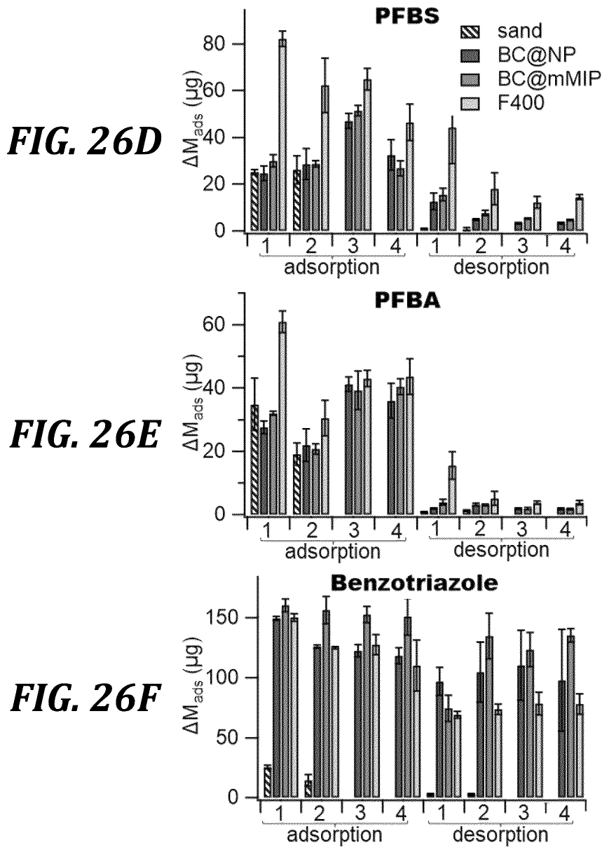

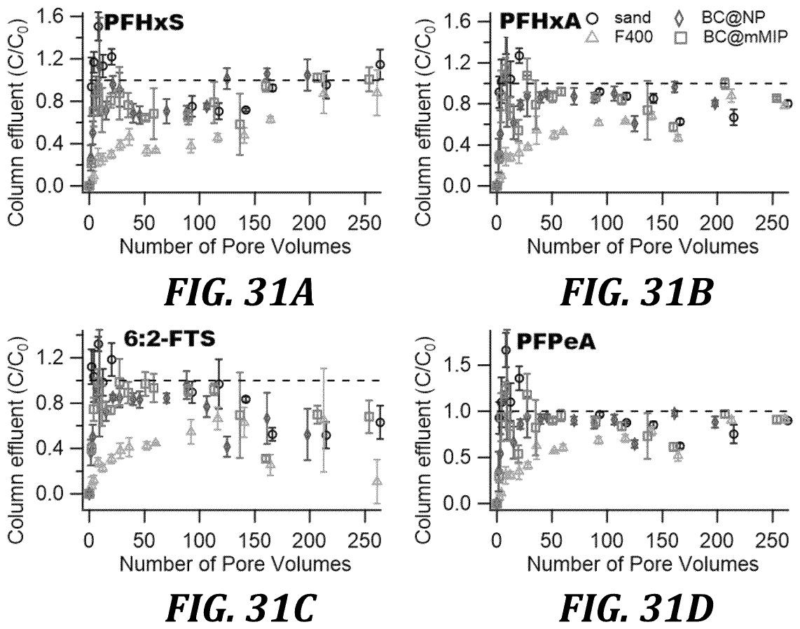

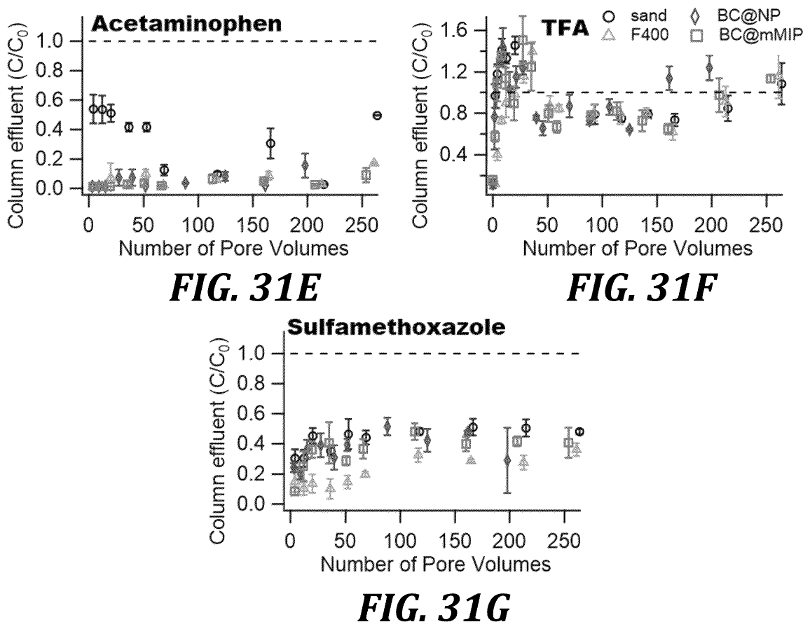

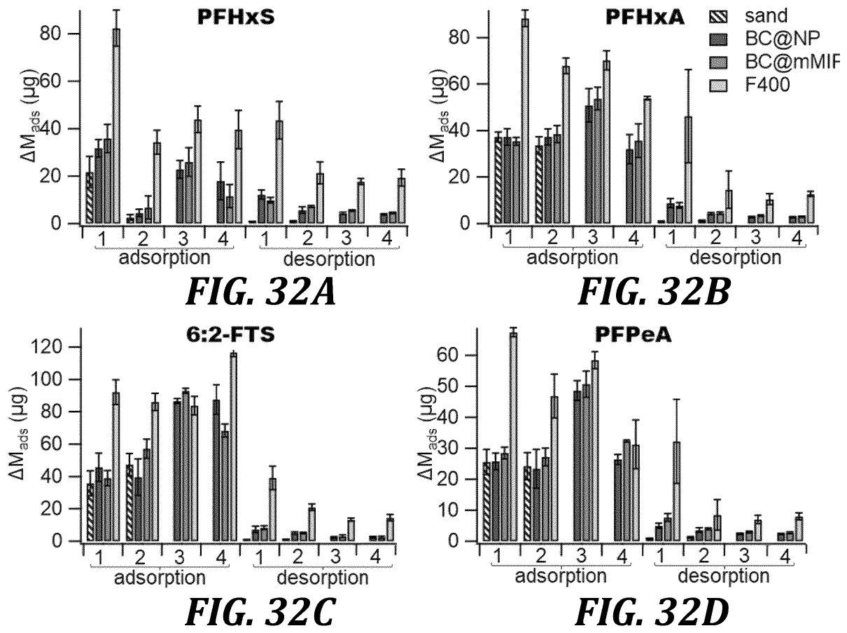

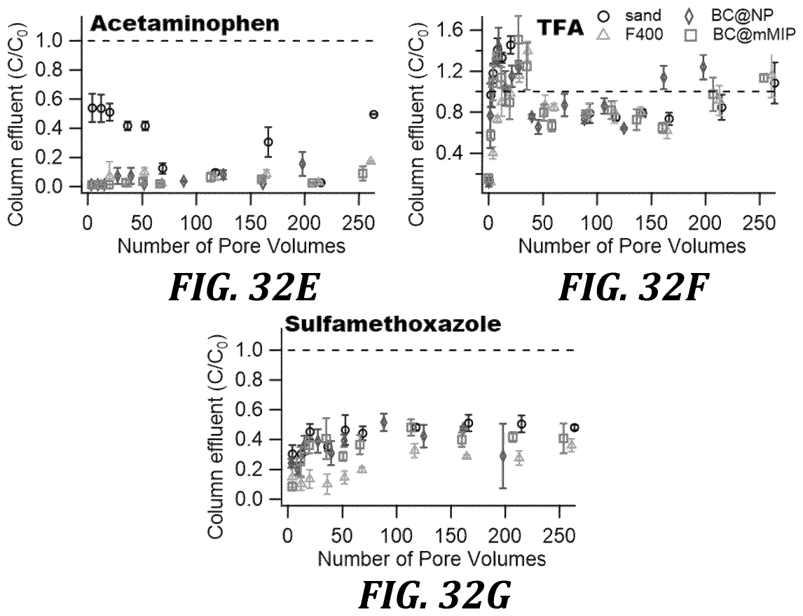

Additional Column Test Plots of Time Series Adsorption and Mass Change Time series and mass change plots of column test results for analytes not included in FIGS. 25A-25F and FIGS. 26A-26F are presented in FIGS. 31A-31G and FIGS. 32A-32G below.

### LC-MS/MS Analysis for Quantification of PFAS and Fipronil

Concentrations of all PFAS were quantified by mass spectroscopy using a Waters Corporation (Milford, MA) triple quadrupole mass spectrometer (MS/MS) preceded by liquid chromatography (LC). Prior to analysis, samples were filtered to remove biochar fines and (where applicable) organic compounds that would negatively impact instrument performance. Briefly, samples were filtered with a cellulose acetate (CA) syringe filter by first filtering 20 mL of sample into waste and then collecting 1.5 mL of filtered sample. Cellulose acetate was chosen as a filter media for its low PFAS loss. All liquid chemicals used in LC-MS/MS analysis of PFAS were Optima® LCMS Grade and the Ammonium Acetate was certified ACS Grade (98.1% purity), all purchased from Fisher Chemical (Hampton, NH). All PFAS calibration and internal standards were purchased from Wellington Laboratories (Ontario, CA) unless otherwise noted.

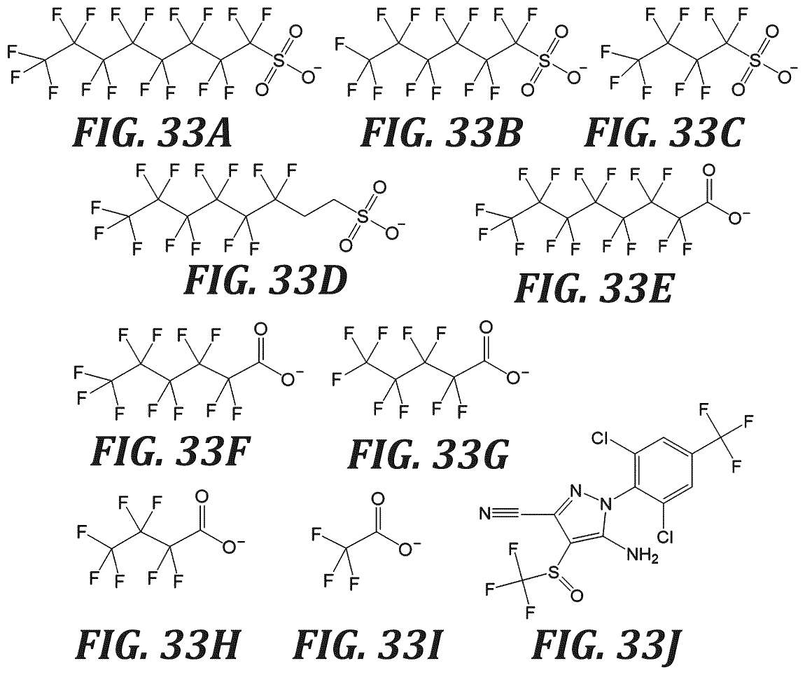

PFOS (C₈F₁₇SO₃; FIG. 33A), PFHxS (C₆F₁₃SO₃; FIG. 33B), PFBS (C₄F₉SO₃; FIG. 33C), 6:2-FTS (C₈F₁₃H₄SO₃; FIG. 33D), PFOA (C₈HF₁₅O₂; FIG. 33E), PFHxA (C₆HF₁₁O₂; FIG. 33F), PFPeA (C₅HF₉O₂; FIG. 33G), PFBA (C₄HF₇O₂; FIG. 33H), TFA (C₂HF₃O₂; FIG. 33I), and fipronil (C₁₂H₄Cl₂F₆N₄OS; FIG. 33J) were analyzed via LC-MS/MS using an Agilent (Santa Clara, CA) Zorbax Rapid Resolution Eclipse XBD-18C column (2.1×50 mm, 1.8 μm). An Agilent, XDB-C18 guard cartridge (80 Å, 4.6×12.5 mm, 5 μm) was placed before the LC column to pre-filter the sample. For samples run without concentration, mass labeled PFOS (¹³C₄-PFOS), PFOS (¹⁸O₂-PFHxS), PFOA (¹³C₄-PFOA), PFHxA (¹³C₂-PFHxA), and PFBA (¹³C₄-PFBA) were used as performance internal standards as shown in TABLE 17. For samples requiring concentration, solid phase extraction was performed as described further herein; mass labeled PFOS (¹³C₄-PFOS), PFOS (¹⁸O₂-PFHxS), 6:2-FTS (¹³C₂-6:2-FTS), PFOA (¹³C₄-PFOA), PFHxA (¹³C₂-PFHxA), and PFBA (¹³C₄-PFBA) were used as extraction internal standards while mass labeled PFNA (¹³C₉-PFNA) purchased from Cambridge Isotope Laboratories (Tewksbury, MA) was used as a performance internal standard, as shown in TABLE 18.

The MS/MS operation mode was set to negative electrospray ionization with multiple reaction monitoring (MRM) transitions (TABLE 19). The LC was operated with a stationary phase of HPLC grade water with 10 mM ammonium acetate (A) and a mobile phase of HPLC grade methanol with 10 mM ammonium acetate (B). Details of the gradient program are given in TABLE 20. Batch test calibration standards and samples were prepared with a 50:50 volumetric ratio of methanol and ultrapure water (or sample in ultrapure water) to minimize PFOS losses to the walls of the polypropylene LCMS vials. Column test samples and the corresponding calibration standards were prepared in a 50:25:25 volumetric ratio of methanol, ultrapure water, and filtered effluent wastewater (or sample in wastewater matrix). This matrix matching of column test samples allowed for normalization of the impact of high wastewater TDS on analyte retention on/recovery from the chromatography column, particularly for low molecular weight PFAS (i.e., TFA and PFBA).

TABLE 17
Performance internal standards for unconcentrated PFAS samples.

| PFAS | performance |
|---|---|
| compound | standard |
| PFBS | ¹³C₂—PFHxA |
| PFHxS | ¹⁸O₂—PFHxS |
| PFOS | ¹³C₄—PFOS |
| 6:2-FTS | ¹³C₄—PFOA |
| TFA | ¹³C₄—PFBA |
| PFBA | ¹³C₄—PFBA |
| PFPeA | ¹³C₂—PFHxA |
| PFHxA | ¹³C₂—PFHxA |
| PFOA | ¹³C₄—PFOA |
| fipronil | ¹³C₄—PFOA |

TABLE 18
Extraction and performance internal standards for analysis
of PFAS samples including solid phase extraction (SPE).

| PFAS | extraction | performance |
|---|---|---|
| compound | standard | standard |
| PFBS | ¹³C₂—PFHxA | ¹³C₉—PFNA |
| PFHxS | ¹⁸O₂—PFHxS | ¹³C₉—PFNA |
| PFOS | ¹³C₄—PFOS | ¹³C₉—PFNA |
| 6:2-FTS | ¹³C₄—6:2-FTS | ¹³C₉—PFNA |
| TFA | ¹³C₄—PFBA | ¹³C₉—PFNA |
| PFBA | ¹³C₄—PFBA | ¹³C₉—PFNA |
| PFPeA | ¹³C₂—PFHxA | ¹³C₉—PFNA |
| PFHxA | ¹³C₂—PFHxA | ¹³C₉—PFNA |
| PFOA | ¹³C₄—PFOA | ¹³C₉—PFNA |

TABLE 19
LC-MS/MS parameters used for quantification of PFAS.

| | | | | | colli- | |
|---|---|---|---|---|---|---|
| | ioniza- | | produc- | cone | sion | |
| | tion | parent | tion | energy | energy | [symbol] T |
| | mode | (m/z) | (m/z) | (V) | (V) | [symbol] min) |
| TFA | − | 112.70 | 68.40 | 19.0 | 10.0 | [symbol] .5 |
| PFBA | − | 213.00 | 169.00 | 11.0 | 13.0 | [symbol] .6 |
| ¹³C₄-PFBA | − | 217.00 | 172.00 | 11.0 | 13.0 | [symbol] .6 |
| PFPeA | − | 263.00 | 219.00 | 17.0 | 8.0 | [symbol] .2 |
| PFBS | − | 299.00 | 79.40 | 20.0 | 35.0 | [symbol] .3 |
| PFBS | − | 299.00 | 98.50 | 25.0 | 35.0 | [symbol] .3 |
| PFHxA | − | 313.10 | 118.60 | 18.0 | 22.0 | [symbol] .0 |
| PFHxA | − | 313.10 | 269.10 | 18.0 | 9.0 | [symbol] .0 |
| ¹³C₂-PFHxA | − | 315.00 | 270.00 | 18.0 | 9.0 | [symbol] .0 |
| PFHxS | − | 399.00 | 79.40 | 54.0 | 35.0 | [symbol] .6 |
| PFHxS | − | 399.00 | 98.50 | 54.0 | 35.0 | [symbol] .6 |
| ¹⁸O₂-PFHxS | − | 403.00 | 83.50 | 65.0 | 35.0 | [symbol] .6 |
| 6:2-FTS | − | 427.00 | 79.40 | 47.0 | 35.0 | [symbol] .2 |
| 6:2-FTS | − | 427.00 | 407.00 | 47.0 | 19.0 | [symbol] .2 |
| ¹³C₄-6:2-FTS | − | 429.00 | 409.00 | 47.0 | 19.0 | [symbol] .2 |
| PFOA | − | 413.10 | 169.00 | 18.0 | 19.0 | [symbol] .2 |
| PFOA | − | 413.10 | 369.00 | 18.0 | 10.0 | [symbol] .2 |
| ¹³C₄-PFOA | − | 417.10 | 372.00 | 18.0 | 10.0 | [symbol] .2 |
| PFOS | − | 498.95 | 79.40 | 53.0 | 40.0 | [symbol] .6 |
| PFOS | − | 498.95 | 98.50 | 53.0 | 35.0 | [symbol] .6 |
| ¹³C₄-PFOS | − | 503.10 | 79.40 | 53.0 | 40.0 | [symbol] .6 |
| ¹³C₉-PFNA | − | 463.00 | 219.00 | 18.0 | 11.0 | [symbol] .6 |
| fipronil | − | 436.90 | 330.20 | 32 | 16 | [symbol] .9 |

[symbol]

indicates data missing or illegible when filed

TABLE 20
LC gradient program for elution of PFAS compounds
using 10 mM ammonium acetate in water and methanol
as the stationary and mobile phases.

| | % A (10 mM | % B (10 mM | |
|---|---|---|---|
| time | ammonium | ammonium acetate in | flow rate |
| (min) | acetate) | methanol) | (mL/min) |
| 0.0 | 80 | 20 | 0.4 |
| 8.0 | 5 | 95 | 0.4 |
| 10.0 | 5 | 95 | 0.4 |
| 10.5 | 80 | 20 | 0.4 |
| 16.0 | 80 | 20 | 0.4 |

### Concentration of PFAS Samples Via Solid Phase Extraction

Low concentration PFAS samples from the batch test were processed via solid phase extraction (SPE) prior to LC-MS/MS analysis to concentrate the sample using a modified version of the EPA Draft Method 1633. Solvents used were Optima™ LC-MS/MS grade unless otherwise noted. Briefly, 2.5 μg of each extraction internal standard (¹³C₄-PFOS, ¹⁸O₂-PFHxS, ¹³C₂-6:2-FTS, ¹³C₄-PFOA, ¹³C₂-PFHxA, and ¹³C₄-PFBA) were added to each sample as methanolic stocks, and the samples were inverted approximately 20 times to mix. Phenomenex Strata X-AW SPE cartridges were preconditioned with 1% ammonium hydroxide (ACS grade) in methanol and 0.3 M formic acid (ACS grade) in ultrapure water as described in Draft Method 1633 and then the sample was passed through under low vacuum at 5 mL/min. Sample bottles and cartridges were washed with two 5 mL aliquots of ultrapure water followed by 5 mL of 1:1 methanol and 0.1 M formic acid in ultrapure water and then dried by applying low vacuum for 10 min followed by high vacuum for 30 s. The sample was eluted by passing through approximately 7 mL of 1% v/v ammonium hydroxide in methanol under low vacuum at a flow rate of 1 mL/min and collected in a 15 mL polypropylene tube. Samples were evaporated to dryness in a nitrogen evaporator with the water bath at 50° C. and a nitrogen flow of 30 SCFH. Samples were reconstituted in the polypropylene tube with 500 μL of ultrapure water and 490 μL of methanol, vortexed for 30 s, allowed to sit at 4° C. overnight, and then vortexed for 30 s before transferring to a polypropylene LC-MS/MS vial. A 10 μL aliquot of a 600 μg/L methanolic stock of the performance internal standard (¹³C₉-PFNA) was added to each LC-MS/MS vial for a total volume of 1 mL. Samples were stored at 4° C. before LC-MS/MS analysis was performed as described further herein.

### Ion Chromatography and ICP-OES Analysis for Quantification of Ionic Salts in Wastewater Treatment Plant Effluent

Selected anions (chloride, nitrate, sulfate) were quantified in the wastewater final effluent samples obtained from King County West Point Treatment Plant via ion chromatography (IC). IC analysis was performed on a Thermo Scientific™ Dionex™ ICS 3000 instrument equipped with a Thermo Scientific™ Dionex™ IonPac™ AS-9 high-capacity analytical column preceded by an AG-9 guard column and a ERS 500 carbonate suppressor. The instrument was operated using the gradient described in TABLE 21. Prior to analysis, samples were filtered with a 0.22 μm cellulose acetate syringe filter by first wasting 10 mL of sample through the filter before collecting approximately 1.5 mL for analysis. Differentiation between sulfate and sulfite peaks was not possible with this method; however, the presence of sulfite species in aerobic waters (e.g., wastewater effluent) is unlikely, thus the entire peak area was attributed to sulfate.

TABLE 21
Ion Chromatography Gradient for Determination
of Selected Anions in Wastewater.

| | % A | % B (9 mM sodium | |
|---|---|---|---|
| time | (deaerated | carbonate | flow rate |
| (min) | ultrapure water) | in water) | (mL/min) |
| 0.0 | 67 | 33 | 0.25 |
| 10.0 | 85 | 15 | 0.25 |
| 16.0 | 0 | 100 | 0.25 |
| 18.0 | 67 | 33 | 0.25 |
| 25.0 | 67 | 33 | 0.25 |

Selected cations (calcium, magnesium, iron, lead, aluminum, and sodium) were quantified by ion coupled plasma optical emission spectroscopy (ICP-OES) on a Perkin Elmer Optima 8300 instrument using a modified version of Standard Method 3010. Briefly, prior to analysis samples were filtered with a 0.45 μm nylon syringe filter by first wasting 10 mL of sample through the filter before collecting approximately 10 mL for analysis. Nitric acid was added to filtered samples to achieve a concentration of 1% v/v and acidified samples were stored at 4° C. until analysis.

### HPLC-UV Analysis for Quantification of Acetaminophen, Benzotriazole, and Sulfamethoxazole

Acetaminophen, benzotriazole, and sulfamethoxazole in column test samples were quantified via high performance liquid chromatography coupled with UV spectrophotometry. Analysis was performed on a Thermo Scientific™ Dionex™ UltiMate™ 3000 instrument equipped with a Millipore Sigma™ Supelco™ Ascentis™ C18 analytical column (3 μm particle size, 15 cm×2.1 mm) preceded by a Supelco™ Ascentis™ C18 Supelguard™ guard column (3 μm particle size). An isometric mobile phase of (A) 81% v/v of HPLC grade water containing 0.1% v/v HPLC grade formic acid and (B) 19% v/v of HPLC grade methanol was delivered at 0.2 mL/min for the duration of the run. Analyte retention times, detection wavelengths, and chemical structure are given in TABLE 22 below. All samples were run without dilution to account for the relatively high limits of quantification (TABLE 14) compared to the expected concentrations. Matrix matching of calibration standards was performed to account for any impact of wastewater salts and organics on HPLC performance.

TABLE 22
HPLC Analysis Conditions and Molecular Structures of Select Organic Compounds.

| | | wavelength | |
|---|---|---|---|
| analyte | RT (min) | (nm) | structure |
| acetaminophen | 6.1 | 244 | 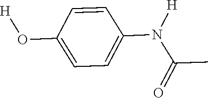 |
| benzotriazole | 19.0 | 270 | 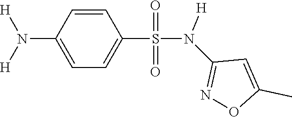 [SMILES: Cc1cc(NS(=O)(=O)c2ccc(N)cc2)no1] |
| sulfamethoxazole | 23.0 | 272 | 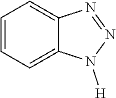 |

### Results and Discussion

### High BC@MIP Specific Surface Area is Attributed to Biochar Morphology and Templated Binding Sites

BET surface area analysis and TEM imaging revealed a thin, variable polymer coating on the BC@mMIP composite with high SSA derived from both the microporous biochar morphology and templated binding sites in the polymer layer. Only a minor reduction in SSA was observed following immobilization of the single- and multi-template imprinted polymers to the biochar surface (TABLE 9).

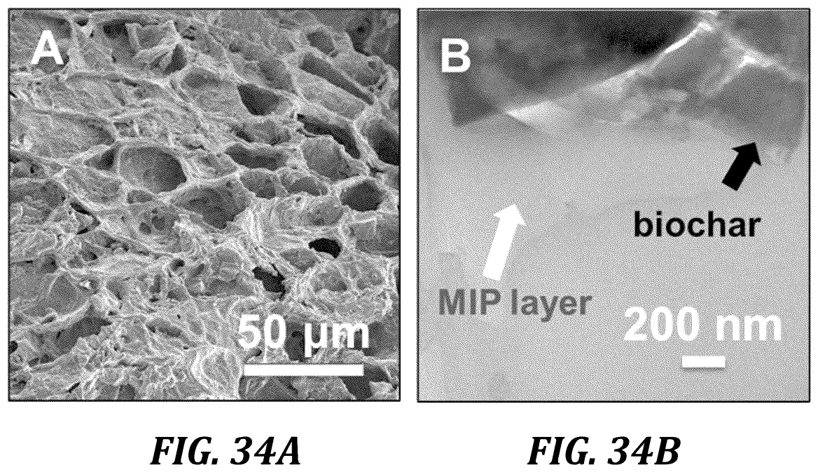

All four BC@MIP materials had a SSA of around 1000 m²/g compared to 1319 m²/g for the unmodified biochar. The average pore diameter increased slightly following MIP immobilization from 3.3 nm for the BC to 4.1-9.8 nm for the BC@MIP materials. This increase in pore size can be primarily attributed to the formation of templated binding sites since the non-imprinted polymer (BC@NP) did not experience a similar increase in pore size. Polymer thickness for the BC@mMIP material can be estimated in the range of 10-500 nm from the TEM image shown in FIGS. 34A and 34B. It should be noted that significant spatial variability in polymer thickness appears to be present, likely a result of the irregular morphology of the biochar surface as well as irregularity inherent in the radical initiated polymerization process. This high surface area is expected to contribute to high PFAS adsorption capacities.

### Batch Adsorption Behavior

### Inclusion of Multiple Templates Improves Adsorption of Short- and Long-Chain PFAS

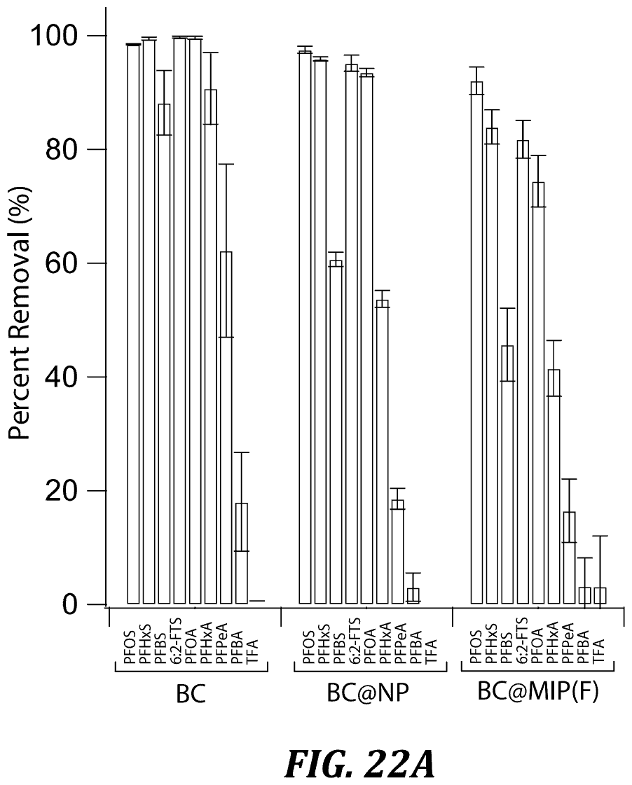

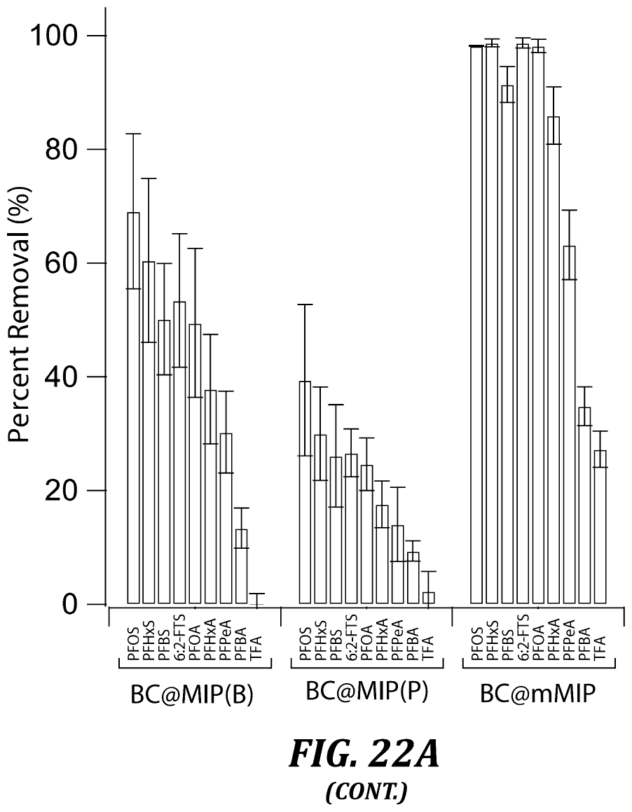

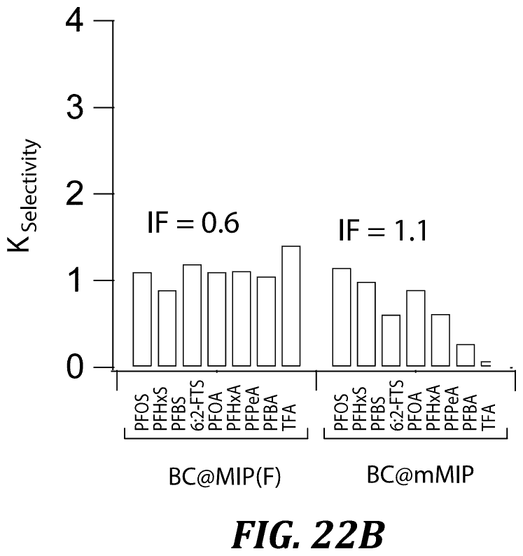

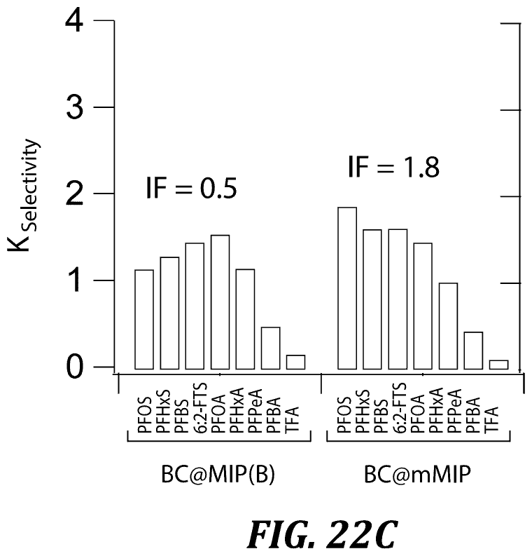

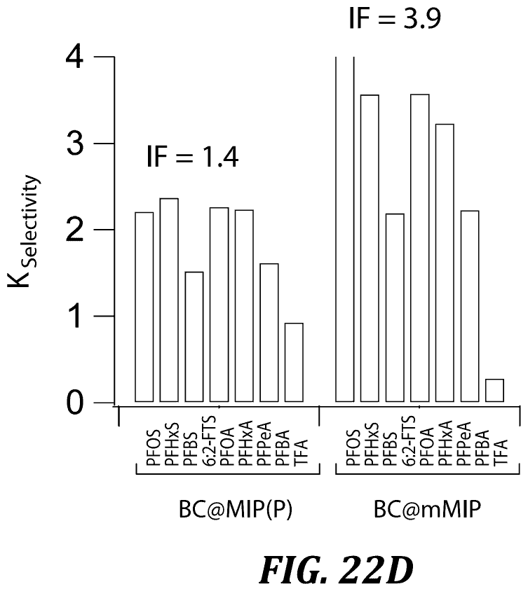

Inclusion of multiple PFAS templates in the BC@MIP synthesis rather than a single template compound appears to result in a synergistic effect (i.e., improved self-assembly of template and functional monomer) which is revealed through an examination of the imprinting factors (IFs). For all three template compounds, IFs are significantly higher for the BC@mMIP than for the corresponding single-template BC@MIP [FIGS. 22B-22D)]. The improved imprinting approach using multiple PFAS templates resulted in a subsequent improvement in adsorption of both short- and long-chain PFSAs and PFCAs, as demonstrated by the results of the PFAS competition test and shown in FIGS. 22A-22D). Single template BC@MIP materials do show improved adsorption of the template over other PFAS compounds when compared to the non-imprinted BC@NP. This is demonstrated by the selectivity coefficients [graphed in FIGS. 22B-22D) and tabulated in TABLE 15] which are generally greater than or equal to one. A K_{selectivity} value of greater than one indicates the templating process improved selectivity for the template compared to the other adsorbate of interest while a K_{selectivity} value of less than one indicates templating improved selectivity for the other adsorbate of interest compared to the template. One notable exception is the low K_{selectivity} values for PFPeA and PFBA adsorption onto BC@MIP(F) which supports a hypothesis that MIPs templated solely by long-chain PFAS perform poorly for short chain PFAS removal, likely due to competition between short- and long-chain PFAS for adsorption sites. By contrast, the BC@mMIP material had lower template selectivity but higher percent removals, making it a more ideal adsorbent for treatment of a suite of PFAS compounds. This is demonstrated through a closer look at the K_{selectivity} values for BC@mMIP. For 6:2-FTS and PFBS, which are removed relatively well by all adsorbents of interest, K_{selectivity} values were around 1.0 or lower, indicating little to no improvement in selectivity for the template over other PFAS. For PFPeA, which was removed poorly by other polymer modified adsorbents, K_{selectivity} values were high for the PFSAs and long-chain PFCAs and very low for PFBA. This reflects the significant improvement in short-chain PFCA adsorption achieved through the multi-template approach, which can also be seen in FIG. 22A. This ability to remove long- and short-chain PFSAs and PFCAs makes BC@mMIP a better candidate for treatment of PFAS in waters containing a complex mixture of PFAS.

Compared to the non-imprinted polymer, the BC@mMIP showed similar adsorption of long chain PFAS (i.e., PFOS, PFHxS, 6:2-FTS, and PFOA) but significantly improved adsorption of shorter-chain PFAS. This indicates binding to templated sites is likely an important adsorption mechanism for short-chain PFAS removal while long-chain PFAS likely participate in both template site and non-specific adsorption. This may be due to competition between short- and long-chain PFAS at non-specific binding sites which is avoided due to size exclusion of larger PFAS at templated binding sites that were imprinted by short-chain PFAS (i.e., PFBS or PFPeA). Despite the improvement in short-chain PFAS adsorption observed for the BC@mMIP, a hierarchy of PFAS removals was still observed with removal of PFSAs >PFCAs and long-chain PFAS >short-chain PFAS. The reason for this is threefold. First, PFSAs generally have a higher electronegativity than their PFCA counterparts (owing to the sulfonic head group), increasing electrostatic attraction to the quaternary nitrogen moiety on the functional monomer. Second, as discussed above, long-chain PFAS are able to participate in adsorption to both non-specific and templated binding sites while short-chain PFAS appear more likely to adsorb to templated binding sites only. Finally, a significant decrease in adsorption is observed between PFHxA and PFPeA as well as between PFPeA and PFBA. This corresponds to significant increases in water solubility from 27.1 mg/L for PFHxA to 197 mg/L for PFPeA and to 1370 mg/L for PFBA (as shown in TABLE 13) which decreases the adsorptive driving forces for these shorter-chain PFAS, making them prefer to remain in the aqueous phase rather than adsorb to the more hydrophobic organic carbon of the BC@mMIP. This hierarchy of adsorption capabilities is not surprising when considering the physicochemical properties of these PFAS but should be considered when evaluating the adsorption capabilities of the BC@mMIP.

PFAS Head Group and Chain Length have a Significant Impact on Adsorption Capacity and Mechanism

Isotherm adsorption tests revealed PFBS adsorption onto BC@mMIP was described best by the Freundlich model (R²=0.996), indicating the presence of heterogeneous binding sites with variable affinity for the templates, as shown in FIGS. 23A-23D. This is attributed to multiple modes of adsorption: (i) binding to template-specific sites, (ii) binding to sites templated by other PFAS, and (iii) non-specific adsorption to the composite surface. Firstly, preferential adsorption at templated sites is expected to occur due to a combination of electrostatic attraction between the negatively charged sulfonate head group and the positively charged quaternary nitrogen moiety on the VBTAC template as well as hydrophobic attraction between the fluorocarbon tail of the PFBS and the aromatic ring on the VBTAC. Adsorption to PFBS-templated sites should be preferred over 6:2-FTS-templated or PFPeA-templated sites due to the size and shape selectivity inherent in the templating process. Finally, non-specific adsorption to untemplated sites on the MIP surface is expected to occur primarily as a lower affinity mechanism, primarily via hydrophobic attraction. Additional adsorption at high PFAS concentrations is likely to occur from PFAS-PFAS hydrophobic interaction resulting in the formation of micelles or hemimicelles on the adsorbent surface, a phenomenon that has been reported at equilibrium concentrations several orders of magnitude below the critical micelle concentration (i.e., approximately 6600 mg/L at 32° C. for PFBS). The 1/n value for the PFBS Freundlich model was less than 0.7 (see FIG. 23C), which is characteristic of highly curved isotherms and indicative of saturation of available binding sites near the high concentration end of the isotherm. This supports the conclusion that at PFBS concentrations near or above the high end of this isotherm data (i.e., greater than or equal to around 3000 μg/L) additional PFBS adsorption would be minimal and primarily the result of PFAS-PFAS interactions and some non-specific binding.

Adsorption of PFPeA was described well by the Langmuir model (R²=0.989), indicating adsorption mainly occurred to binding sites with homogeneous affinity as shown in FIGS. 23A-23D. This may be the result of PFPeA primarily binding at templated sites via electrostatic attraction with little to no non-specific binding occurring due to hydrophobic attraction to non-templated areas of the MIP surface. Another important consideration from these results is the low equilibrium adsorption capacities for PFPeA compared to the other templates. This is consistent with the results from the PFAS competition test (the qₑ for PFPeA adsorption onto BC@mMIP in that test was 0.38 mg/g). However, this indicates PFHxA or another longer chain PFAS may be a better choice for a PFCA template compound in future synthesis efforts while PFBS or other short-chain PFSAs are good choices for short-chain PFAS templates.

The adsorption of 6:2-FTS onto BC@mMIP by contrast, was described well by both the Langmuir (R²=0.980) and Freundlich (R²=0.984) models. The 6:2-FTS adsorption results indicate a much smaller difference in adsorption affinity between templated and non-specific binding sites for 6:2-FTS than for either PFBS or PFPeA. These isotherm results also reflect the high log K_{oc} and low water solubility of 6:2-FTS (see TABLE 13) which make adsorption of this compound easier onto a range of adsorbents, as demonstrated herein above. Thus, 6:2-FTS is likely to adsorb to both templated and non-specific binding sites across the range of concentrations investigated.

### BC@MMIP Removes PFOA to Below the Proposed EPA MCL at (Waste)Water-Relevant Concentrations

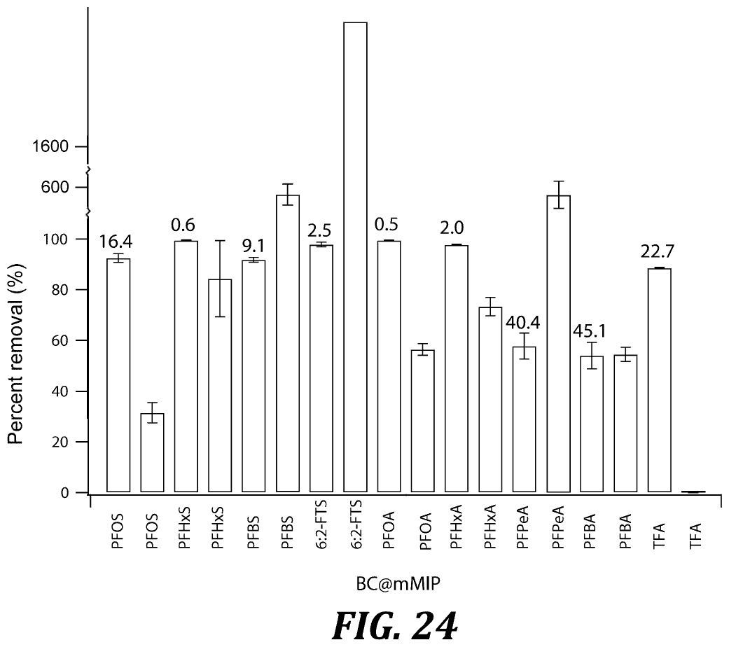

The BC@mMIP demonstrated high removals of PFAS at (waste)water treatment relevant concentrations, as demonstrated in FIG. 24, indicating this material may be a promising alternative for selective adsorption of PFAS. Over 90% removal was observed for four PFSAs (92.5% of PFOS, 99.4% of PFHxS, 91.7% of PFBS, and 97.7% of 6:2-FTS) and two long-chain PFCAs (99.4% of PFOA and 97.7% of PFHxA). Of particular note is the low equilibrium PFOA concentration (0.5 ng/L) which is well below the proposed EPA MCL of 4 ng/L. Two additional contaminants included in the proposed MCL, PFBS (9.1 ng/L at equilibrium) and PFHxS (0.6 ng/L at equilibrium), were similarly treated to well below their referenced Health Based Water Concentrations of 2000 ng/L and 10 ng/L, respectively. The equilibrium PFOS concentration (16.4 ng/L) was notably higher than the proposed MCL of 4 ng/L. This is attributed in part to the higher than expected initial PFOS concentration (217±93 ng/L) and in part to PFOS contamination observed during the SPE concentration step. However, despite these challenges, it is clear that high PFOS removal is possible. Over 50% removal of three short-chain PFCAs was also observed (57.8% of PFPeA, 54.0% of PFBA, and 88.5% of TFA). This drop in percent removal of PFCAs from the C6 to C5 and C4 compounds can be primarily attributed to the increased water solubility and is commonly observed during adsorption of complex PFAS mixtures by AC and ion exchange (IX) resin. Of particular note is the TFA removal, which was higher than expected considering the results. Additional investigation is needed to further elucidate the mechanism for this high removal. These results indicate the BC@mMIP adsorbent is capable of PFAS removal sufficient to meet regulatory requirements, making it a promising alternative to less selective adsorbent materials like AC and BC.

High PFAS recovery from spent adsorbent (shown in FIG. 24) indicates long material lifetimes may be possible, an essential characteristic given the higher expected production cost compared to commercial AC adsorbents. Interestingly, PFAS recovery did not appear to follow a specific trend with respect to PFAS chain length, although recovery of PFSAs generally appeared higher than that of PFCAs. For example, 84.3% of PFHxS was recovered compared to only 56.4% of PFOA and 73.3% of PFHxA. These results are somewhat in contrast to prior studies which have generally demonstrated increasing recovery with increasing chain length and higher recovery for PFSAs than PFCAs. Recovery of the three PFAS template compounds (i.e., PFBS, 6:2-FTS, and PFPeA) was significantly higher than 100%. This is attributed to the incomplete recovery of the templates remaining within the BC@mMIP following the washing step. It is important to note that this unrecovered template mass was relatively low (0.28 μg PFBS, 0.86 μg 6:2-FTS, and 0.15 μg PFPeA) and did not appear to leach during the adsorption phase. Thus, unrecovered template remaining in the MIP layer is not expected to significantly impact adsorption performance of this material. Another key finding was that PFAS recovery did not increase significantly with time after the first day, as demonstrated in FIGS. 28A and 28B. For example, PFHxS recovery was 35% on day one and 42% on day seven. These desorption kinetics results indicate PFAS desorption kinetics from the BC@mMIP are relatively fast, which is beneficial for use in water treatment scenarios. It should be noted that the total mass of PFAS sorbed to the BC@mMIP in this test was fairly low. Therefore, it would be beneficial to repeat this test either with higher PFAS concentrations or in a column test set up to confirm the validity of this conclusion about the desorption kinetics.

### Column Test Results

### PFAS Adsorption to BC@MMIP was Hindered by the Presence of Effluent Organic Matter and Total Dissolved Solids

The high total dissolved solids (TDS) load in the wastewater effluent, particularly from sulfate salts, contributed to low PFAS removal by the polymer modified biochar the during column filtration studies (TDS=286 mg/L and sulfate=16.3 mg/L in round one, see TABLE 10). This result can be observed in the concentration time series plots for each analyte from the first adsorption cycle (FIGS. 25A-25F and FIGS. 31A-31G) where PFAS removal by BC@mMIP was lower than removal by F400 and lower than expected given the batch test results. For example, complete breakthrough of the long-chain PFOS and PFOA occurred around 125 pore volumes for the BC@mMIP compared to a much slower breakthrough on F400 which did not experience complete breakthrough by the end of round one (261 pore volumes). A similar comparison can be made for the short-chain PFBS and PFBA which show the same trend but with BC@mMIP breakthroughs around 50 pore volumes. In a high TDS matrix, competition for adsorption sites between PFAS and ionic species (particularly sulfur-containing salts) has been observed in previous studies of PFAS adsorption by MIP materials or IX resins containing quaternary nitrogen-containing moieties. In mixed matrices containing PFAS and sulfate salts, electrostatic attraction between the sulfate ions and quaternary nitrogen moieties within templated binding sites is expected to block PFAS adsorption at these sites, thereby decreasing the PFAS removal capabilities of the MIP adsorbent and making it behave more like the non-imprinted BC@NP. The performance of the F400 was less impacted by matrix effects, as demonstrated by the later breakthrough times observed for almost all compounds (FIGS. 25A-25F and FIGS. 31A-31G). This can be attributed to the primary adsorption mechanism for PFAS onto F400 (hydrophobic attraction to non-specific binding sites) which will not be impacted by competition with ionic species. The PFAS adsorption during column testing followed a similar trend to that observed in the batch tests with greater removal of long-chain PFAS compared to short-chain PFAS. Interestingly, very little difference was observed in adsorption of similar chain-length PFSAs and PFCAs. This result can also be attributed to adsorption of sulfate ions which will exert a larger repellant force on the more electronegative PFSAs. The impaired PFAS adsorption results by the BC@mMIP composite indicate pretreatment of wastewater effluent and other matrices with high sulfate concentrations (e.g., with IX) is needed to realize the full PFAS removal potential of the BC@mMIP.

TABLE 10
Chemical characteristics of weekly wastewater
treatment plant effluent samples.

Collection Date

| | Apr. 3, | Apr. 10, | Apr. 17, | Apr. 24, |
|---|---|---|---|---|
| | 2023 | 2023 | 2023 | 2023 |
| DOC (mg/L) | 9.4 ± | 6.7 ± | 9.3 ± | 10.2 ± |
| | 0.3 | 0.2 | 0.2 | 0.5 |
| TSS (mg/L) | 3.6 | 2.0 | 2.4 | 4.8 |
| TDS (mg/L) | 286 | 255 | 130 | 442 |
| pH (S.U.) | 7.12 | 7.20 | 7.15 | 7.38 |
| Chloride | 113 | 64.4 | 71.4 | 192 |
| (mg/L) | | | | |
| Nitrate (mg/L) | 5.49 | 0.94 | 0.79 | 1.49 |
| Sulfate (mg/L) | 16.3 | 11.5 | 14.2 | 22.3 |
| Sodium | 41.7 ± | 36.2 ± | 24.1 ± | 53.5 ± |
| (mg/L) | 2.4 | 2.5 | 2.1 | 4.2 |
| Calcium(II) | 17.5 ± | 16.1 ± | 17.1 ± | 20.9 ± |
| (mg/L) | 0.1 | 0.1 | 0.3 | 0.4 |
| Magnesium(II) | 9.8 ± | 9.3 ± | 8.7 ± | 14.5 ± |
| (mg/L) | 0.0 | 0.1 | 0.2 | 0.3 |
| Lead(II) | ND | ND | ND | ND |
| (mg/L) | | | | |
| Aluminum(III) | 0.01 ± | 0.01 ± | 0.01 ± | 0.01 ± |
| (mg/L) | 0.0 | 0.0 | 0.0 | 0.0 |
| Total iron | 0.5 ± | 0.1 ± | 0.1 ± | 0.1 ± |
| (mg/L) | 0.0 | 0.0 | 0.0 | 0.0 |

ND: below limit of detection

The presence of effluent organic matter (EfOM) and TDS did not appear to affect co-occurring organics adsorption to as great of an extent since removal of organics was generally higher than PFAS (FIGS. 25A-25F). Adsorption of acetaminophen, benzotriazole, and sulfamethoxazole in particular were significantly higher than any PFAS compound, with greater than 80%, 70%, and 50% removal, respectively, observed for the duration of round one. This can be attributed to the relatively high organic carbon distribution coefficients (log D_{oc}; TABLE 13) of these compounds at pH 7.0 which range from 1.09 to 1.65 compared to the log D_{oc} values of the PFAS compounds which range from −1.65 (6:2-FTS) to −9.75 (PFBS). The higher log D_{oc} values of the co-occurring organics are due in large part to their higher pKa values and are responsible for increased adsorption both to the adsorbent media and to the suspended organics that may be physically removed by any of the four types of media. Fipronil is the exception to this trend with a high log D_{oc} of 3.77 similar to the other organics but exhibiting lower adsorption and faster breakthrough similar to that of the PFAS compounds (FIGS. 25A-25F). This may be due in part to the large molecular size of fipronil which would hinder adsorption at templated binding sites, limiting its adsorption potential on the BC@mMIP. It is also important to note that according to the Organization for Economic Cooperation and Development's (OECD) definition of a PFAS (i.e., compounds containing at least one fully fluorinated carbon) fipronil is categorized as a PFAS, which may also contribute to similarities in their adsorption behavior.

PFAS and organic analyte removal by the sand only control columns was higher than expected for several compounds including PFOS (FIGS. 25A-25F), acetaminophen (FIG. 31E, and sulfamethoxazole (FIG. 31G). This removal is attributed to adsorption of analytes onto suspended effluent organic matter which was physically removed by the media in the sand columns.

### BC@MMIP Maintains Consistent PFAS Removal Over Multiple Cycles

The PFAS removal capabilities of BC@mMIP were maintained over four cycles of adsorption and regeneration with a 70% methanol, 1% sodium chloride, and 2.8 mM sodium hydroxide solution in water. This consistent removal is demonstrated by the mass adsorbed and recovered (shown in FIGS. 26A-26F and FIGS. 32A-32G) and which is steady or increasing across adsorption cycles for all nine PFAS. Notably, PFAS removal increased from the second to third adsorption rounds, particularly for the short-chain PFBS and PFBA (FIGS. 26D and 26E) and PFPeA (FIG. 32D). This increase can be attributed to the relatively lower influent TDS in round three (130 mg/L compared to 255 mg/L in round 2) as shown in TABLE 10 which is expected to have reduced competition for templated adsorption sites on the BC@mMIP between PFAS and sulfate species. The improved PFAS adsorption during round three also supports the earlier hypothesis that high TDS levels severely impacted PFAS sorption by the BC@mMIP. In contrast to the trend observed for BC@mMIP, the F400 PFAS adsorption performance decreased over the four cycles of adsorption and regeneration for most of the PFAS compounds (except PFOS and 6:2-FTS) and fipronil. The drop in adsorption by F400 indicates adsorption sites on F400 are not able to be regenerated to the extent that those on the polymer modified biochar adsorbents are. The relatively consistent removal of PFOS, 6:2-FTS, acetaminophen, benzotriazole, and sulfamethoxazole by F400 reflects the higher adsorption affinities of the F400 for these compounds, as discussed previously. It is expected that over additional adsorption and regeneration cycles the removal of these compounds by F400 would begin to decrease as well. The consistent PFAS removal capabilities of the MIP modified biochar material indicate this adsorbent is likely to experience longer material lifetimes than traditional activated carbon, potentially offsetting the higher production cost and making it a promising alternative.

Interestingly, the calculated mass of PFAS recovered from the BC@mMIP was significantly lower than the mass adsorbed for all nine PFAS compounds (FIGS. 26A-26F and C6). This result was surprising given the relatively consistent PFAS removal across all four cycles which would seem to indicate good regeneration of adsorption sites between each adsorption cycle. This discrepancy is likely due to one or both of the following factors. First, the regeneration step may have facilitated high recovery of sulfate ions and other salts adsorbed to quaternary nitrogen moieties in templated binding sites. This regeneration of sites blocked by ions may have been sufficient to allow for good PFAS removal in subsequent adsorption cycles despite low PFAS recovery during the regeneration step. Second, the mass of PFAS recovered may have been underestimated due to a lack of granularity in the data collected from the regeneration step (only three samples were collected over the six hour regeneration time). If PFAS recovery primarily occurred in the first hour or two, the midpoint integration method used to calculate the mass recovered may be a significant underestimate.

### CONCLUSIONS

Selective PFAS adsorbents are needed to address the issue of PFAS contamination in a range of water sources, including wastewater. In particular, there is a need for adsorbent materials capable of high short-chain PFAS removal to address the increasing occurrence of short-chain PFAS. The multi-template BC@MIP adsorbent described herein has the potential to fulfill both of these needs. Our BC@mMIP material was able to remove PFOA, PFHxS, and PFBS to below their respective proposed MCLs in a batch adsorption test with (waste)water-relevant initial concentrations of nine PFAS. Column adsorption testing with higher concentrations of the same nine PFAS spiked into real wastewater effluent showed lower removal than expected which was attributed to interference from competing organics and ions, particularly sulfate species. Additional adsorption testing in wastewater effluent with lower initial PFAS concentrations, and IX pre-treatment should be considered to further evaluate the capabilities and limitations of this adsorbent. Given the results presented herein, the BC@mMIP material is expected to be an excellent option for treatment of long- and short-chain PFAS in lower TDS/TOC containing waters like typical drinking water treatment and some water reuse scenarios.

This work also demonstrated some of the benefits of the multi-template imprinting approach compared to the traditional, single-template MIP, particularly for removal of a complex suite of compounds like PFAS. For PFAS removal, the high selectivity for a single template compound that is characteristic of traditional MIP materials is not necessarily desirable since removal of a number PFAS is often desired. The multi-templating approach significantly improved adsorption, particularly of short-chain and carboxylic PFAS when compared to the non-imprinted and single-template MIPs. We hypothesize that there is a synergistic interaction between multiple types of templates and the functional monomer that was unable to occur in the single-template scenarios. The complex interactions between the different templates and the BC@mMIP were reflected in the adsorption isotherm results. Electrostatic attraction was expected to be most dominant in interactions between PFBS and the VBTAC monomer owing to the high electronegativity of the sulfonate head group and the relatively short chain length of the four carbon PFBS tail which promote preferential adsorption at templated binding sites. Hydrophobic interaction was expected to dominate interactions between PFPeA and VBTAC, although the short chain length and high water solubility of PFPeA resulted in a much lower adsorption capacity for PFPeA. The sulfonic head group and long chain length of 6:2-FTS allowed for both hydrophobic and electrostatic attraction to the VBTAC and resulted in good adsorption both to templated and non-specific binding sites. The success and versatility of the multi-template approach make it an ideal option for synthesis of PFAS adsorbents and adsorbents for other complex contaminant mixtures.

While illustrative embodiments have been illustrated and described, it will be appreciated that various changes can be made therein without departing from the spirit and scope of the present disclosure.

1. A method of functionalizing activated carbon for selective adsorption of a per- or polyfluoroalkyl substance (PFAS), the method comprising:
coordinating a PFAS template with a plurality of functional monomers;
polymerizing the plurality of functional monomers coordinated with the PFAS template in the presence of an activated carbon substrate to provide a molecularly imprinted polymer (MIP) coupled to the activated carbon; and
extracting the PFAS template from the MIP.

2. The method of claim 1, wherein coordinating the PFAS template with the plurality of functional monomers comprises mixing the plurality of the functional monomers and the PFAS template in a pre-polymerization solution under conditions and for a time sufficient to coordinate functional monomers of the plurality of functional monomers with the PFAS template.

3. The method of claim 1, wherein polymerizing the functional monomers coordinated with the PFAS template in the presence of an activated carbon substrate comprises:
introducing a crosslinker configured to crosslink the plurality of functional monomers and the activated carbon substrate to the pre-polymerization solution to provide a reaction solution; and
introducing an initiator to the reaction solution thereby polymerizing the plurality of functional monomers to provide the MIP coupled to the activated carbon.

4. The method of claim 2, further comprising:
prior to introducing the activated carbon substrate to the pre-polymerization solution, heating the activated carbon substrate with melamine to modify the activated carbon substrate with the melamine.

5. The method of claim 4, further comprising:
rinsing the melamine-modified activated carbon substrate to remove unreacted melamine; and
drying the rinsed melamine-modified activated carbon substrate.

6. The method of claim 2, further comprising:
prior to introducing the activated carbon substrate to the pre-polymerization solution, contacting the activated carbon substrate with nitric acid and sulfuric acid to provide a nitrate-modified activated carbon substrate; and
contacting the nitrate-modified activated carbon substrate with sodium dithionite to provide an amino-functionalized activated carbon substrate.

7. The method of claim 6, further comprising:
rinsing the amino-modified activated carbon substrate to remove unreacted nitric acid and sulfuric acid; and
drying the rinsed amino-modified activated carbon substrate.

8. The method of claim 1, wherein the PFAS template is a first PFAS template, the method further comprising a second PFAS template with the functional monomers.

9. The method of claim 1, wherein functional monomers of the plurality of functional monomers comprise a functional group selected from the group consisting of a quaternary amine and a fluorocarbon.

10. The method of claim 1, wherein functional monomers of the plurality of functional monomers are selected from the group consisting of Methacryloyloxy)ethyl] trimethylammonium chloride, 2-(trifluoromethyl)acrylic acid, and vinylbenzyl trimethylammonium chloride, and combinations thereof.

11. The method of claim 3, wherein the crosslinker is N,N′-methylenebisacrylamide.

12. The method of claim 3, wherein the initiator is 2,2′-azobis(2-methylpropionitrile).

13. The method of claim 1, wherein the activated carbon substrate comprises spent coffee grounds activated carbon made from pyrolyzing spent coffee grounds with a caustic.

14. The method of claim 1, wherein the PFAS template is selected from the group consisting of PFCAs, PFOA, PFSAs, PFOS, GenX, 6:2 FtTAOS, PFHxSaAmA, ADONA, and combinations thereof.

15. A composition comprising:
activated carbon; and
a molecularly imprinted polymer (MIP) coupled to the activated carbon, wherein the MIP is configured to selectively adsorb a PFAS compound.

16. The composition of claim 15, wherein the activated carbon comprises an amine functional group.

17. The composition of claim 16, wherein the amine functional group comprises a moiety selected from the group consisting of a pyrrolic-N, pyridinic-N, amine-N, graphitic-N, and pyridinic-N⁺ oxides, and combinations thereof.

18. The composition of claim 15, wherein the MIP comprises repeating units comprising a quaternary nitrogen moiety.

19. The composition of claim 15, wherein the MIP comprises repeating units selected from the group consisting of (vinylbenzyl trimethylammonium chloride, [2-(Methacryloyloxy)ethyl] trimethylammonium chloride) and 2-(trifluoromethyl)acrylic acid.

20. The composition of claim 15, wherein the composition comprises a specific surface area in a range between about 700 m²/g and about 1100 m²/g.

21. The composition of claim 15, wherein a thickness of the MIP is in a range between about 10 nm and about 250 nm.
